(19) United States
(12) Patent Application Publication
(10) Pub. No.: US 2025/0273915 A1
(43) Pub. Date: Aug. 28, 2025

(54) ELECTRICAL WIRING DEVICES FOR USE IN KITCHEN/BATHROOM COUNTERTOPS

(71) Applicant: Pass & Seymour, Inc., Syracuse, NY (US)

(72) Inventors: Joshua Ryan, Syracuse, NY (US); Richard M Rohmer, Memphis, NY (US)

(73) Assignee: Pass & Seymour, Inc., Syracuse, NY (US)

(21) Appl. No.: 19/064,456

(22) Filed: Feb. 26, 2025

Related U.S. Application Data
(60) Provisional application No. 63/757,123, filed on Feb. 11, 2025.
(60) Provisional application No. 63/557,743, filed on Feb. 26, 2024.

(51) Int. Cl. H01R 13/74; H01R 13/44; H01R 13/52

(52) U.S. Cl. CPC H01R 13/74; H01R 13/44; H01R 13/5202

(57) ABSTRACT

The present invention relates generally to electrical wiring devices/assemblies, and particularly to electrical wiring devices/assemblies used in bathroom countertops and/or kitchen countertops (including tops of kitchen islands). The assembly can include a main body having internal channels that separate each of the contacts that are within the device. The interior of the main body can also include openings that are configured to direct liquid to flow outside and away from the device. According to an embodiment, a plug connector can be included and have internal channels that line up with the channels of the interior of the main body and similarly separate the contacts within the device. The plug connector can also have openings that align with the channels and are configured to direct liquid out and away from the device.

### BACKGROUND OF THE INVENTION

### 1. FIELD OF THE INVENTION

The present invention relates generally to electrical wiring devices/assemblies, and particularly to electrical wiring devices/assemblies configured to be used in bathroom countertops and/or kitchen countertops (including tops of kitchen islands).

### 2. DESCRIPTION OF THE RELATED ART

Electrical power is provided to users by way of electrical distribution systems that typically include electrical wiring from a utility power source to a breaker panel disposed in a house, building or some other facility. The breaker panel distributes AC power to one or more branch electric circuits installed at various locations throughout a structure. The electric circuits may typically include one or more electrical wiring devices that regulate, monitor or provide AC power to other devices. There are a variety of electrical wiring devices available to the consumer including outlet receptacles, light switches, dimmers, ground fault circuit interrupters, arc fault circuit interrupters, fan speed controls and timers.

Each electrical wiring device is equipped with electrical terminals/contacts that provide a means for connecting the device to the source of AC power and a means for connecting the device to a load. Specifically, line terminals couple the device to the source of AC electrical power, whereas load terminals couple power to the load. Load terminals may also be referred to as “feed-through” or “downstream” terminals because the wires connected to these terminals may be coupled to a daisy-chained configuration of receptacles or switches.

Thus, an electric circuit may include many different electrical wiring devices disposed at various locations throughout a structure. Outlet receptacles, switches and protective devices are examples or types of electrical wiring devices. Ground fault circuit interrupters (GFCIs) and arc fault circuit interrupters (AFCIs) are examples of protective devices in electric circuits. One or more electrical wiring devices may be mounted to a device box depending on the size of the device box. A single-gang device box typically accommodates one electrical wiring device; a two-gang device box will typically accommodate two electrical wiring devices, and so on and so forth. An electrical wiring device provides the consumer with a point of access to electrical service. For example, a receptacle outlet provides power to a portable device when the device's corded power plug is inserted into an energized receptacle. Once an electrical wiring device is installed inside the device box, a cover plate can be disposed over the electrical wiring device to “complete the electrical enclosure” such that individuals are not exposed to “hot” electrical wiring after the electrical power is turned ON.

Similar to other electrical wiring devices, electrical wiring devices such as outlet receptacles positioned in bathroom countertops and kitchen countertops (including tops of kitchen islands) should comply with the certain requirements of Underwriters Laboratories (UL) (including UL 498) related to water spill testing (among other performance parameters and requirements, as should be understood by a person of ordinary skill in the art).

Description of the Related Art Section Disclaimer: To the extent that specific patents/publications/products are discussed above in this Background Section or elsewhere in this Application, these discussions should not be taken as an admission that the discussed patents/publications/products are prior art for patent law purposes. For example, some or all of the discussed patents/publications/products may not be sufficiently early in time, may not reflect subject matter developed early enough in time and/or may not be sufficiently enabling so as to amount to prior art for patent law purposes. To the extent that specific patents/publications/products (and/or specific portions thereof) are discussed above in this Background Section and/or throughout the application, the descriptions/disclosures of which are all hereby incorporated by reference into this document in their respective entirety (ies) (or at least the specific references sections are incorporated by reference into this document in their respective entirety (ies), as may be applicable).

### BRIEF SUMMARY OF THE INVENTION

The inventors recognize there are several drawbacks associated with conventional outlet receptacles positioned in bathroom countertops and kitchen countertops. For example, such conventional devices/assemblies take up a lot of room where installed, are relatively difficult to install and connect to a building's electrical power, and could be improved with respect to complying with the above referenced UL performance requirements.

It is therefore a principal object and advantage of the present invention to provide embodiments of electrical wiring device assemblies that eliminate one or more of the problems/issues discussed above. In particular, the present disclosure is directed to inventive electrical wiring device assemblies including improved outlet receptacles structured and configured to be (1) positioned in bathroom countertops and kitchen countertops, (2) easier to install, (3) take up less space, and/or (4) allow for more cabinet and drawer space, while complying (and improving upon performance of conventional devices/assemblies) with the above referenced UL performance requirements.

Generally, according to an embodiment, an electrical wiring assembly is provided. The assembly includes a main body having internal channels that separate each of the contacts that are within the device. The interior of the main body also includes openings that are configured to direct liquid to flow outside and away from the device.

According to an embodiment, a plug connector is included and has internal channels that line up with the channels of the interior of the main body and similarly separate the contacts within the device. The plug connector can also have openings in its base that align with the channels and are configured to direct liquid out and away from the device (i.e., axial drainage).

According to an embodiment, the plug connector has a tail that extends at an approximately right angle with respect to a longitudinal axis of the main body and is positioned immediately adjacent to and under the connection portion of the main body such that the plug connector is releasably attached to the main body and extends substantially parallel to a surface when installed.

According to an embodiment, a primary gasket is provided that is ideally formed of one piece but allows for the isolation of the three contacts and is aligned with the channels of the main body by covering each entry point. The primary gasket can fit within the contours of and have similar geometry to the top surface of the main body and can be designed to sit below the top of the dividers within the top surface of the main body to prevent liquid from flowing into the device while also preventing interference with the use thereof.

According to an embodiment, secondary gaskets are provided that surround each contact in the plug connector and are configured to prevent liquid from encountering the contacts.

According to an embodiment, the interior of the main body can have ledges that are angled or sloped downward and away with respect to the main body, providing radial drainage.

The details of one or more embodiments are further described in the attached drawings and appendices, which include additional information regarding embodiments of the present disclosure that is incorporated by reference in its entirety herein. A brief description of each of the drawings is set forth below.

While embodiments of the present invention have been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements. If elements shown in a particular Figure discussed below are not specifically identified with respect to that Figure, the elements should be sufficiently identified with respect to at least one other Figure.

The components described herein can be made of, for example, metal, rubber or plastic polymer, as should be understood by those of ordinary skill in the art in conjunction with this disclosure.

The embodiments described and illustrated herein can include pop-up outlet receptacles and non-pop-up outlet receptacles, each of which can include a gasket through which the blades of a cord attached to a load can pierce through and which meets or exceeds the UL spill test parameters (as should be understood by a person of ordinary skill in the art in conjunction with a review of this disclosure). In addition, aspects of the tamper resistant mechanism of an embodiment are shown in some of the accompanying drawings and are further described in U.S. Pat. Nos. 9,847,611, 9,543,715 and 9,893,456.

### BRIEF DESCRIPTION OF THE DRAWINGS

The present invention will be more fully understood and appreciated by reading the following Detailed Description in conjunction with the accompanying drawings. The accompanying drawings illustrate only typical embodiments of the disclosed subject matter and are therefore not to be considered limiting of its scope, for the disclosed subject matter may admit to other equally effective embodiments.

Reference is now made briefly to the accompanying drawings, in which:

FIG. 1A is a perspective view schematic representation of an assembled outlet receptacle assembly according to an embodiment of the present disclosure.

FIG. 1B is an exploded view of the view shown in FIG. 1A according to an aspect of the present disclosure.

FIG. 2 is another perspective view schematic representation of the assembled outlet receptacle assembly according to an embodiment of the present disclosure.

FIG. 3 is a perspective view schematic representation of the top portion of the outlet receptacle assembly according to an embodiment of the present disclosure.

FIG. 4 is another perspective view schematic representation of the top portion of the outlet receptacle assembly according to an embodiment of the present disclosure.

FIG. 5 is a close-up perspective view schematic representation of the outlet receptacle assembly with the outer housing removed, according to an embodiment of the present disclosure.

FIG. 6 is a close-up top view schematic representation of the outlet receptacle assembly with the outer housing removed, according to an embodiment of the present disclosure.

FIG. 7 is a close-up perspective view schematic representation of the outlet receptacle assembly with the outer housing removed, according to an embodiment of the present disclosure.

FIG. 8 is a perspective view schematic representation of the top portion of the outlet receptacle assembly with the middle structures removed, according to an embodiment of the present disclosure.

FIG. 9 is a top view schematic representation of the top portion of the outlet receptacle assembly with the middle structures removed, according to an embodiment of the present disclosure.

FIG. 10 is a perspective view schematic representation of the outlet receptacle assembly with the middle structures removed, according to an embodiment of the present disclosure.

FIG. 11A is a close-up view schematic representation of the box and wire covering according to an embodiment of the present disclosure.

FIG. 11B is an exploded view schematic representation of the box and wire covering attachment mechanism shown in FIG. 11A according to an embodiment of the present disclosure.

FIG. 12A shows a step of installing the embodiment shown in FIGS. 1-11B according to an embodiment of the present disclosure.

FIG. 12B shows a step of installing the embodiment shown in FIGS. 1-11B according to an embodiment of the present disclosure.

FIG. 12C shows a step of installing the embodiment shown in FIGS. 1-11B according to an embodiment of the present disclosure.

FIG. 12D shows a step of installing the embodiment shown in FIGS. 1-11B according to an embodiment of the present disclosure.

FIG. 12E shows a step of installing the embodiment shown in FIGS. 1-11B according to an embodiment of the present disclosure.

FIG. 12F shows a step of installing the embodiment shown in FIGS. 1-11B according to an embodiment of the present disclosure.

FIG. 12G shows an additional view schematic representation of the outlet receptacle assembly installed into a counter according to an embodiment of the present disclosure.

FIG. 12H shows an additional view schematic representation of the outlet receptacle assembly installed into a counter according to an embodiment of the present disclosure.

FIG. 12I shows an additional view schematic representation of the outlet receptacle assembly installed into a counter according to an embodiment of the present disclosure.

FIG. 13A is a perspective view schematic representation of an assembled outlet receptacle assembly according to an alternative embodiment of the present disclosure.

FIG. 13B is an exploded perspective schematic representation of the outlet receptacle assembly shown in FIG. 13A.

FIG. 14 is another perspective view schematic representation of the assembled outlet receptacle assembly according to an alternative embodiment of the present disclosure.

FIG. 15 is a close-up view schematic representation of the assembled outlet receptacle assembly according to an alternative embodiment of the present disclosure.

FIG. 16 is a close-up bottom view schematic representation of the assembled outlet receptacle assembly according to an alternative embodiment of the present disclosure.

FIG. 17 is a top view schematic representation of the bottom portion of the outlet receptacle assembly according to an alternative embodiment of the present disclosure.

FIG. 18A is a perspective disassembled view schematic representation of the bottom portion of the outlet receptacle assembly according to an alternative embodiment of the present disclosure.

FIG. 18B is an exploded view schematic representation of the bottom portion of the outlet receptacle assembly according to an alternative embodiment of the present disclosure.

FIG. 19A shows a step of assembling the embodiment shown in FIGS. 13-18B.

FIG. 19B shows another step of assembling the embodiment shown in FIGS. 13-18B.

FIG. 19C shows another step of assembling the embodiment shown in FIGS. 13-18B.

FIG. 19D shows another step of assembling the embodiment shown in FIGS. 13-18B.

FIG. 20A is a perspective schematic representation of an assembled outlet receptacle assembly according to an alternative embodiment of the present disclosure.

FIG. 20B is an exploded view schematic representation of the outlet receptacle assembly shown in FIG. 20A according to an alternative embodiment of the present disclosure.

FIG. 21 is another perspective schematic representation of the assembled outlet receptacle assembly according to an alternative embodiment of the present disclosure.

FIG. 22 is a close-up exploded schematic representation of the wire box according to an alternative embodiment of the present disclosure.

FIG. 23 is a close-up schematic representation of the wire box shown in FIG. 22 according to an alternative embodiment of the present disclosure.

FIG. 24A is an exploded view schematic representation of the wire box according to an alternative embodiment of the present disclosure.

FIG. 24B is another exploded view schematic representation of the wire box according to an alternative embodiment of the present disclosure.

FIG. 25A shows a step in the installation of the embodiment described in FIGS. 20-24B.

FIG. 25B shows another step in the installation of the embodiment described in FIGS. 20-24B,

FIG. 25C shows another step in the installation of the embodiment described in FIGS. 20-24B,

FIG. 25D shows another step in the installation of the embodiment described in FIGS. 20-24B,

FIG. 25E shows another step in the installation of the embodiment described in FIGS. 20-24B,

FIG. 25F shows another step in the installation of the embodiment described in FIGS. 20-24B,

FIG. 25G shows another step in the installation of the embodiment described in FIGS. 20-24B,

FIG. 25H shows another step in the installation of the embodiment described in FIGS. 20-24B,

FIG. 26 is a perspective schematic representation of an outlet receptacle assembly assembled in a countertop according to an alternative embodiment of the present disclosure.

FIG. 27 another perspective schematic representation of the outlet receptacle assembled in a countertop according to an alternative embodiment of the present disclosure.

FIG. 28 is a rear view schematic representation of the outlet receptacle assembly according to an alternative embodiment of the present disclosure.

FIG. 29A is an exploded schematic representation with some components removed for illustrative purposes according to an alternative embodiment of the present disclosure.

FIG. 29B is another exploded schematic representation with some components removed for illustrative purposes according to an alternative embodiment of the present disclosure.

FIG. 30A shows a step of installation with respect to the embodiment shown in FIGS. 26-29B.

FIG. 30B shows a step of installation with respect to the embodiment shown in FIGS. 26-29B.

FIG. 30C shows a step of installation with respect to the embodiment shown in FIGS. 26-29B.

FIG. 30D shows a step of installation with respect to the embodiment shown in FIGS. 26-29B.

FIG. 30E shows a step of installation with respect to the embodiment shown in FIGS. 26-29B.

FIG. 31 is a perspective disassembled schematic representation of an outlet receptacle assembly according to an alternative embodiment of the present disclosure.

FIG. 32 is another perspective disassembled schematic representation of the outlet receptacle assembly according to an alternative embodiment of the present disclosure

FIG. 33 is an exploded schematic representation of the outlet receptacle assembly according to an alternative embodiment of the present disclosure.

FIG. 34 is a close-up schematic representation of the top portion of the outlet receptacle assembly according to an alternative embodiment of the present disclosure.

FIG. 35 is a close-up perspective schematic representation of the top portion of the outlet receptacle assembly according to an alternative embodiment of the present disclosure.

FIG. 36 is a close-up rear view schematic representation of the top portion of the outlet receptacle assembly according to an alternative embodiment of the present disclosure.

FIG. 37 is an exploded schematic representation of the top portion of the outlet receptacle assembly according to an alternative embodiment of the present disclosure.

FIG. 38 is an assembled schematic representation of a plug connector of the outlet receptacle assembly according to an alternative embodiment of the present disclosure.

FIG. 39 is an exploded schematic representation of the plug connector according to an alternative embodiment of the present disclosure.

FIG. 40 is another exploded schematic representation of the plug connector according to an alternative embodiment of the present disclosure.

FIG. 41A is another exploded schematic representation of the plug connector according to an alternative embodiment of the present disclosure.

FIG. 41B is a rear view schematic representation of the outlet receptacle assembly according to an alternative embodiment of the present disclosure.

FIG. 42A shows a step of installing the embodiment shown in FIGS. 31-41B according to an alternative embodiment of the present disclosure.

FIG. 42B shows a step of installing the embodiment shown in FIGS. 31-41B according to an alternative embodiment of the present disclosure.

FIG. 42C shows a step of installing the embodiment shown in FIGS. 31-41B according to an alternative embodiment of the present disclosure.

FIG. 42D shows a step of installing the embodiment shown in FIGS. 31-41B according to an alternative embodiment of the present disclosure.

FIG. 42E shows a step of installing the embodiment shown in FIGS. 31-41B according to an alternative embodiment of the present disclosure.

FIG. 43A is a perspective schematic representation of the outlet receptacle assembly according to an alternative embodiment of the present disclosure.

FIG. 43B is an assembled perspective schematic representation of the outlet receptacle assembly according to an alternative embodiment of the present disclosure.

FIG. 44 is an exploded schematic representation of the outlet receptacle assembly according to an alternative embodiment of the present disclosure.

FIG. 45 is an assembled schematic representation of an outlet receptacle assembly according to an alternative embodiment of the present disclosure.

FIG. 46 is a disassembled schematic representation of the outlet receptacle assembly according to an alternative embodiment of the present disclosure.

FIG. 47 is an exploded schematic representation of the outlet receptacle assembly according to an alternative embodiment of the present disclosure.

FIG. 48A is a close-up schematic representation of the top portion of the outlet receptacle assembly according to an embodiment of the present disclosure.

FIG. 48B is a rear view schematic representation of the top portion of the outlet receptacle assembly according to an embodiment of the present disclosure.

FIG. 49 is a rear view schematic representation of the bottom portion of the outlet receptacle assembly according to an embodiment of the present disclosure.

FIG. 50A shows a step of installing the embodiment shown in FIGS. 45-49 according to an embodiment of the present disclosure.

FIG. 50B shows a step of installing the embodiment shown in FIGS. 45-49 according to an embodiment of the present disclosure.

FIG. 50C shows a step of installing the embodiment shown in FIGS. 45-49 according to an embodiment of the present disclosure.

FIG. 50D shows a step of installing the embodiment shown in FIGS. 45-49 according to an embodiment of the present disclosure.

FIG. 51 is an exploded schematic representation of an outlet receptacle assembly according to an alternative embodiment of the present disclosure.

FIG. 52A is a perspective assembled schematic representation of the outlet receptacle assembly according to an alternative embodiment of the present disclosure.

FIG. 52B is a rear assembled schematic representation of the outlet receptacle assembly according to an alternative embodiment of the present disclosure.

FIG. 53A is a perspective view of the outlet receptacle assembly according to an alternative embodiment of the present disclosure.

FIG. 53B is a cross-sectioned schematic representation of the outlet receptacle assembly according to an alternative embodiment of the present disclosure.

FIG. 53C is a close-up perspective view schematic representation of the top portion of the outlet receptacle assembly according to an alternative embodiment of the present disclosure.

FIG. 53D is a top view schematic representation of the top portion of the outlet receptacle assembly according to an alternative embodiment of the present disclosure.

FIG. 54A is a top view schematic representation of a primary gasket of the outlet receptacle assembly according to an alternative embodiment of the present disclosure.

FIG. 54B is a side view schematic representation of the primary gasket of the outlet receptacle assembly according to an alternative embodiment of the present disclosure.

FIG. 54C is a rear view schematic representation of the primary gasket of the outlet receptacle assembly according to an alternative embodiment of the present disclosure.

FIG. 55A is a top view schematic representation of the top portion of the outlet receptacle assembly with some components removed for illustrative purposes according to an alternative embodiment of the present disclosure.

FIG. 55B is another top view schematic representation of the top portion of the outlet receptacle assembly with some components removed for illustrative purposes according to an alternative embodiment of the present disclosure.

FIG. 56A is another top view schematic representation of the top portion of the outlet receptacle assembly with some components removed for illustrative purposes according to an alternative embodiment of the present disclosure.

FIG. 56B is a side perspective view schematic representation of the top portion of the outlet receptacle assembly according to an alternative embodiment of the present disclosure.

FIG. 56C is a close-up side perspective view schematic representation of the top portion of the outlet receptacle assembly according to an alternative embodiment of the present disclosure.

FIG. 56D is a perspective view schematic representation of the bottom portion of the outlet receptacle assembly with certain components removed for illustrative purposes according to an alternative embodiment of the present disclosure.

FIG. 57 is a side perspective view schematic representation of the outlet receptacle assembly according to an alternative embodiment of the present disclosure.

FIG. 58A is an exploded schematic representation of the bottom portion of the outlet receptacle assembly according to an alternative embodiment of the present disclosure.

FIG. 58B is a top view schematic representation of the bottom portion of the outlet receptacle assembly with certain components removed for illustrative purposes according to an alternative embodiment of the present disclosure.

FIG. 58C is a top view schematic representation of the bottom portion of the outlet receptacle assembly with certain components removed for illustrative purposes according to an alternative embodiment of the present disclosure.

FIG. 58D is a bottom view schematic representation of the bottom portion of the outlet receptacle assembly with certain components removed for illustrative purposes according to an alternative embodiment of the present disclosure.

FIG. 59 is an assembled perspective view schematic representation of an outlet receptacle assembly according to an alternative embodiment of the present disclosure.

### DETAILED DESCRIPTION

Aspects of the present invention and certain features, advantages, and details thereof, are explained more fully below with reference to the non-limiting examples illustrated in the accompanying drawings. Descriptions of well-known structures are omitted so as not to unnecessarily obscure the invention in detail. It should be understood, however, that the detailed description and the specific non-limiting examples, while indicating aspects of the invention, are given by way of illustration only, and are not by way of limitation. Various substitutions, modifications, additions, and/or arrangements, within the spirit and/or scope of the underlying inventive concepts will be apparent to those skilled in the art from this disclosure.

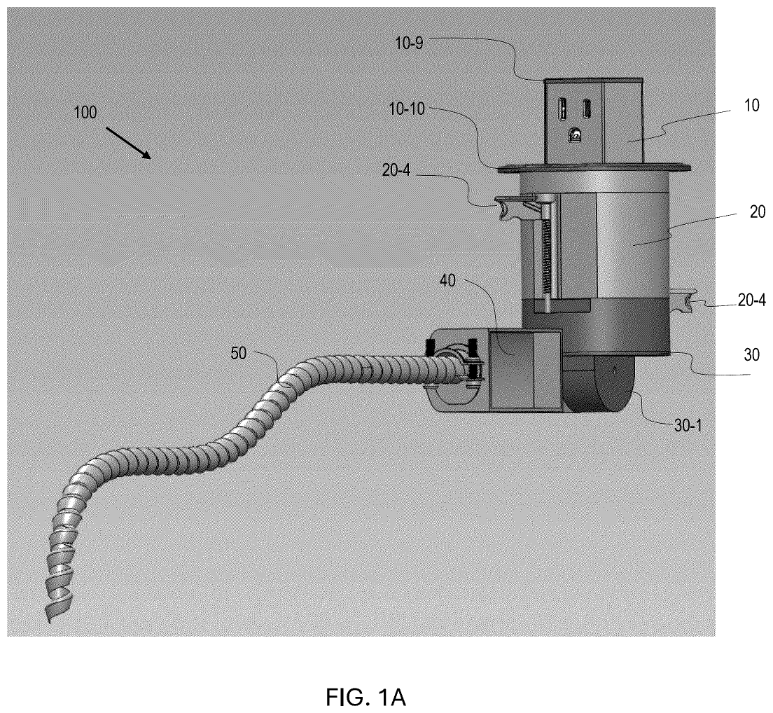

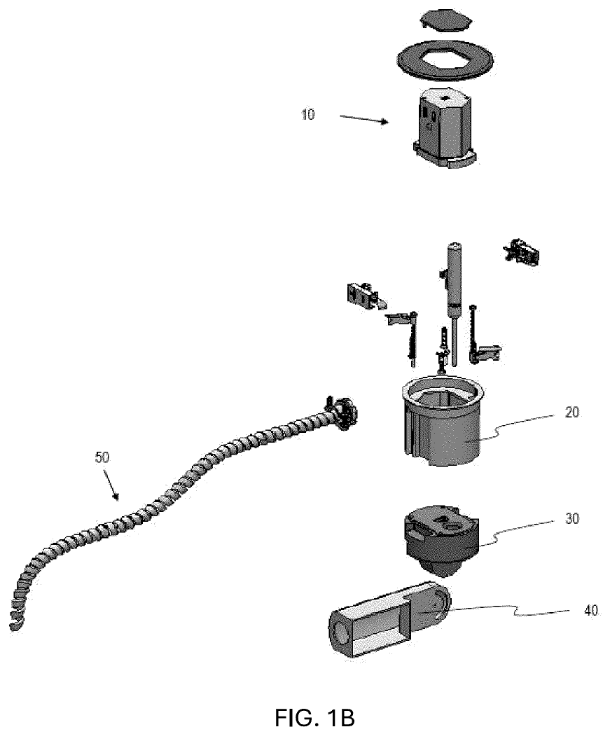

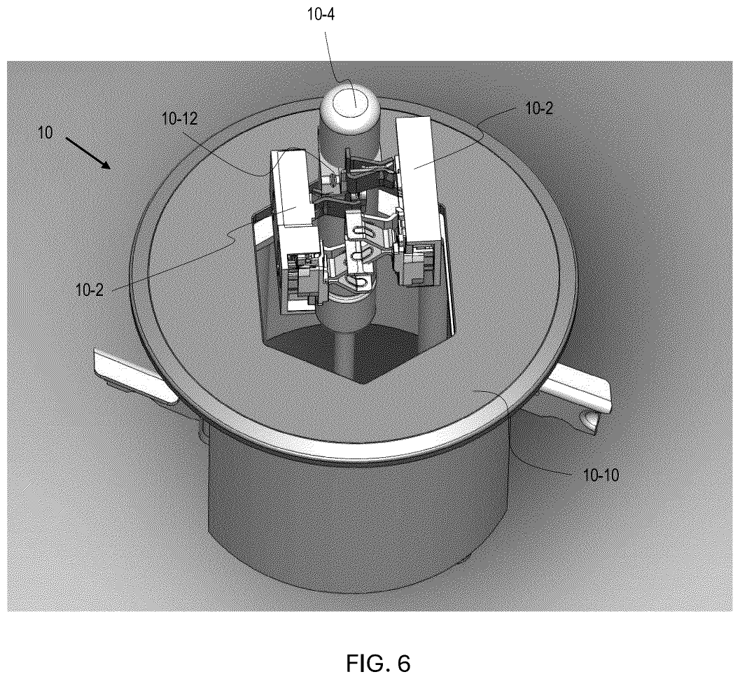

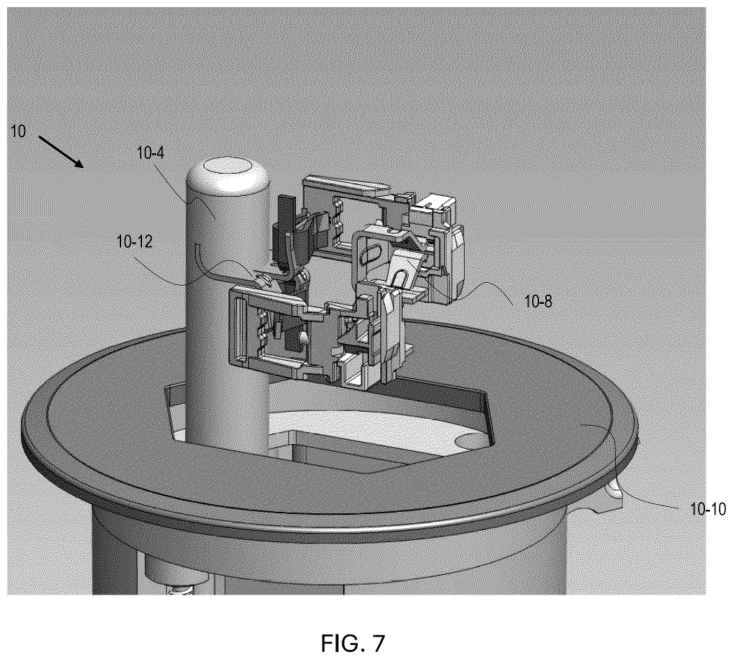

Referring now to FIGS. 1-12F, various schematic representations and views of a first embodiment of this disclosure are shown.

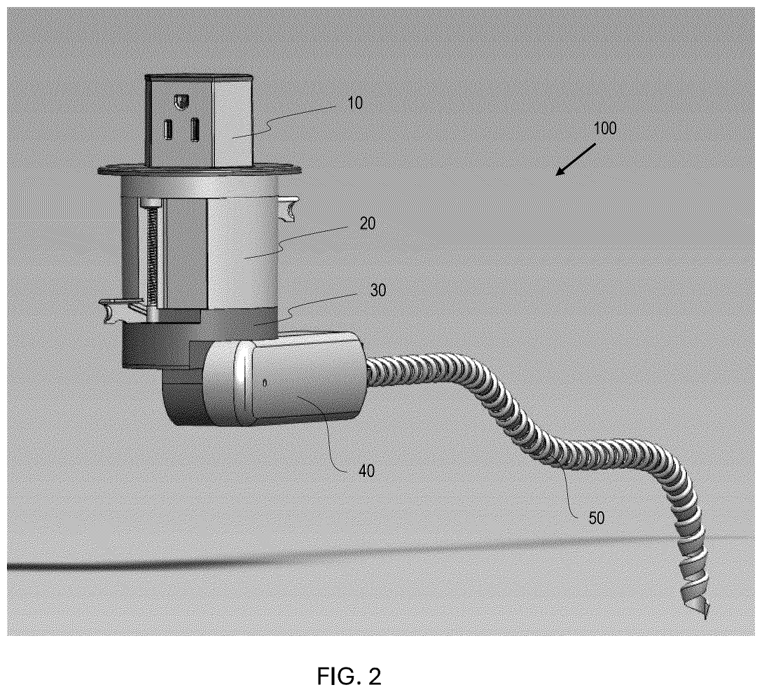

FIGS. 1A and 2 show a fully assembled outlet receptacle assembly 100 structured and configured as discussed above and FIG. 1B shows an exploded view of the same. This outlet receptacle can include a pop-up receptacle 10 positioned and moveable up and down (as shown) along the longitudinal axis of the receptacle 10 within a top housing 20. Bottom housing 30 includes a circular shaped portion 30-1 about which a wiring/electrical box 40 is moveably attached. AC power wire(s) from a house/commercial building (breaker panel, for example) are provided through a wire covering or housing 50 to the box 40. Box 40 can rotate about the circular shaped portion of the bottom housing 30. In particular, the box can rotate from a first position where the box 40 is positioned in line with the longitudinal axis of the pop-up receptacle 10, top housing 20, and bottom housing 30 to a second position shown in FIG. 1A, where the box is positioned orthogonally (or otherwise at an angle to) to the longitudinal axis of the top housing 20 and bottom housing 30. The housing can be locked in either position or any angled position from the first position to the second position in between. The locking mechanism can include, but is not limited to, any locking mechanism known to a person of ordinary skill in the art in conjunction with a review of this disclosure (e.g., movable pin, lever, flange, and/or friction fit). Also shown are a cap 10-9, trim ring 10-10, and swing brackets 20-4 for mounting the assembly 100 to a countertop (as should be understood by a person of ordinary skill in the art in conjunction with this disclosure).

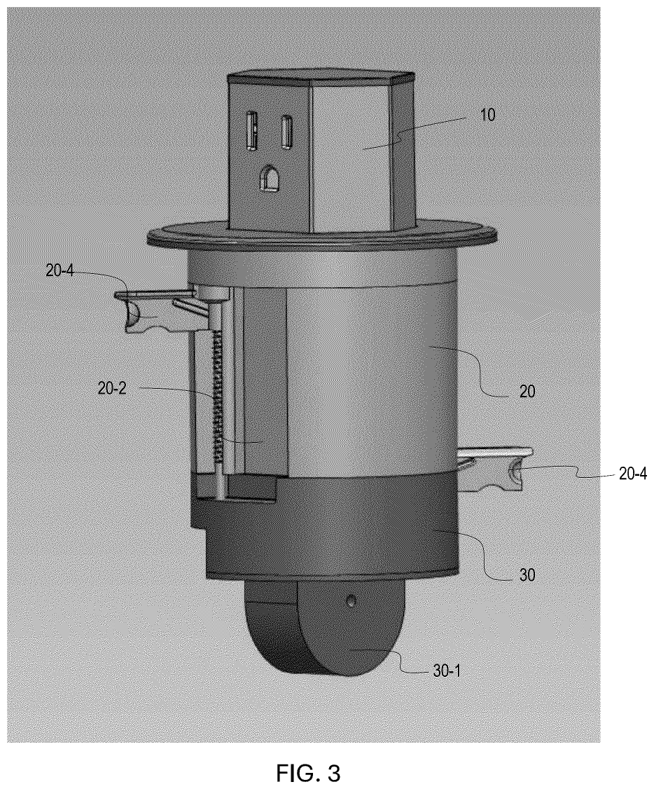

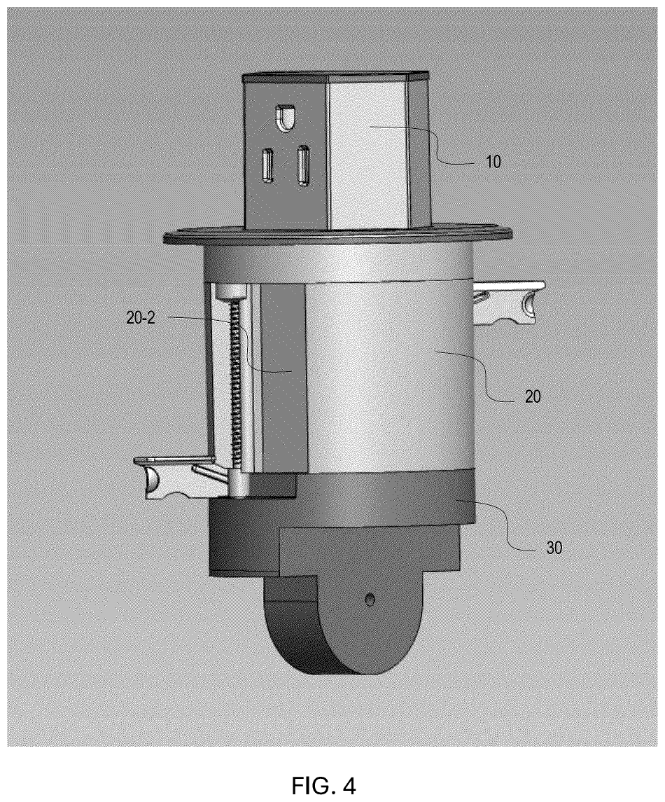

FIGS. 3-4 show outlet receptacle assembly 100 with box 40 and wire covering 50 removed for illustrative purposes.

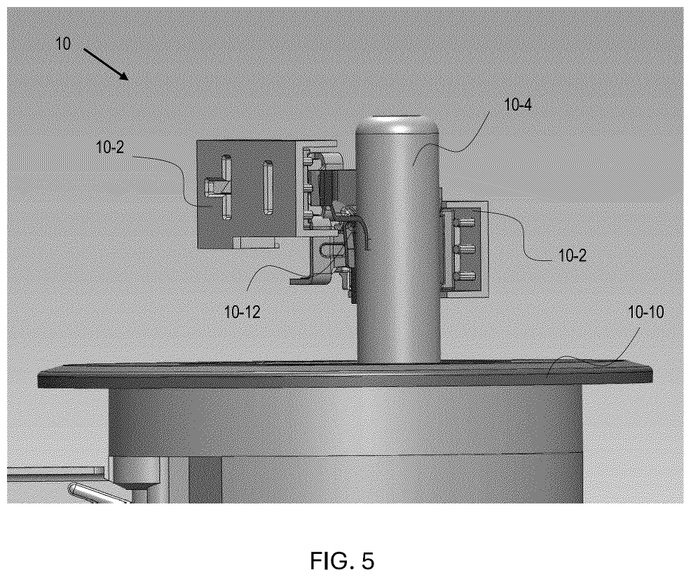

FIGS. 5-7 show outlet receptacle assembly 100 with the outer housing of the outlet pop-up receptacle 10 removed. Outlet receptacle openings 10-2, spring 10-4 (which activates the pop-up functionality of the pop-up receptacle), and contacts/terminals 10-12 are shown. A gasket (not shown, described below) can also be positioned within the top inside portion of the top housing to meet the UL performance parameters regarding the spill test (as should be understood by a person of ordinary skill in the art in conjunction with a review of this disclosure).

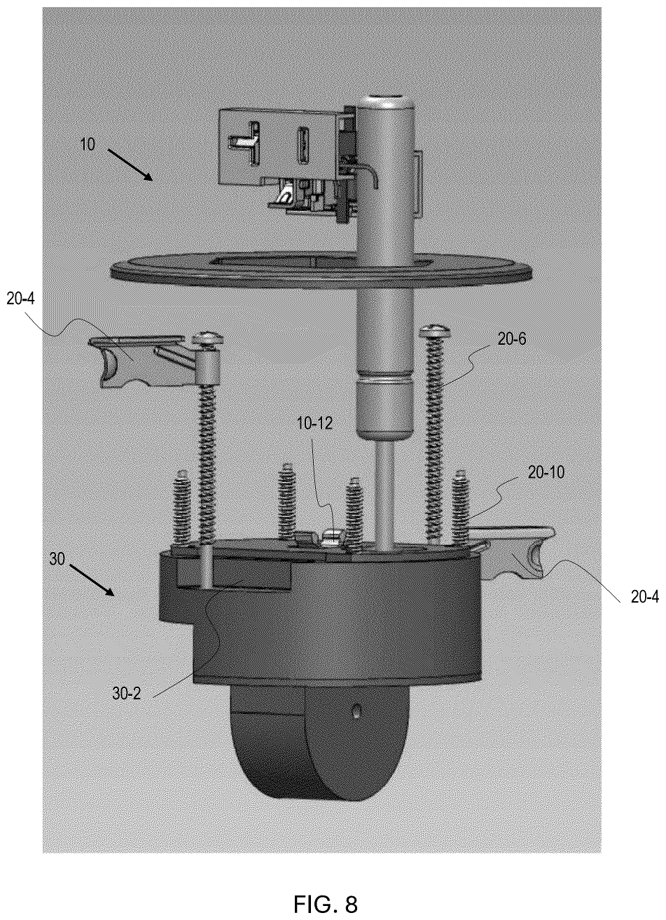

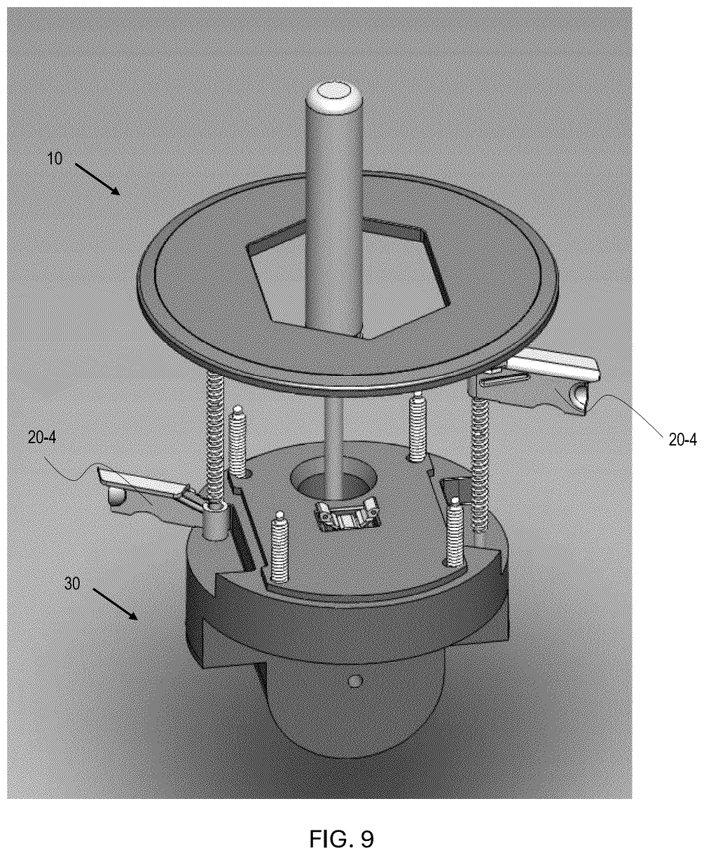

FIGS. 8-9 show outlet receptacle assembly 100 with the outer housing of the outlet pop-up receptacle 10 and top receptacle 20 removed. Attachment screws 20-10 (attach plug connector base 20-14 to plug connector body 20-2), swing brackets 20-4 and related screws 20-6 (which, when turned, can move the swing brackets up and down the respective screws and can move the swing bracket about the axis of a respective screw), and contacts/terminals 10-12 are shown (which can connect to other contacts/terminals and wires received through the wire covering 50). A cutout portion 30-2 for each swing bracket 20-4 to fit within is also shown.

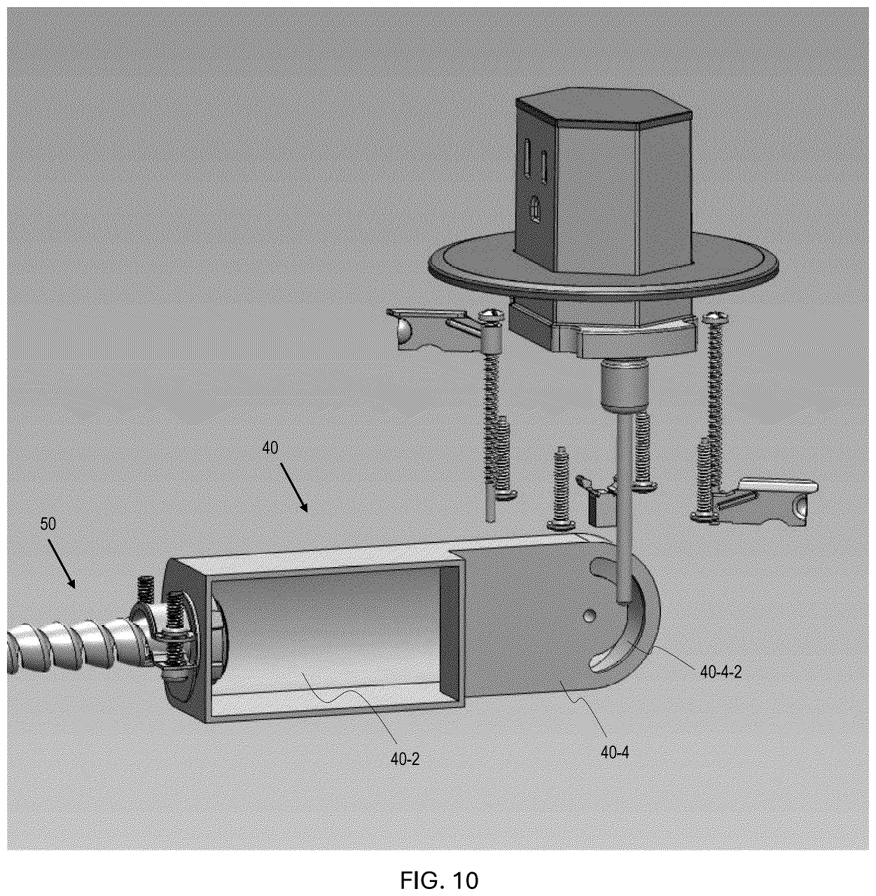

FIG. 10 shows the outlet receptacle assembly 100 with the bottom housing 30 to top housing 20 removed. The open interior of the housing 40-2 of the box 40 and the opening 40-4-2 (which allows the box 40 to move with respect to the bottom housing 30 (via a cam mechanism, for example), as should be understood by those of ordinary skill in the art) of a second end 40-4 of the box 40 is also shown.

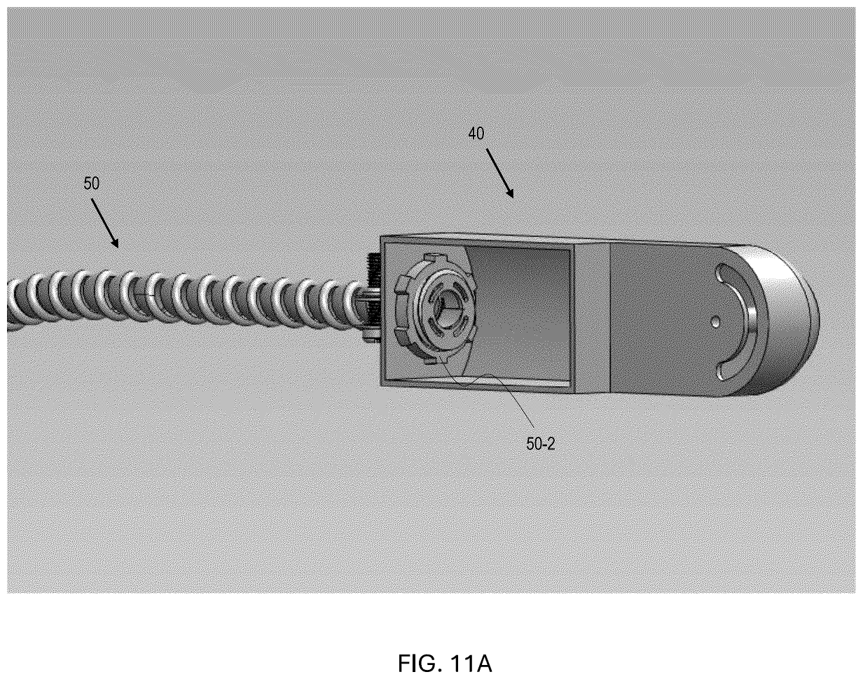

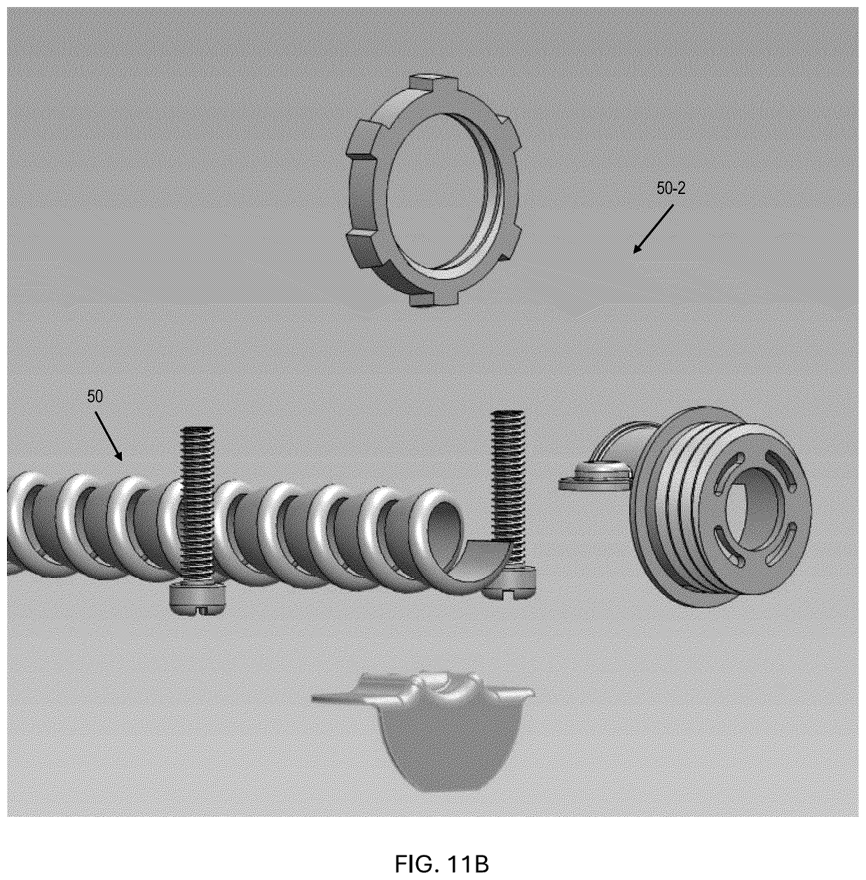

FIG. 11A shows the box 40 and the wire covering 50 with an attachment mechanism 50-2 attaching the wire covering to the box 40 and FIG. 11B shows attachment mechanism 50-2 in an exploded condition.

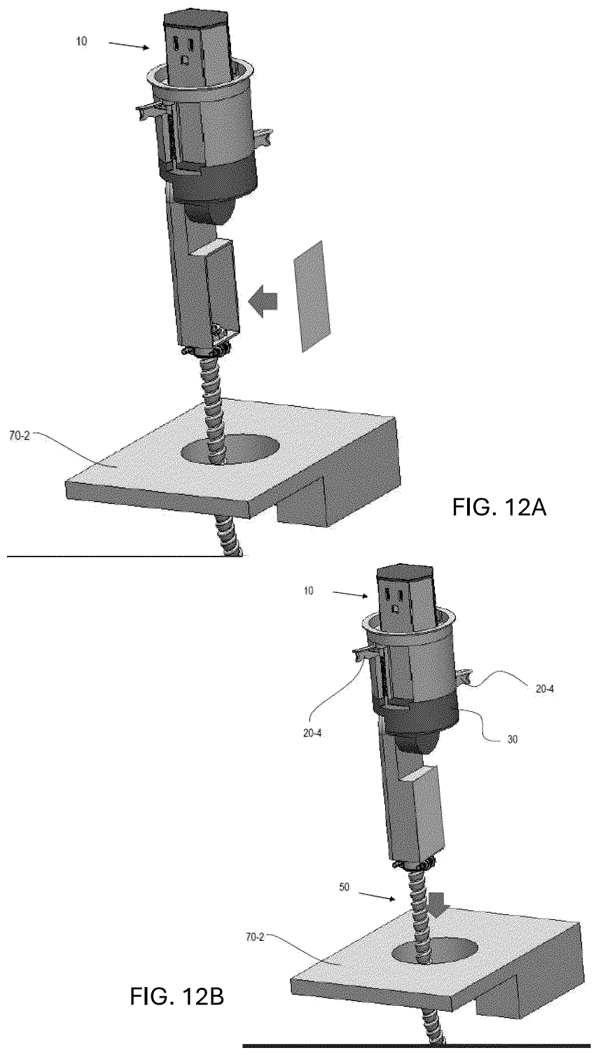

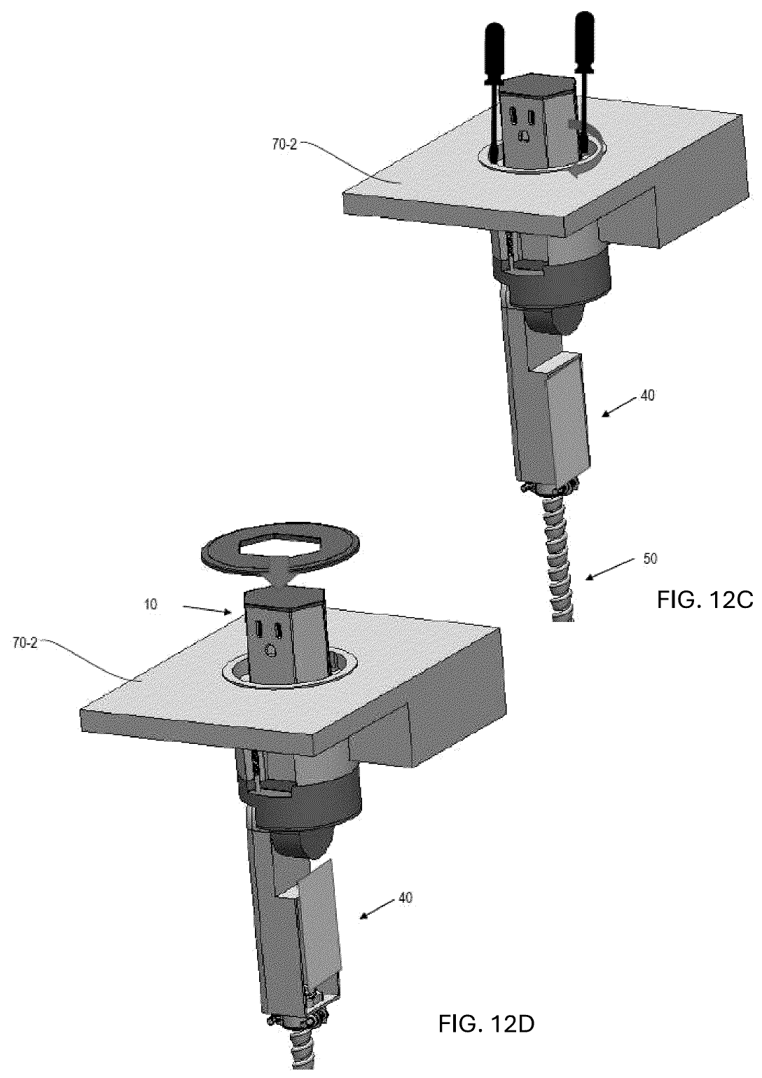

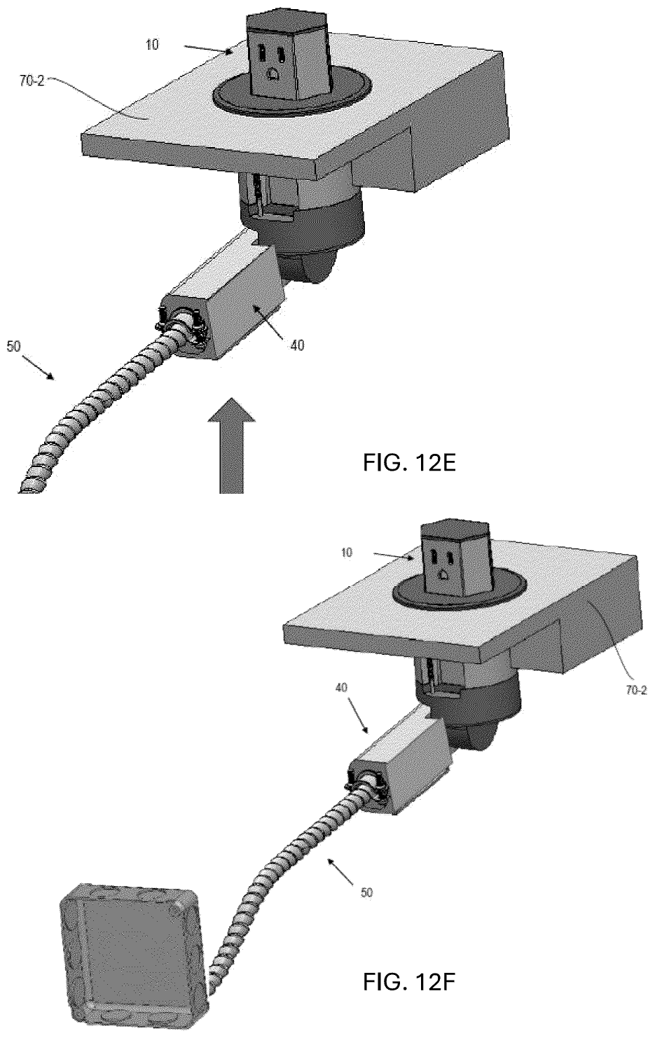

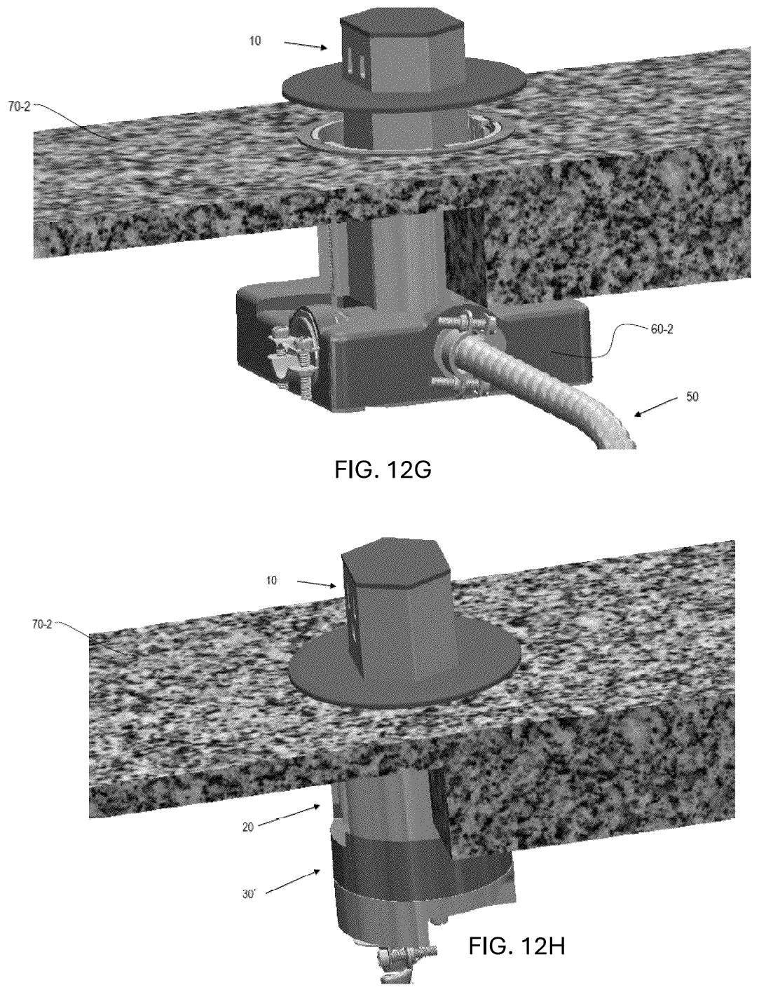

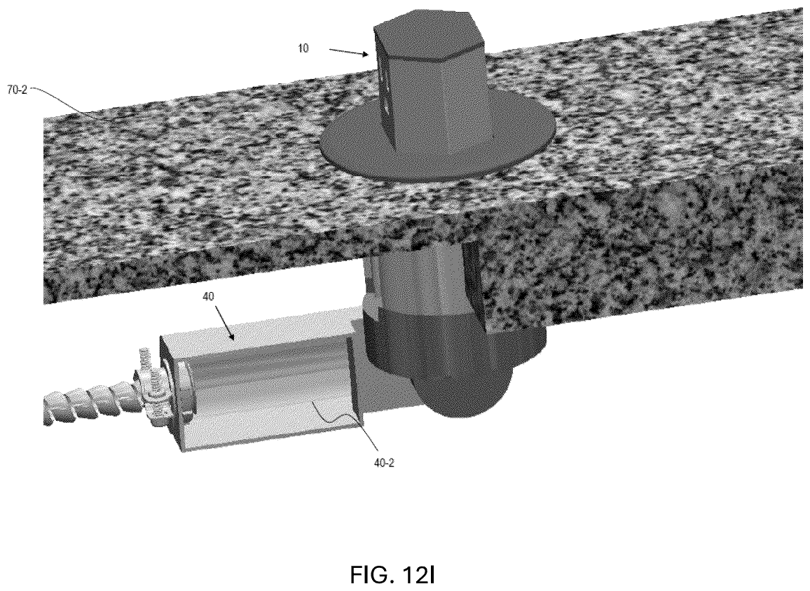

Referring to FIGS. 12A-12F, steps of installing the embodiment shown in FIGS. 1-11B are shown. This embodiment 100 can be wired above a counter and dropped into the installation hole. The box portion can be rotated up 90 degrees to the position shown making it protrude less under the cabinet. The cable can be wired to the rotatable integral box outside of the cabinet and a cover plate can be installed (FIG. 12A). The device can be positioned into the counter top or other installation hole (FIG. 12B) and the brackets can be tightened from the top side (FIG. 12C). The cover and gasket (gasket not shown) can be fitted onto the assembly (FIG. 12D) and the box can be rotated up 90 degrees to be parallel with the bottom of the countertop as shown-the box will have a positive stop and catch when rotated to hold it in place (FIG. 12E). Lastly, the other end of the wire can be connected to the box (FIG. 12F). FIGS. 12G-12I show additional views of the assembly 100 installed into a countertop, for example.

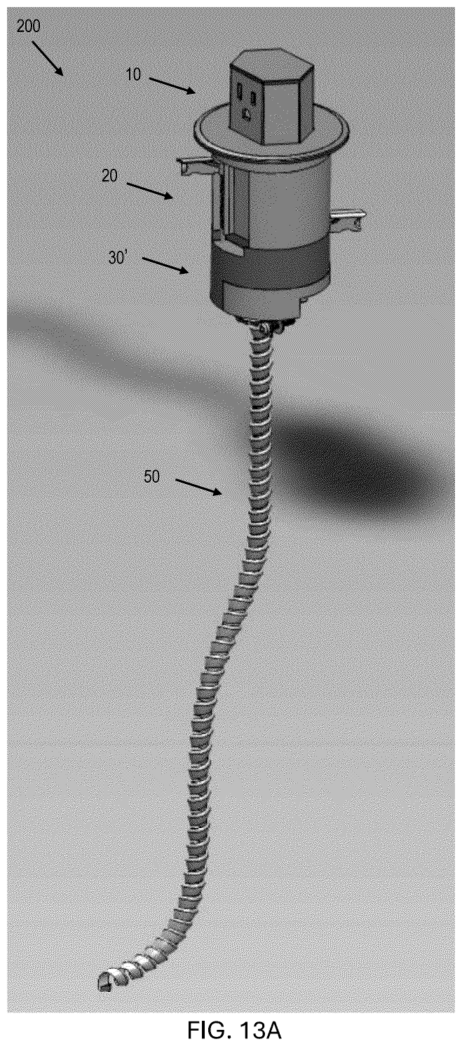

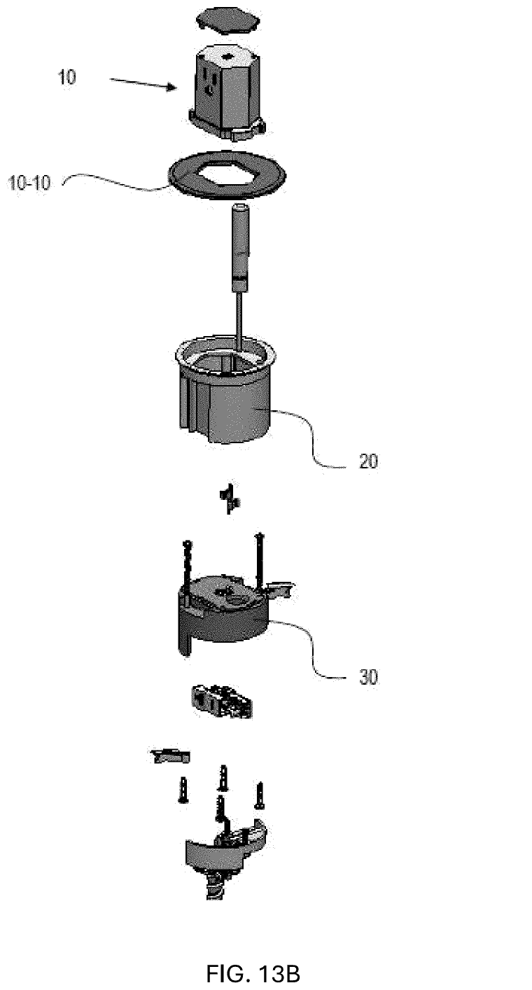

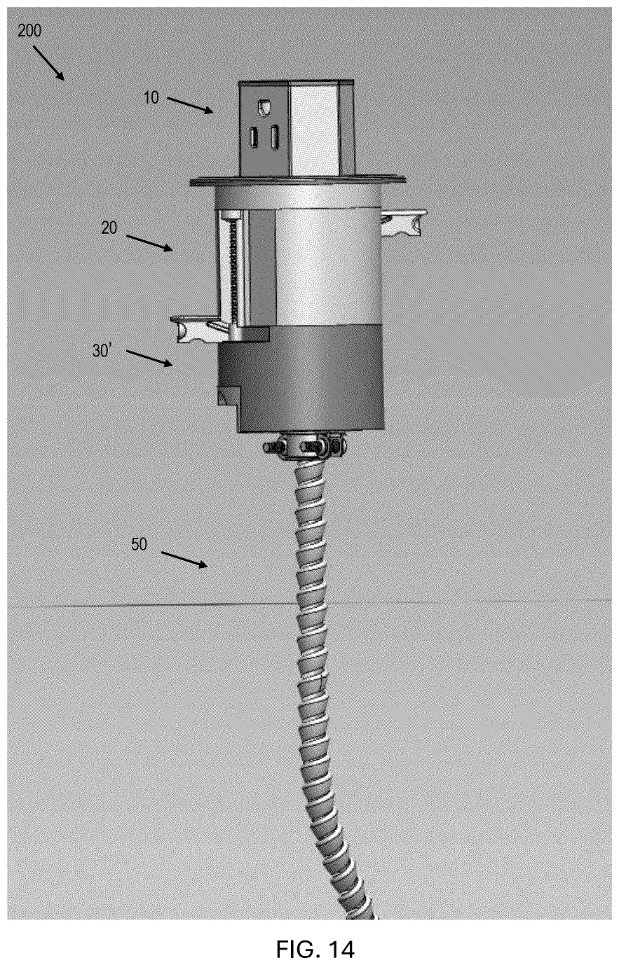

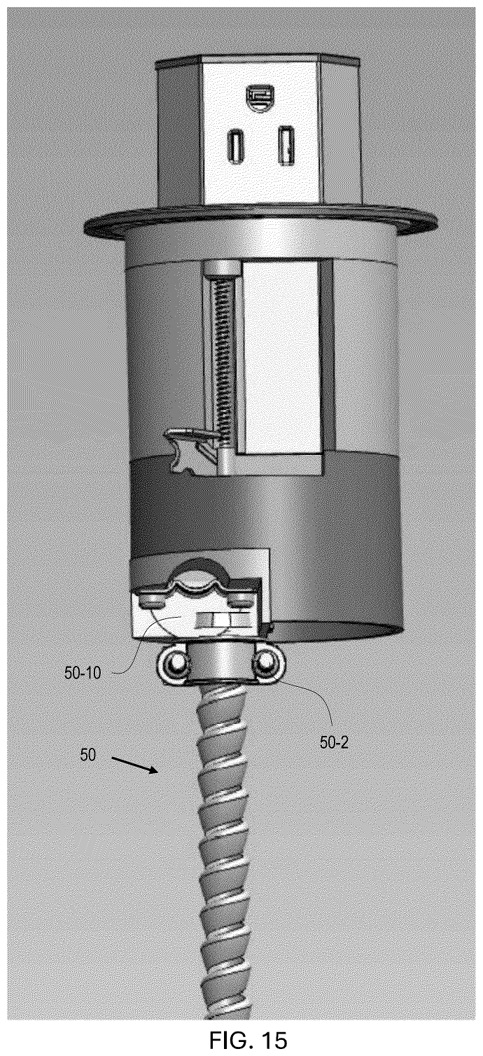

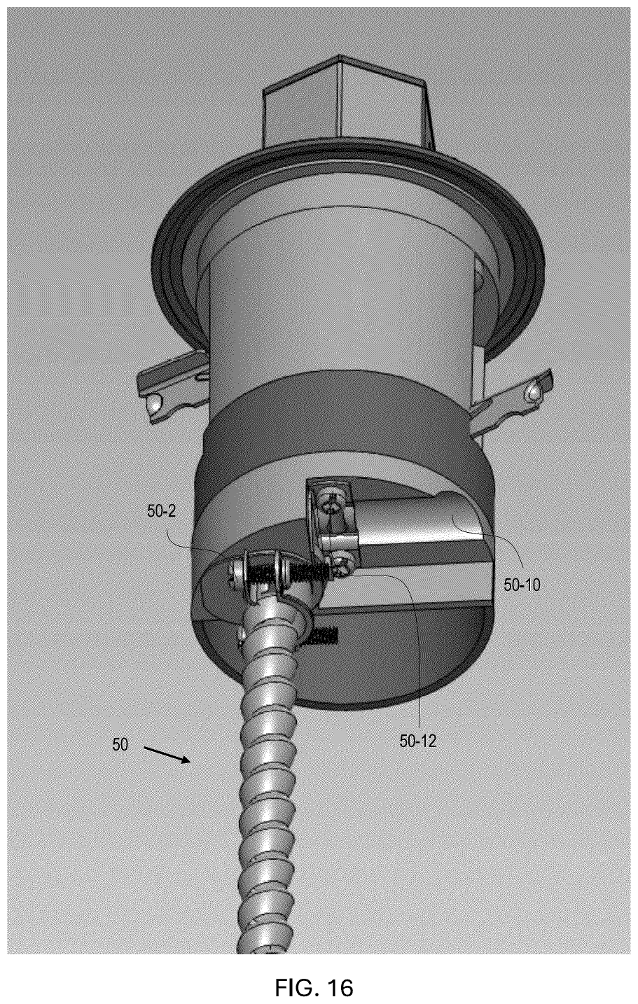

FIGS. 13A-18B show various schematic representations and views of a second embodiment (assembly 200) of this disclosure. This embodiment is the same as the first embodiment except there is no box 40. The wire cover 50 extends out from the bottom of the bottom housing 30′ along the longitudinal axis (vertical-up and down as shown), although the wire cover 50 can extend out from the bottom housing 30′ at an angle to the longitudinal axis (the connection of the wire cover can be fixed or be moveable to these positions).

FIGS. 13A and 14-16 show a fully assembled outlet receptacle assembly 200 structured and configured in part, as discussed above, and FIG. 13B shows an exploded view of the same. Bottom housing 30 includes a smaller section (wire box) 50-10 where the wires extend from the wire covering 50. Attachment mechanism 50-2 for the wire covering 50 to section 50-10 is also shown. Attachment screws 50-12 used to attach section 50-10 to the rest of bottom section 30 is shown.

FIG. 17 shows section 50-10 alone with attachment screws 50-12, attachment mechanism 50-2, and wire covering 50.

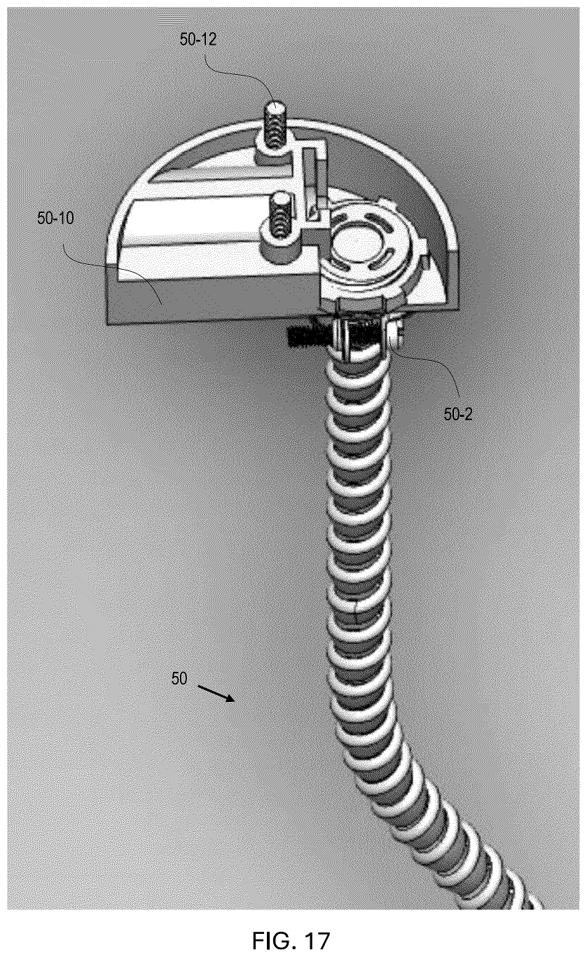

FIG. 18A shows the attachment mechanism 50-2 with attachment housing 50-6 and wire covering 50.

FIG. 18B shows an exploded view of the components shown in FIG. 18.

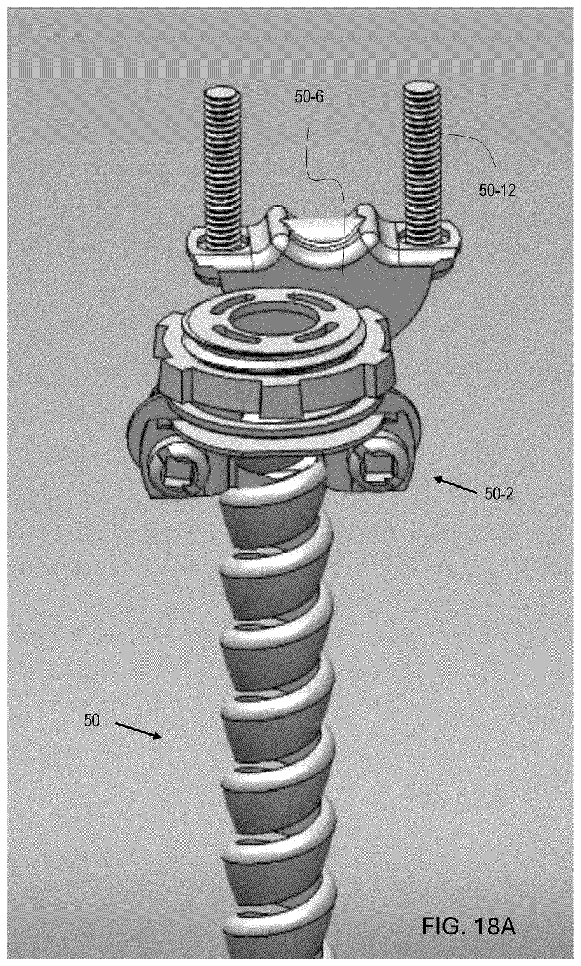

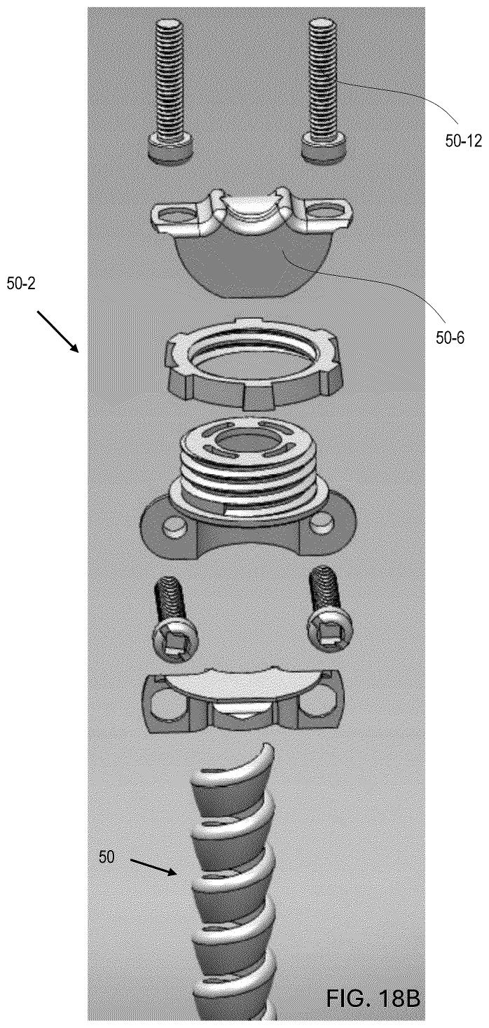

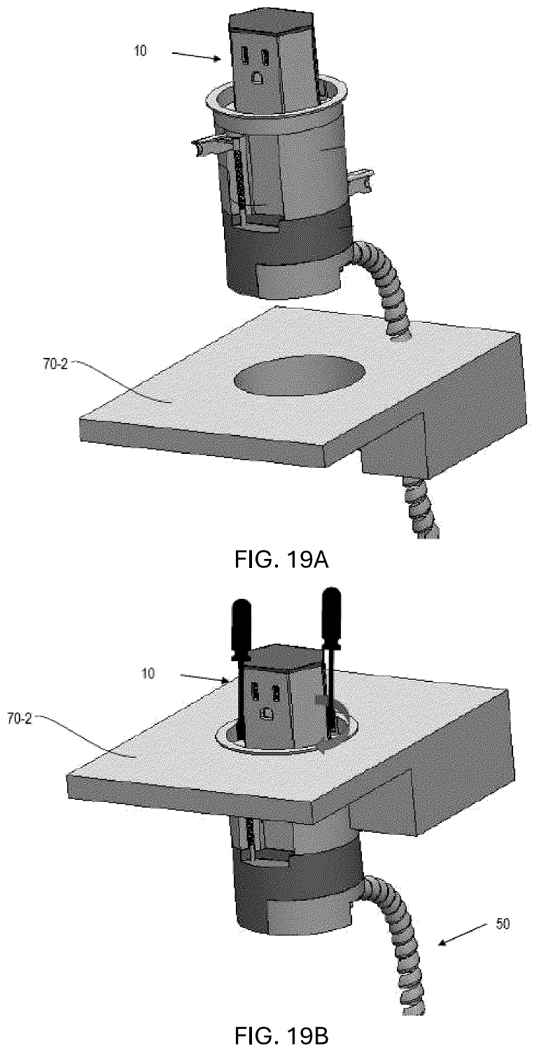

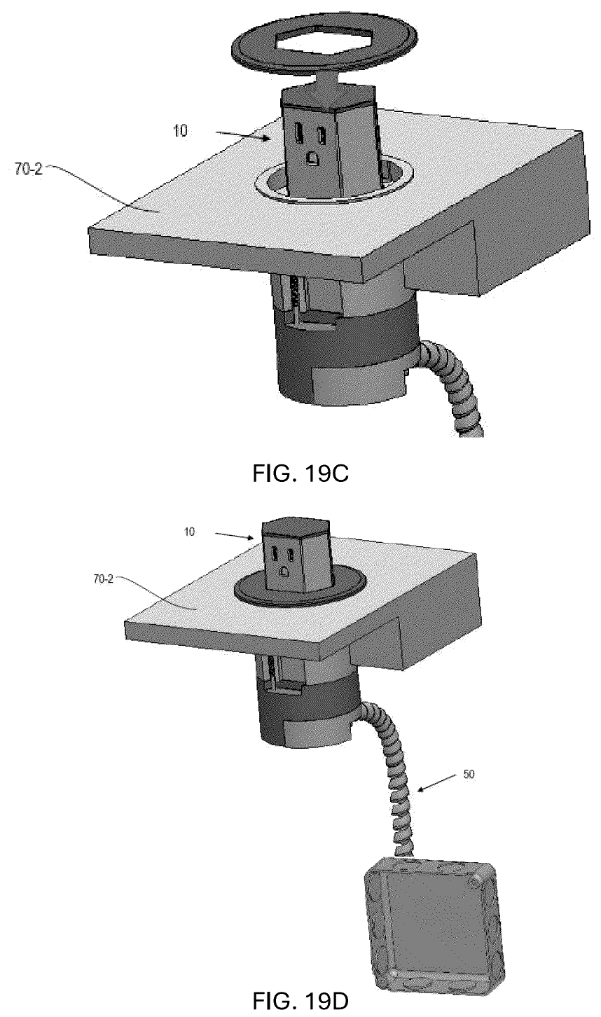

FIGS. 19A-19D show steps to install the embodiment described above (200) with respect to FIGS. 13A-18B. This embodiment 200 can be wired above the counter and dropped into the installation hole. The swing brackets can be tightened from the top and the cable can come straight out of the bottom, ideally positioned in a cabinet or other receptacle with depth (i.e., long and narrow to above taking up space horizontally). Referring to FIG. 19A, the device can be wired from the top (the cable may need to come straight out of the bottom) and be placed into the hole. Next, the two swing brackets can be tightened from the top side (FIG. 19B) and the cover and gasket (gasket not shown) can be snapped to the assembly (FIG. 19C). The other end of the cable wire can be wired to a box at the bottom of the cabinet, for example, (FIG. 19D).

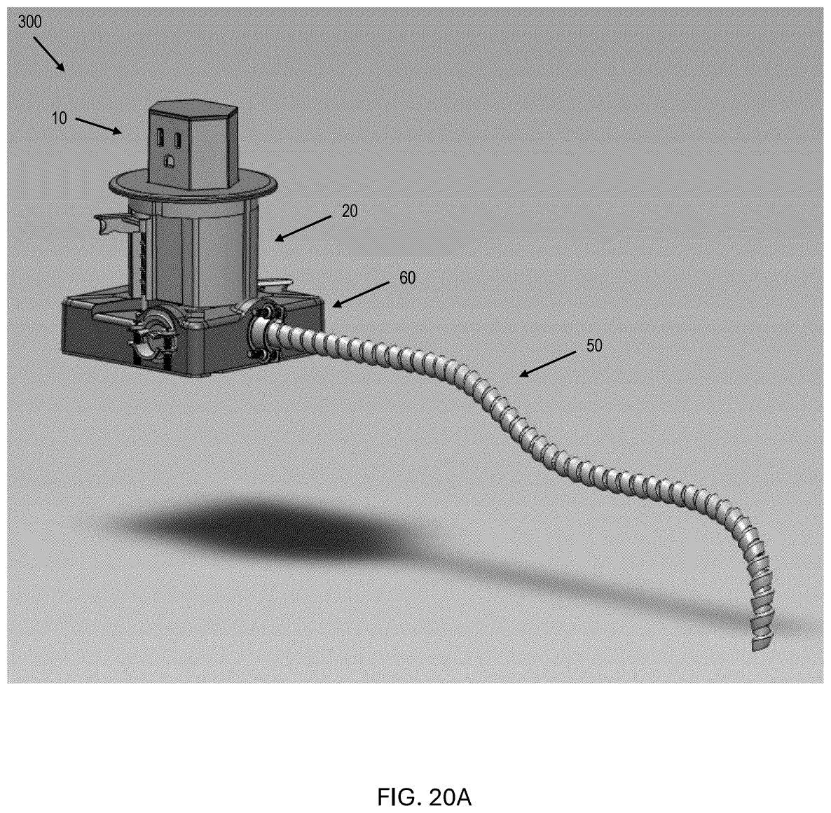

FIGS. 20A-25 show various schematic representations and views of a third embodiment (assembly 300) of this disclosure. This embodiment is the same as the first embodiment except there is no box 40 and no bottom housing 30. Instead, there is a wire box 60, which is similar to box 40 except that it is attached to the bottom of top housing 20 along the longitudinal axis (vertical-up and down as shown) and the wire covering 50 extends from a side of the wire box 60 (although, wire covering 50 can extend from any other portion of wire box 60.

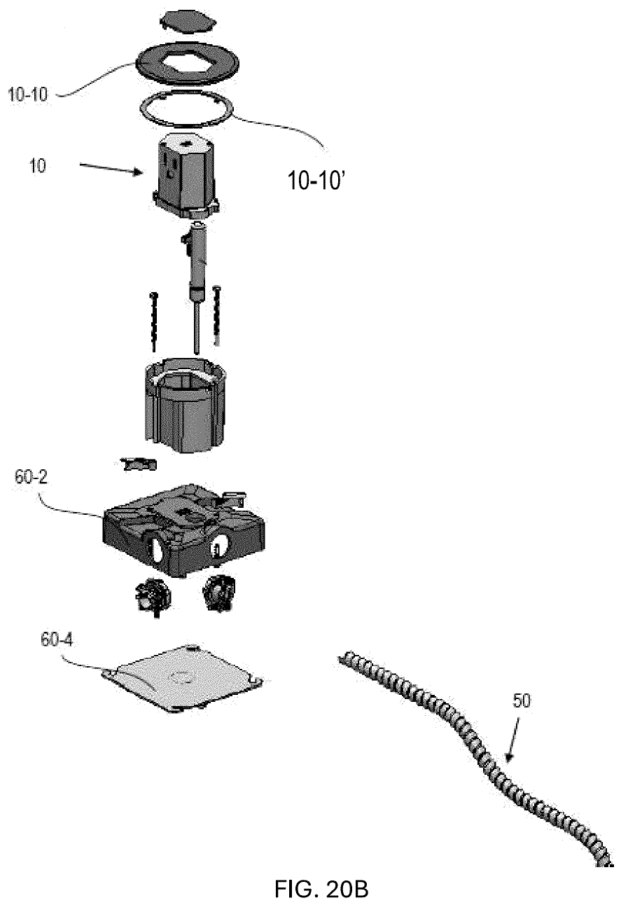

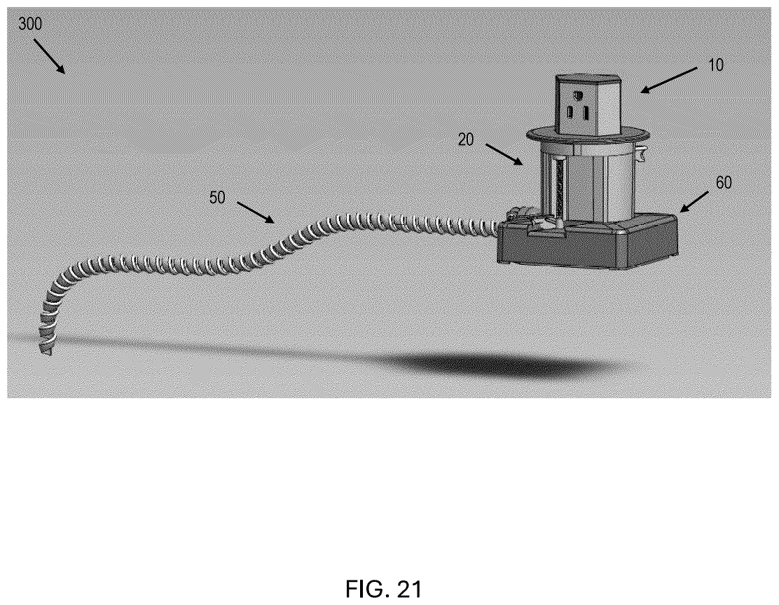

FIGS. 20A-21 show a fully assembled outlet receptacle assembly 300 structured and configured in part, as discussed above, and FIG. 20B shows an exploded view of the same. This embodiment goes up from the bottom of a surface such as a countertop, allowing a larger box for ease of wiring and possible feed through, yet not requiring any more depth in the cabinet.

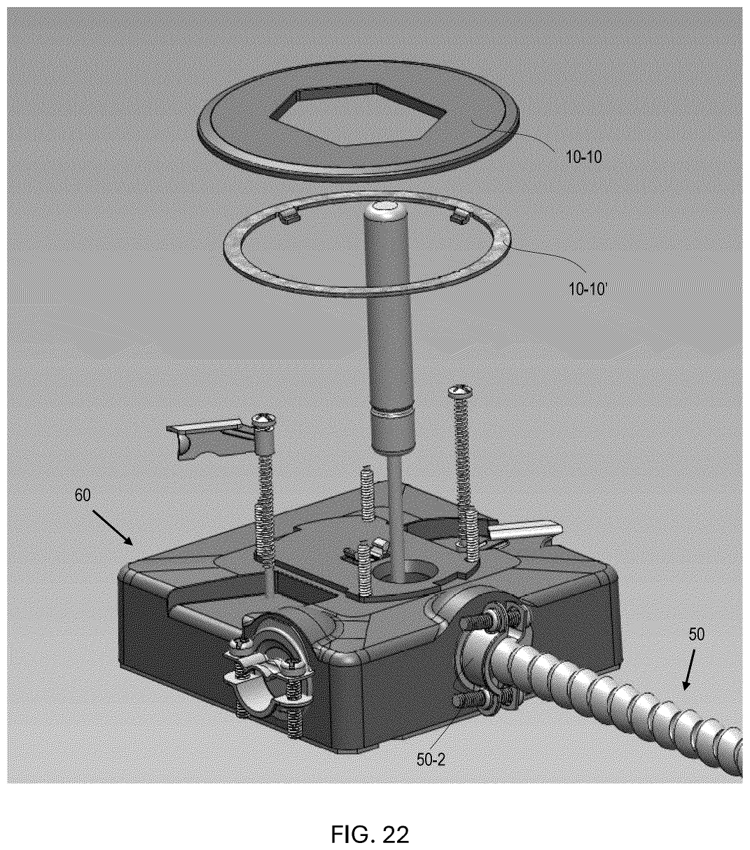

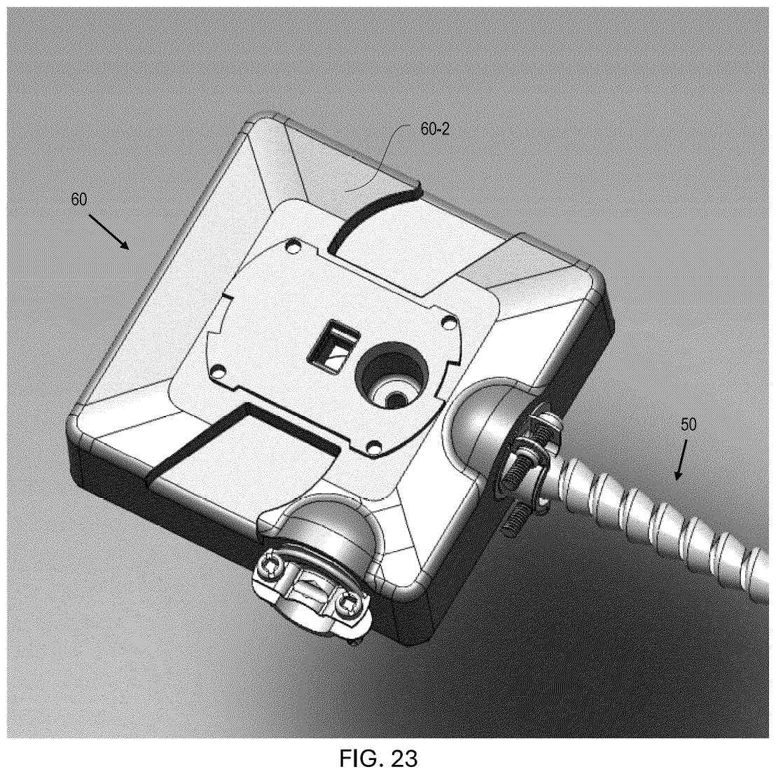

FIGS. 22 and 23 show wire box 60 with other elements of the assembly removed.

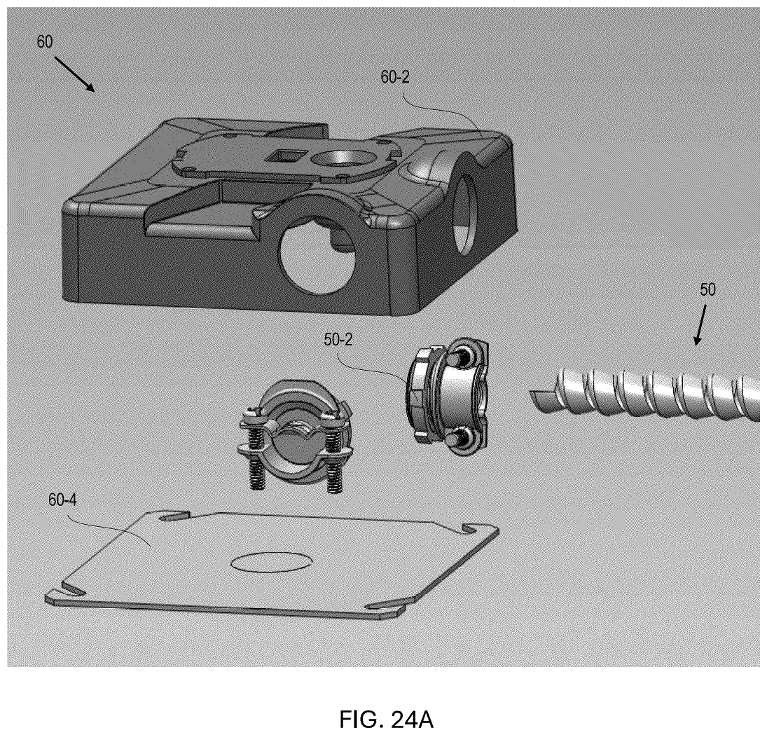

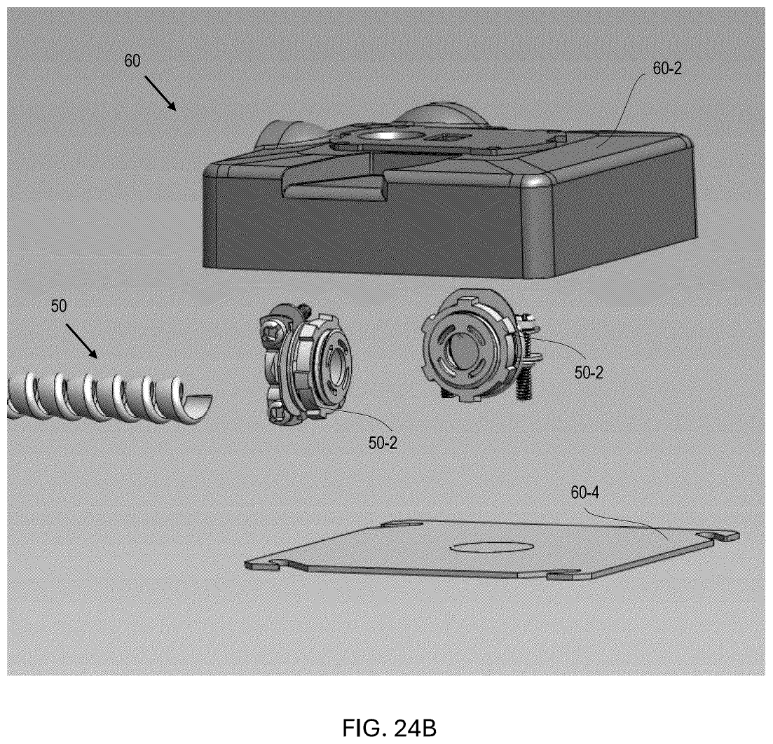

FIGS. 24A-24B show exploded views of the wire box 60, which includes top housing 60-2 and bottom cover 60-4.

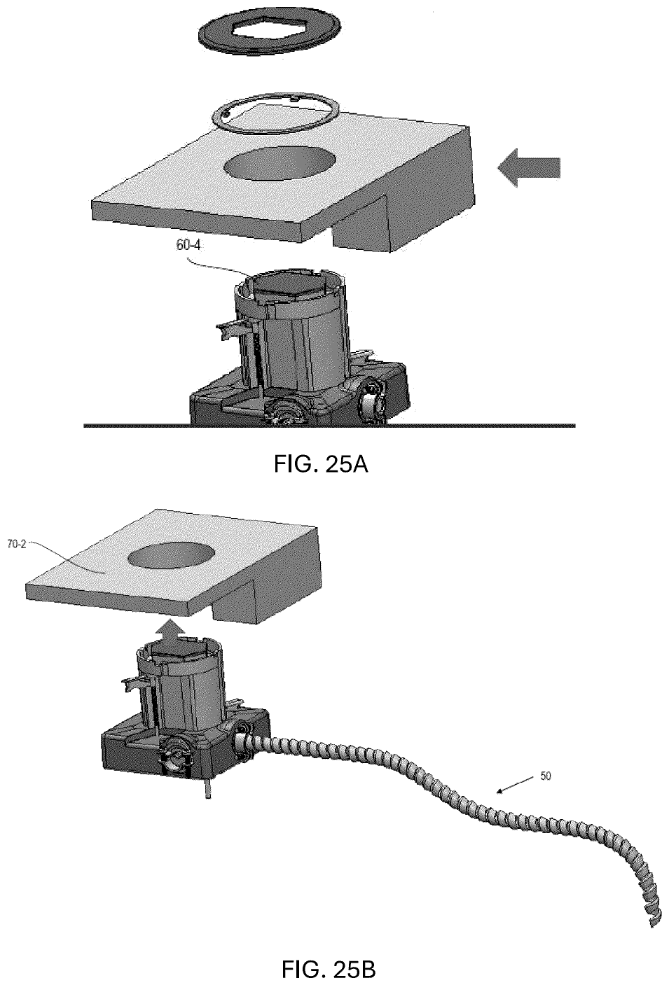

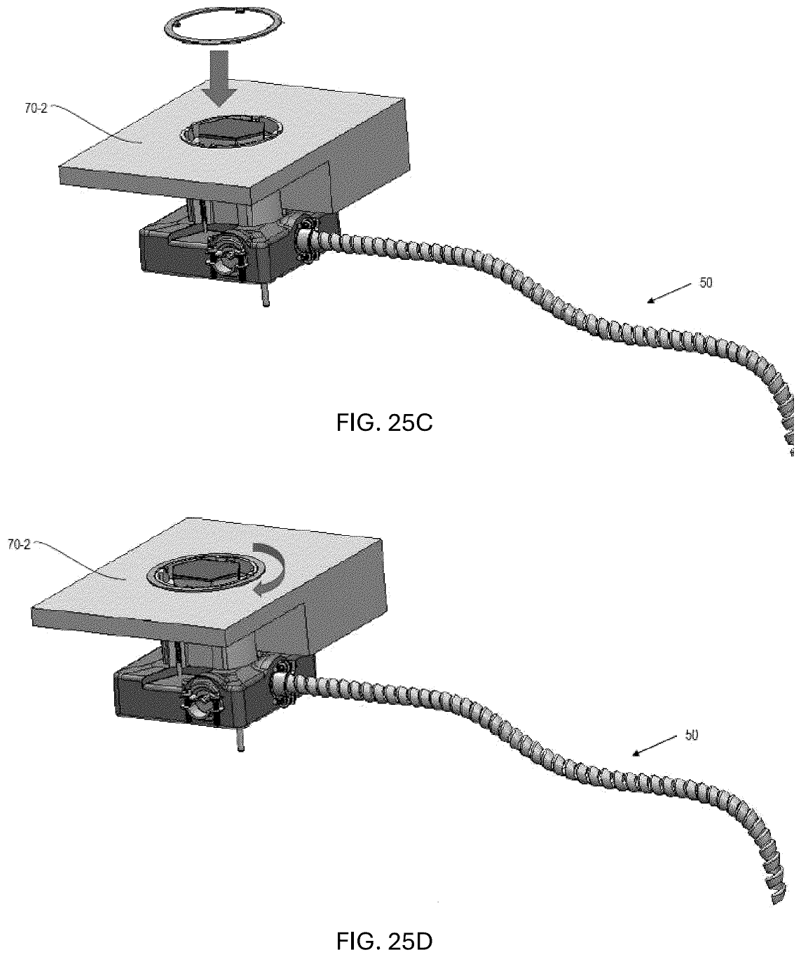

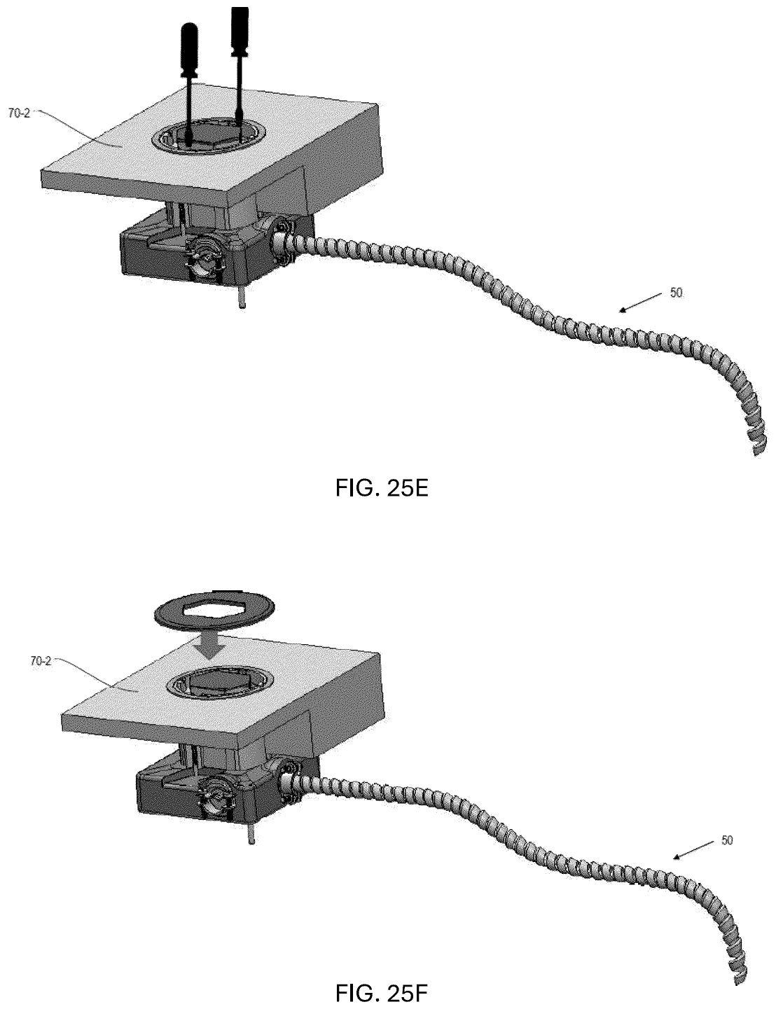

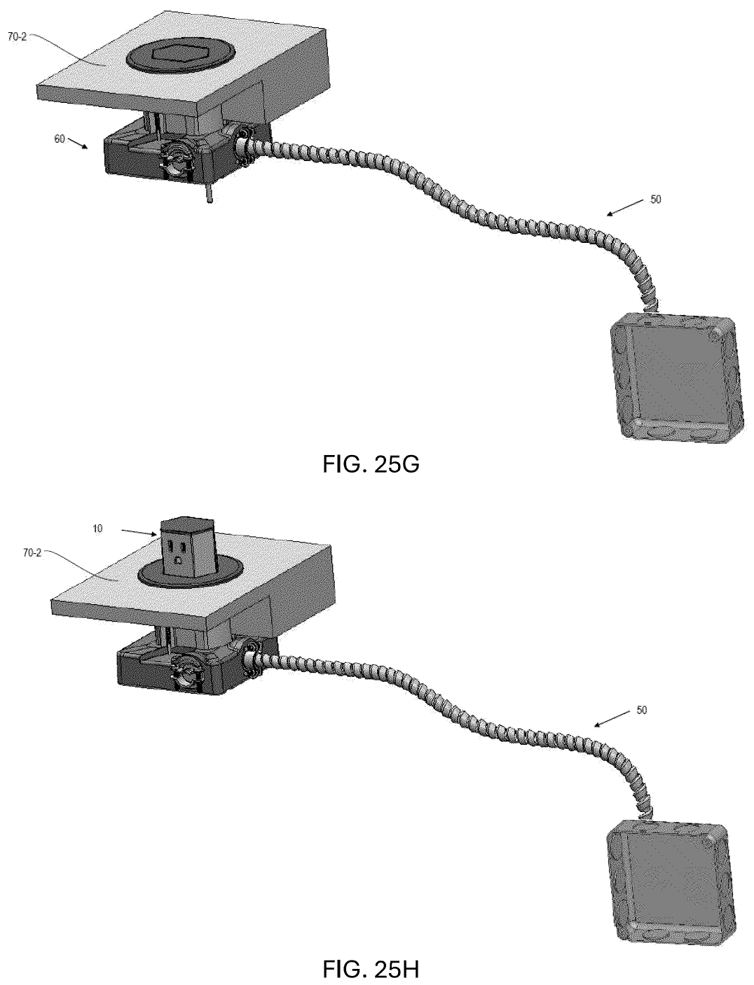

FIGS. 25A-25G show steps of assembling the embodiment shown in FIGS. 20-24B. A metallic armored cable 50 (or Romex) can be wired to the integral box 60 outside of a cabinet or installation location and a cover plate can be installed (FIG. 25A). Next, the assembly can be inserted from the bottom side and into the countertop or surface (FIG. 25B). The ring can be placed overtop (FIG. 25C) and rotated in a direction to tighten (e.g., clockwise 1/8 turn) (FIG. 25D). The swing brackets can be tightened from the top side as shown (FIG. 25E). The cover and gasket (gasket not shown) can be snapped to the assembly (FIG. 25F) and the other end of the wire can be wired to the box at the bottom of a cabinet, for example (FIG. 25G). A user can then press down on the top of the device and the device can pop up as shown with a spring-loaded or similar mechanism (FIG. 25H).

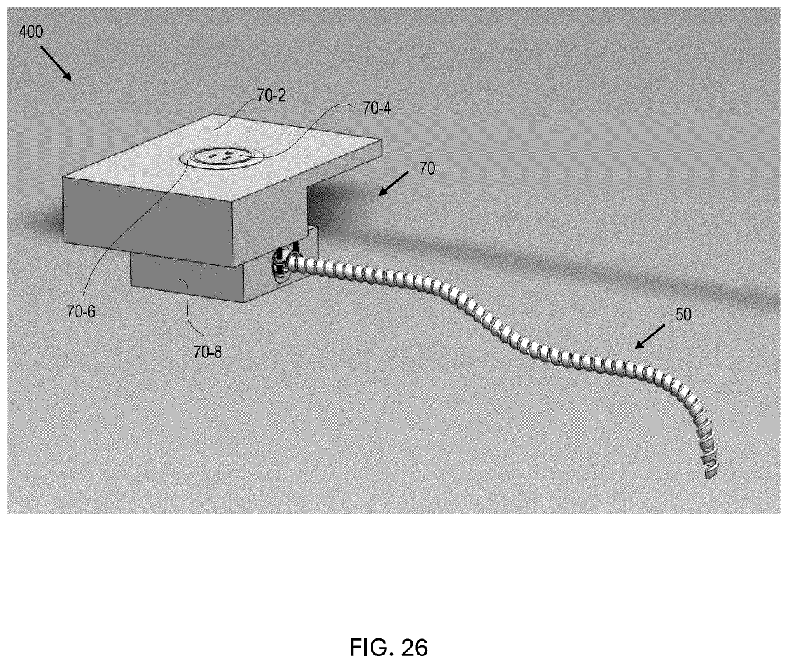

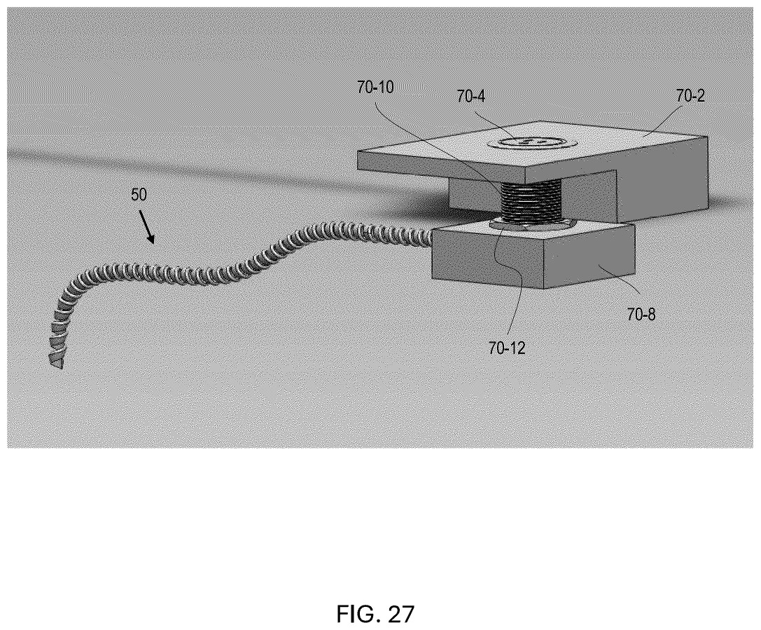

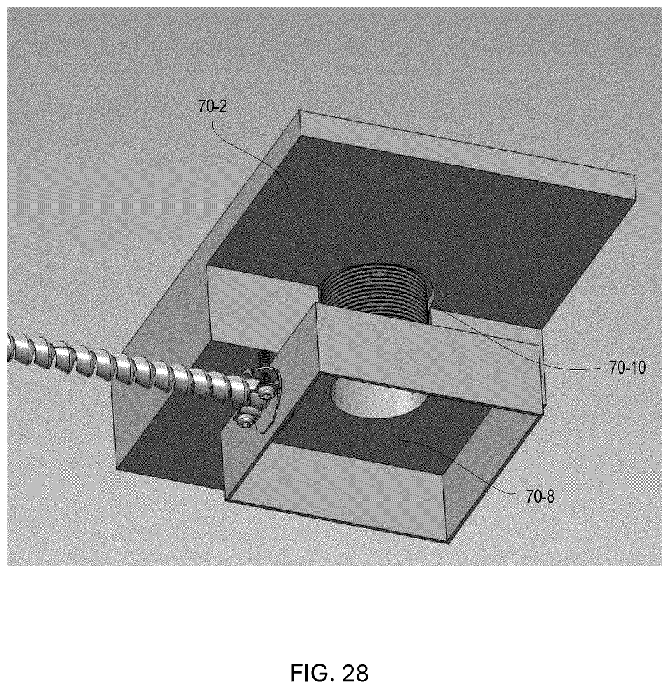

FIGS. 26-30 show various schematic representations and views of a fourth embodiment (assembly 400) of this disclosure. This embodiment is different in some ways to the first three embodiments discussed above, including that it is not a pop-up receptacle.

FIGS. 26-28 show the assembly 400 fully assembled within a countertop. The outlet receptacle 70 is shown positioned through a top surface of a countertop 70-2. The outlet receptacle cover and openings 70-4 and the trim ring 70-6 are shown substantially flush with the top surface of countertop 70-2. Wire box 70-8 is similar to wire box 60, and the wire covering 50 extends from a side of the wire box 70-8. Outlet receptacle cover and openings 70-4 are attached to body 70-10, which is configured to extend through the top surface of countertop 70-2. The outside surface of the body 70-10 can be threaded and can include a nut portion 70-12 which can include threading on its inside surface to mate and move up and down the body 70-10 via the threads (and lock the assembly in place).

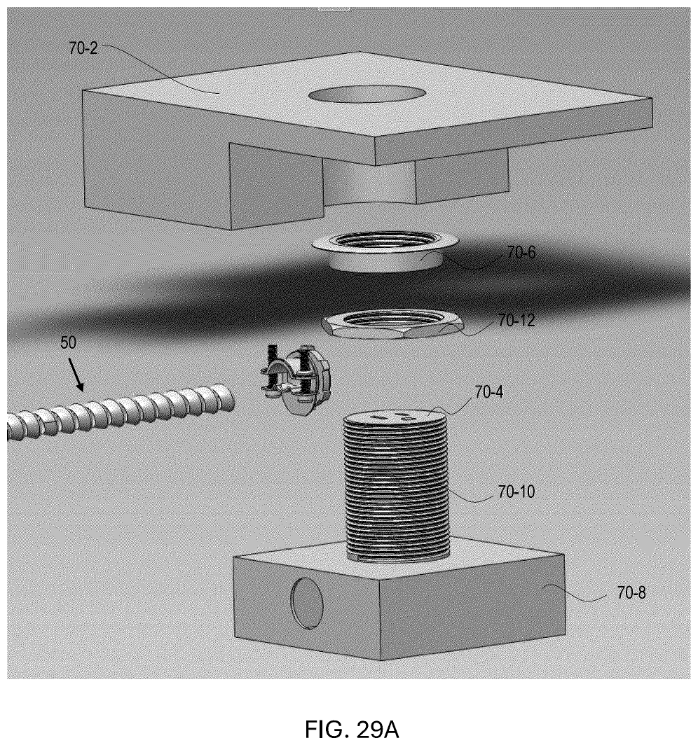

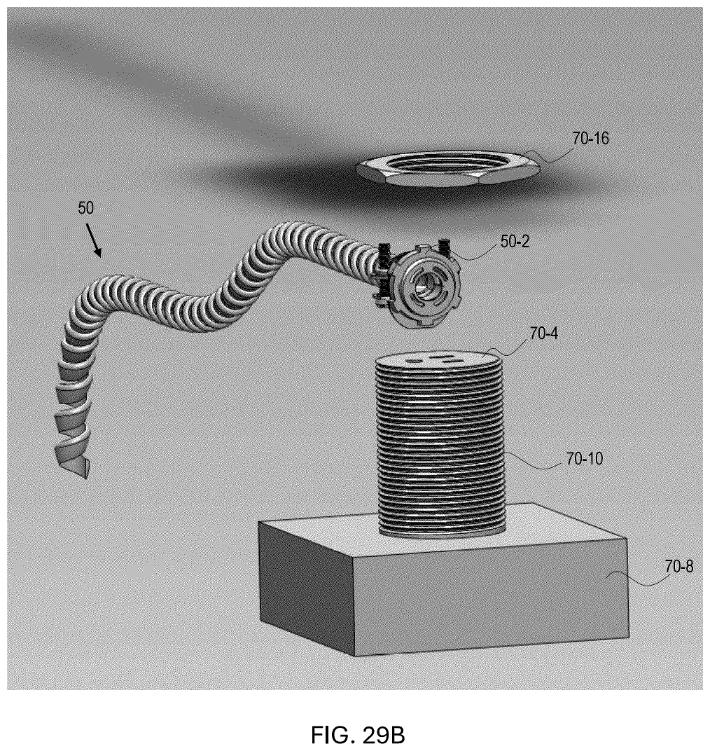

FIGS. 29A and 29B show the assembly 400 in an exploded condition with certain components removed.

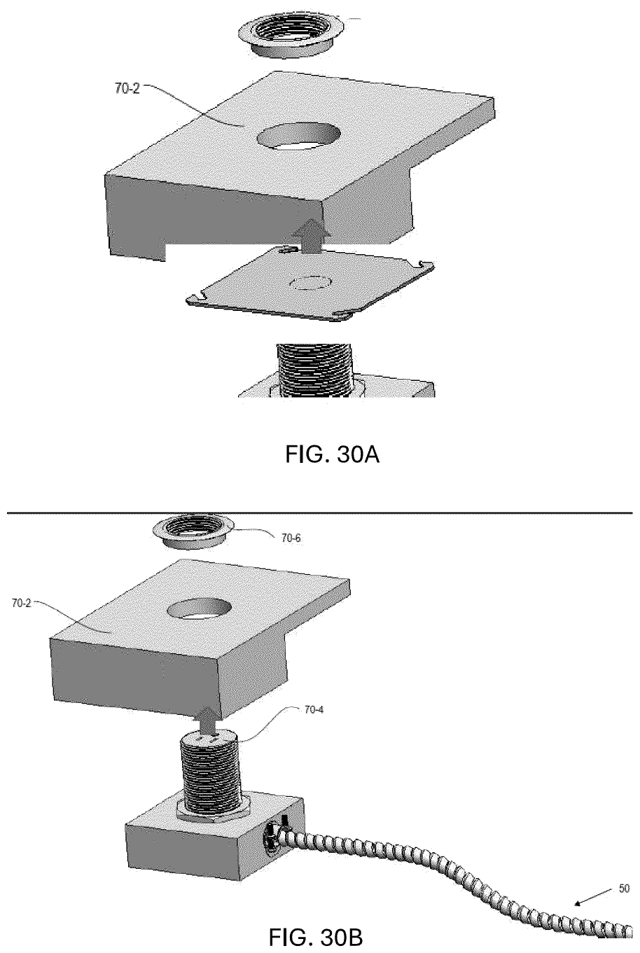

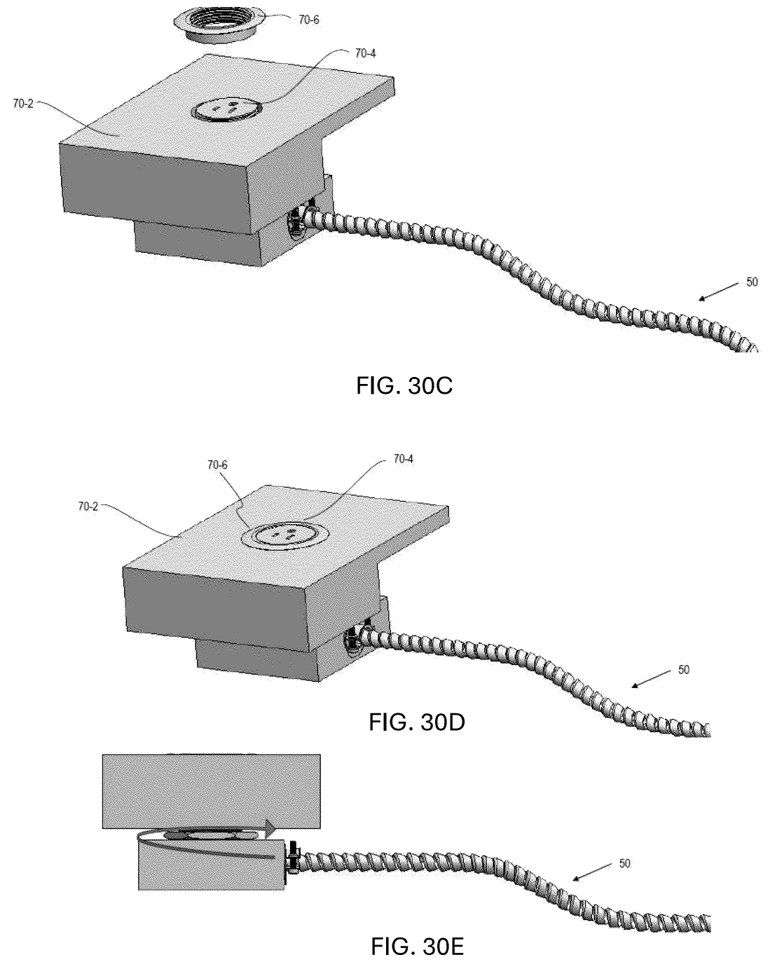

Referring to FIGS. 30A-30E, steps to install the assembly 400 shown in FIGS. 26-29B are shown. This embodiment 400 can go up from the bottom of the counter top, allowing for a larger box for ease of wiring and possible feed through, yet not requiring any more depth in the cabinet or installation location. The cable can be wired to the integral box outside of the installation location and the cover plate can be installed (FIG. 30A). The assembly 400 can be inserted from underneath the installation surface and into the countertop (FIG. 30B) and the screw cap from the top side can be screwed onto the assembly 400 (FIG. 30C). Lastly, the screw nut can be tightened from underneath the installation surface (FIGS. 30D-30E).

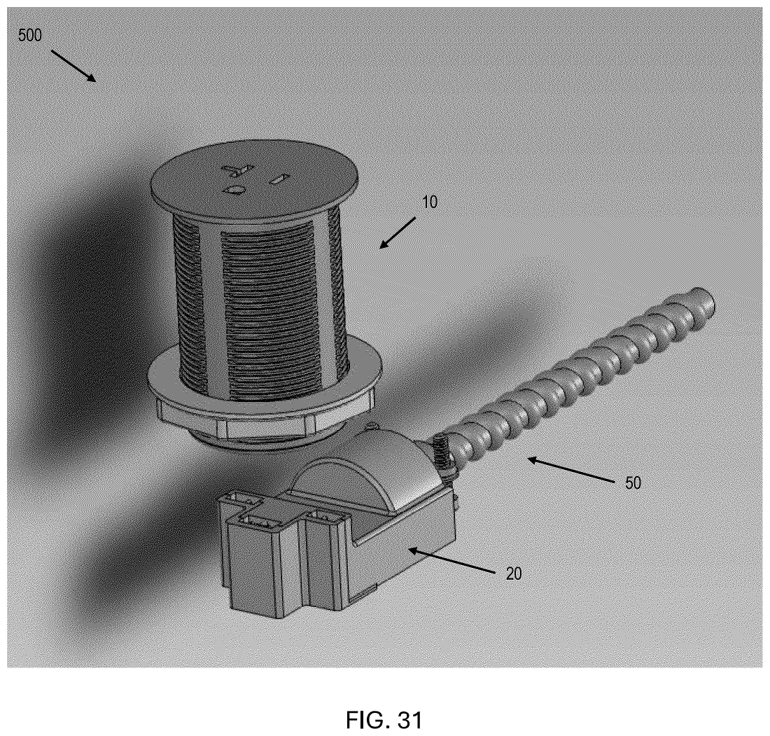

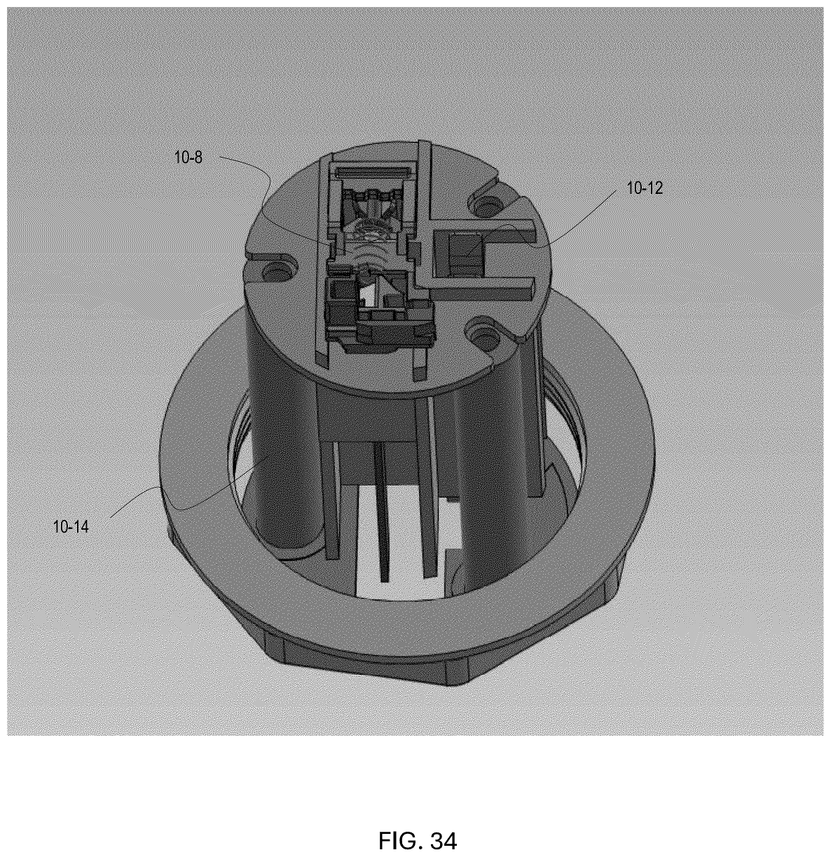

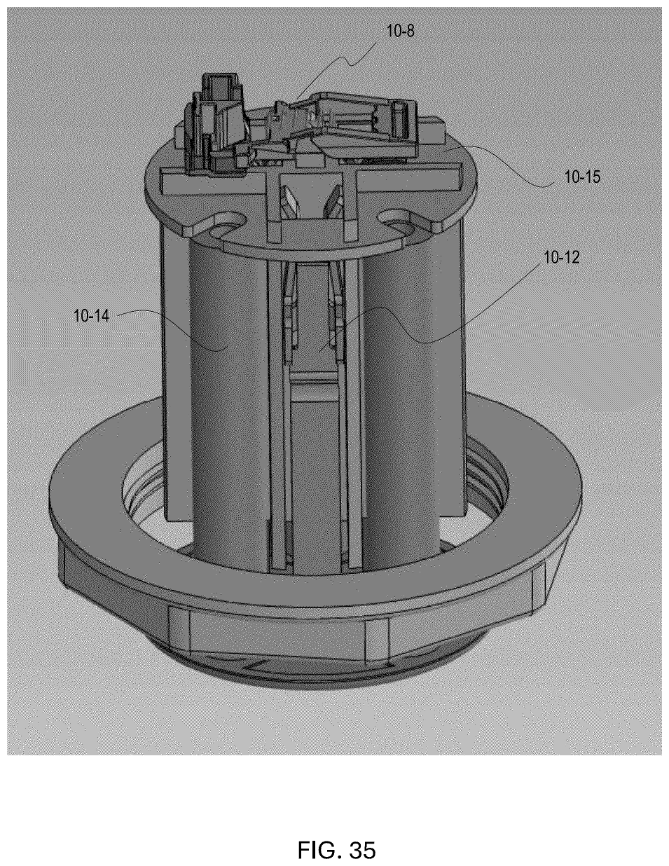

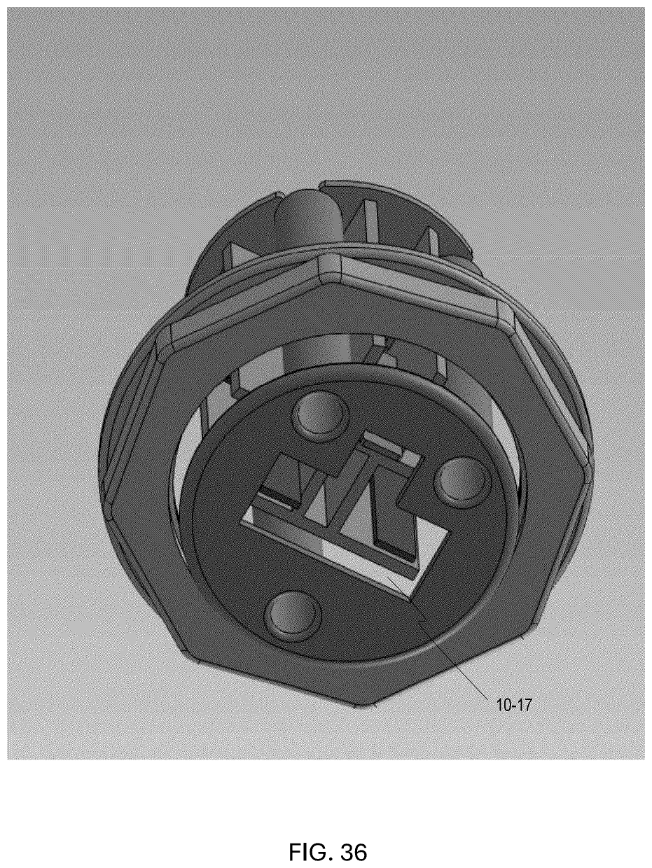

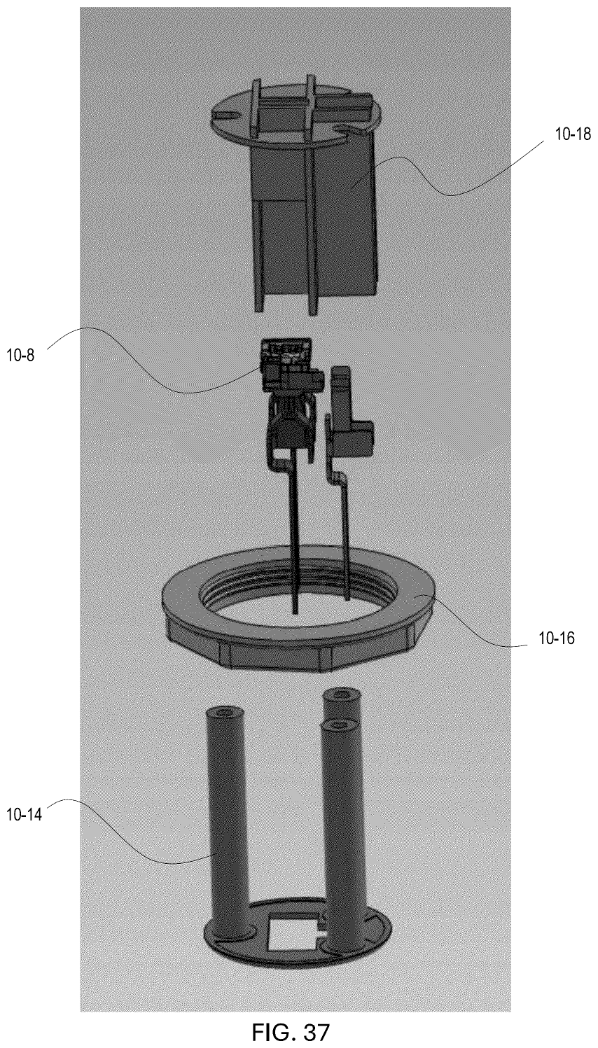

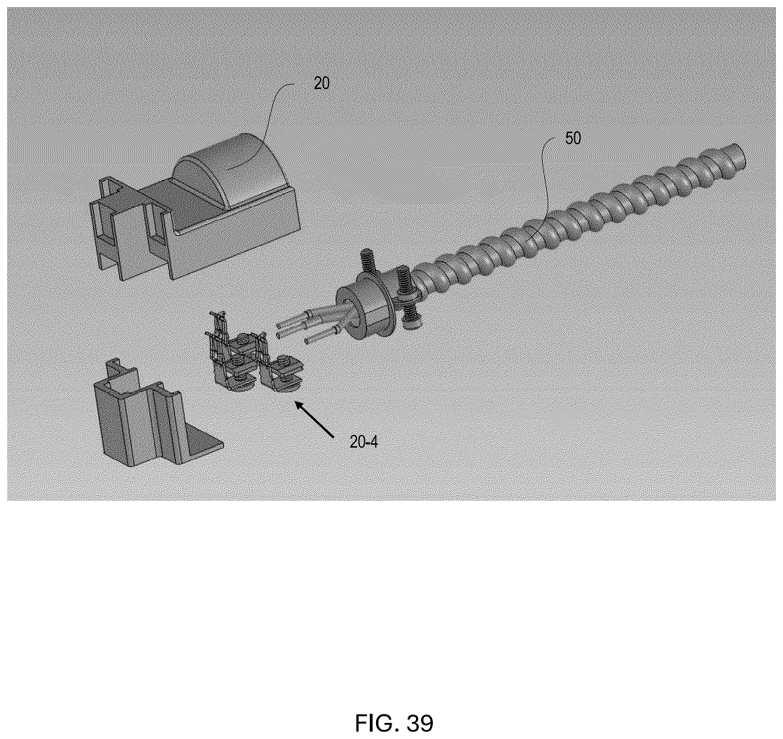

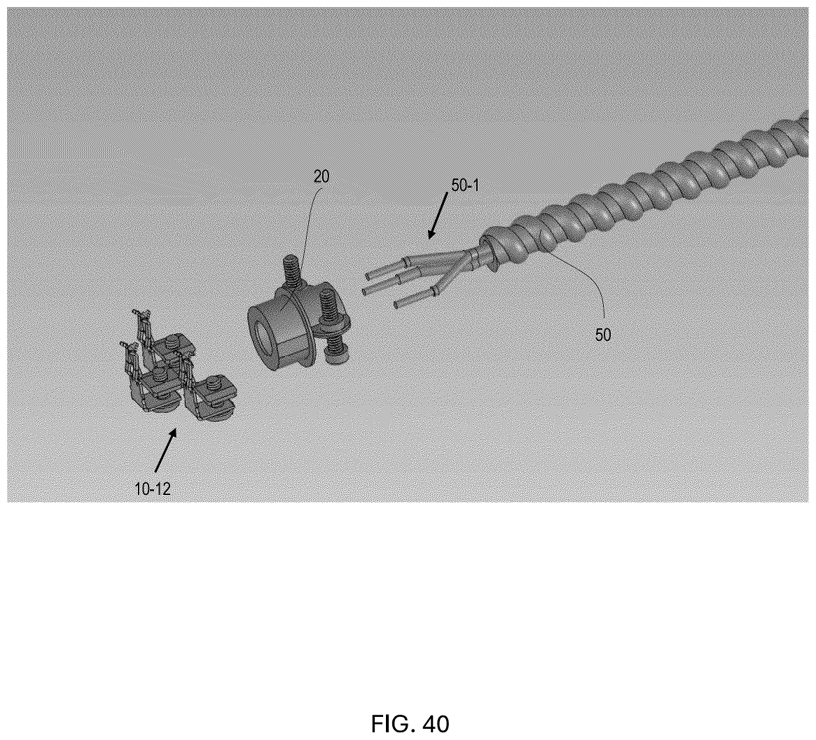

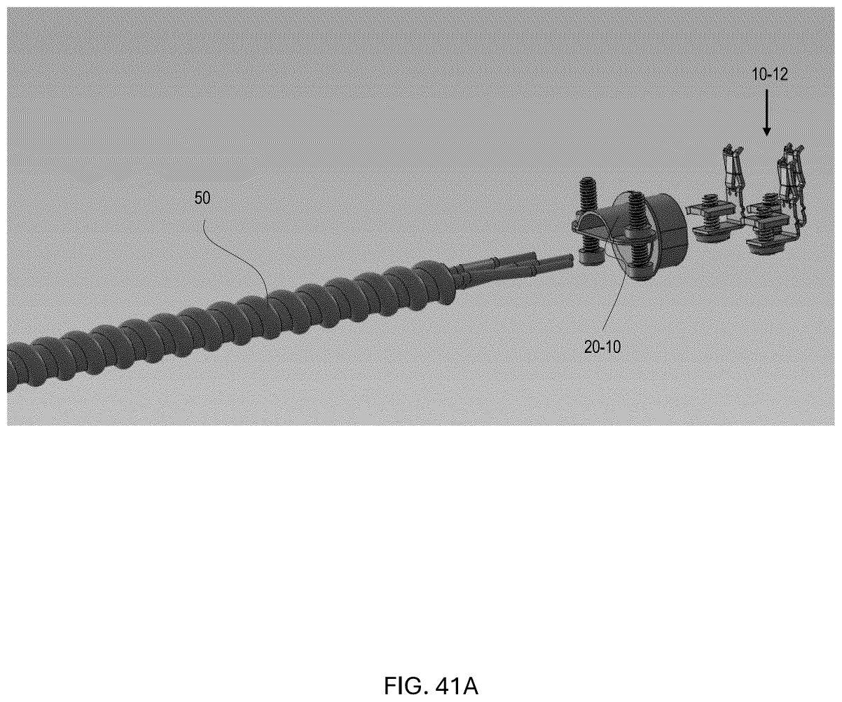

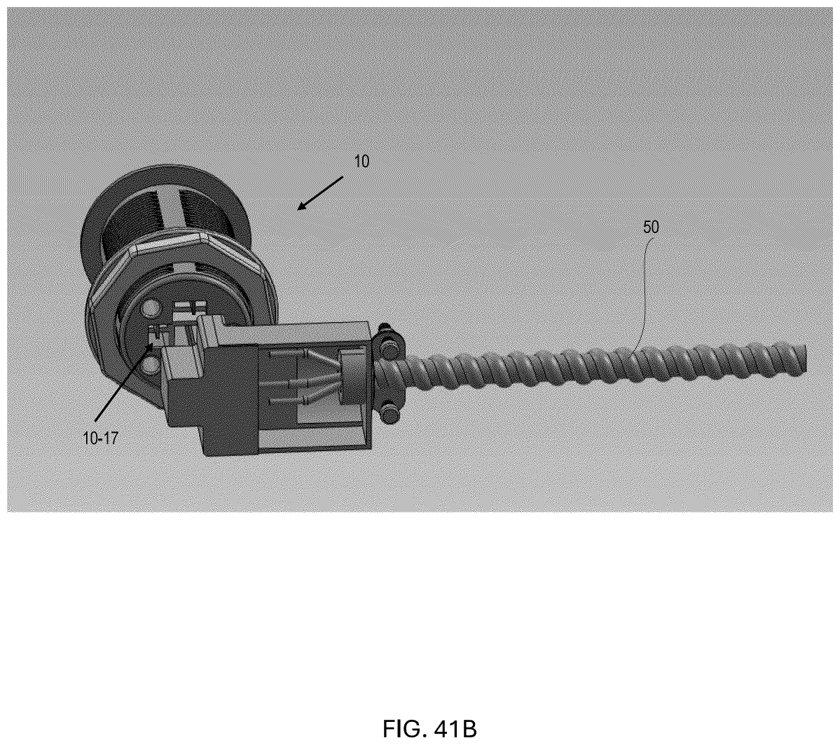

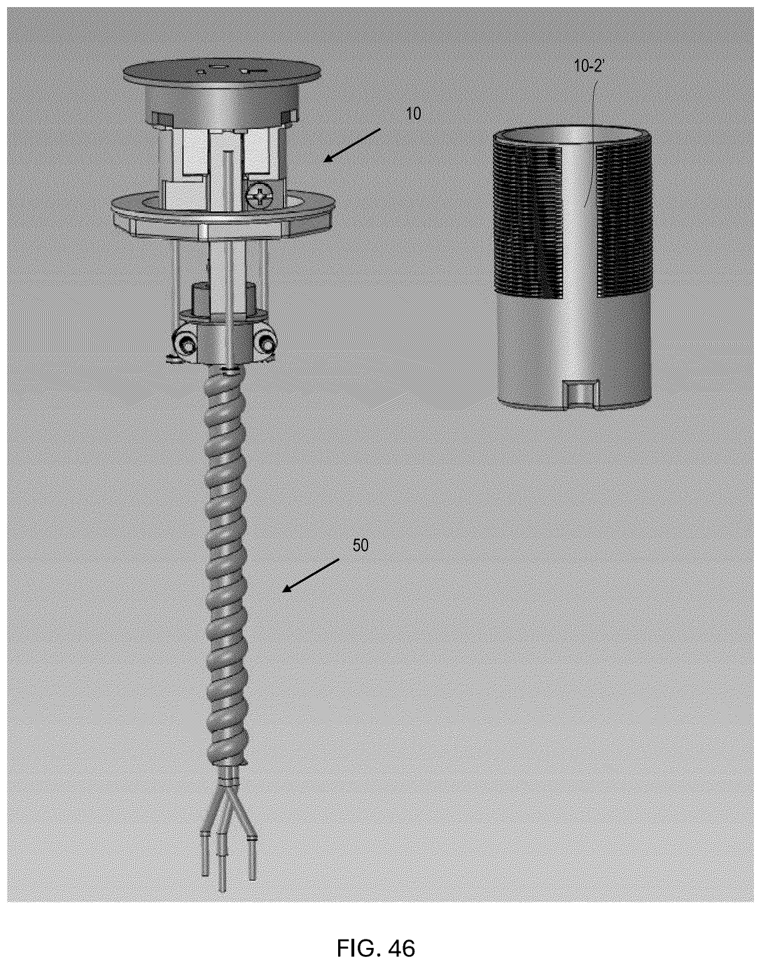

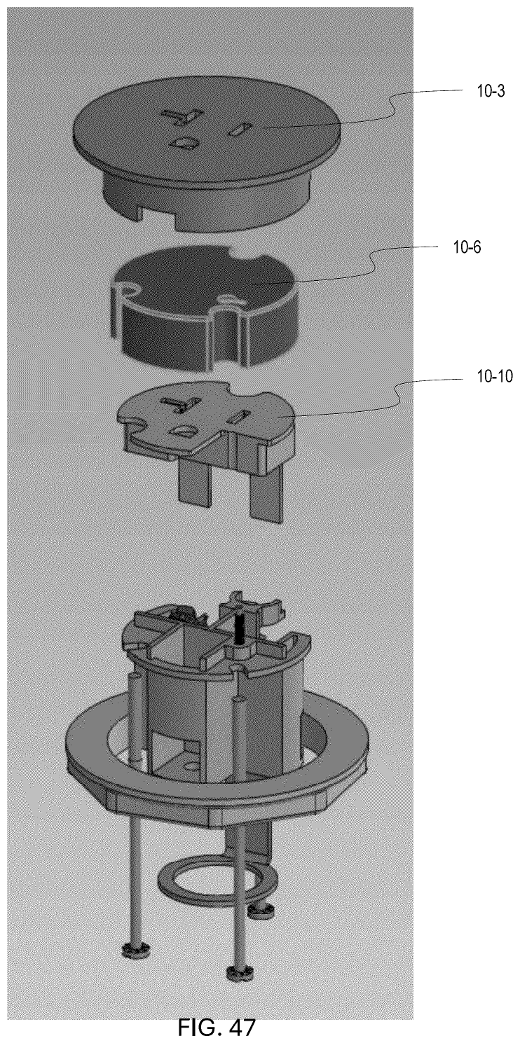

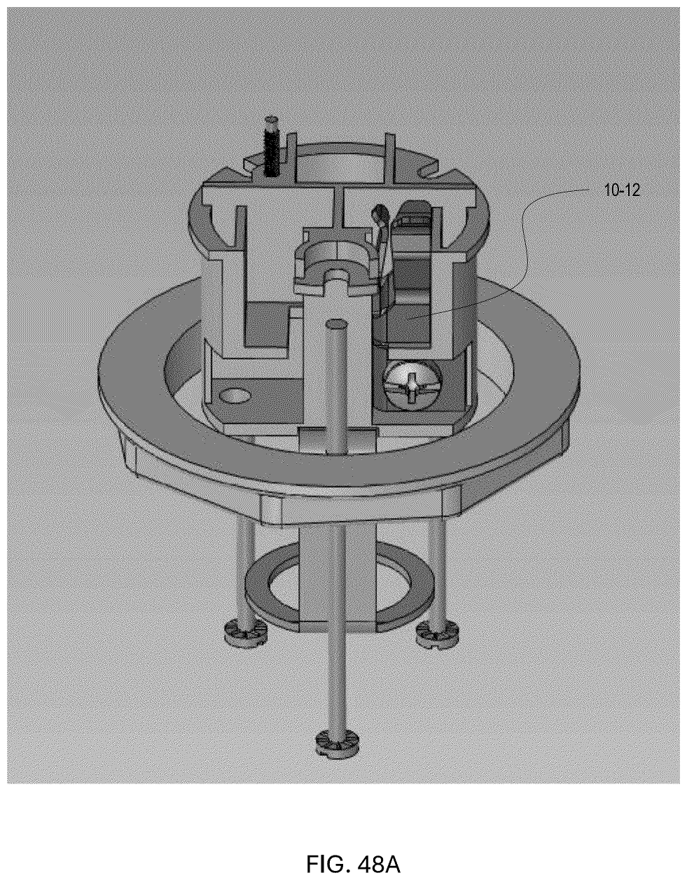

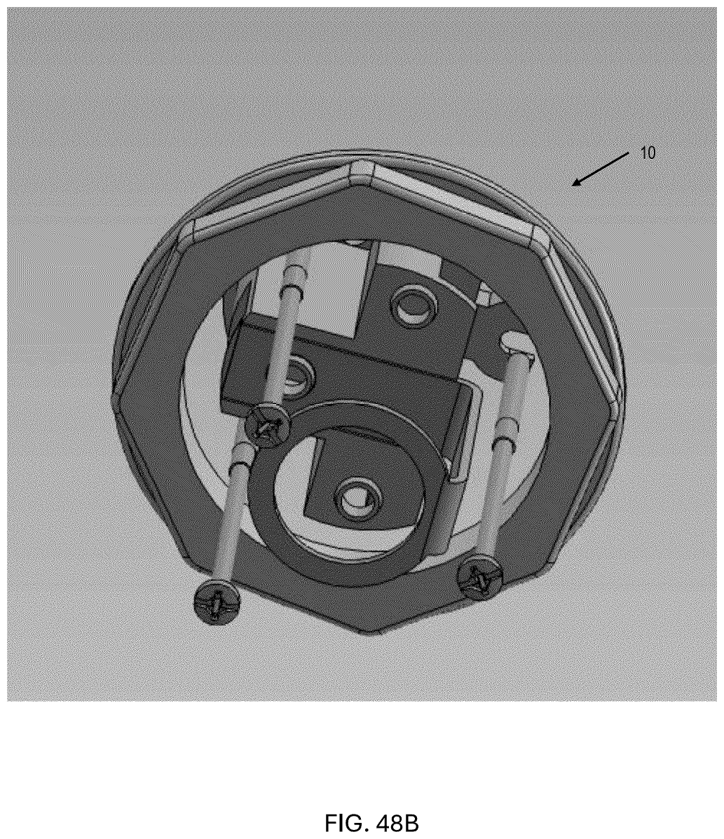

FIGS. 31-50 show various schematic representations and views of first-third alternative embodiments of a non-pop-up countertop outlet.

FIGS. 31-42 show an alternative assembly 500. This embodiment is very similar to the fourth embodiment 400 (described above) except there is no box 70-8. Instead, there is a plug connector 20, similar to a plug connector shown and described in U.S. Pat. No. 7,749,018, for example. The plug connector 20 is configured to mate with wires positioned through the wire covering 50, and the connectors inside the plug connector are configured to mate with the connectors of the body of the outlet receptacle 10. The outlet receptacle 10 can include a cover and openings 10-3. The outside surface of the body 10 can be threaded and can include a nut portion 10-16 which can include threading on its inside surface to mate and move up and down the body of the outlet receptacle 10 via the threads (and lock the assembly in place).

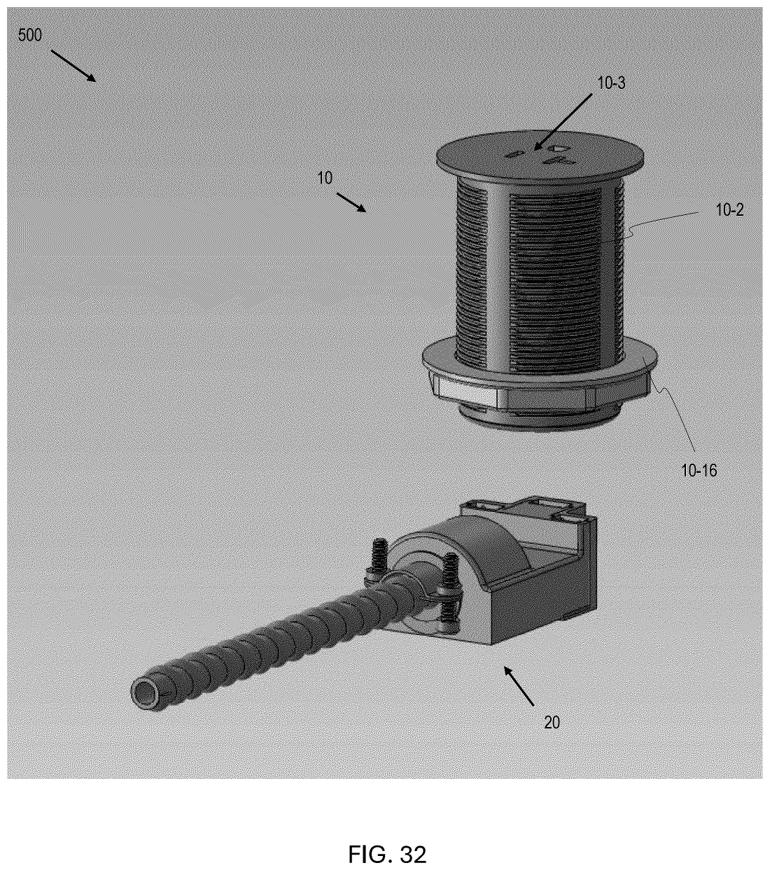

FIGS. 31-32 show a fully assembled alternative outlet receptacle assembly 500 structured and configured in part, as discussed above.

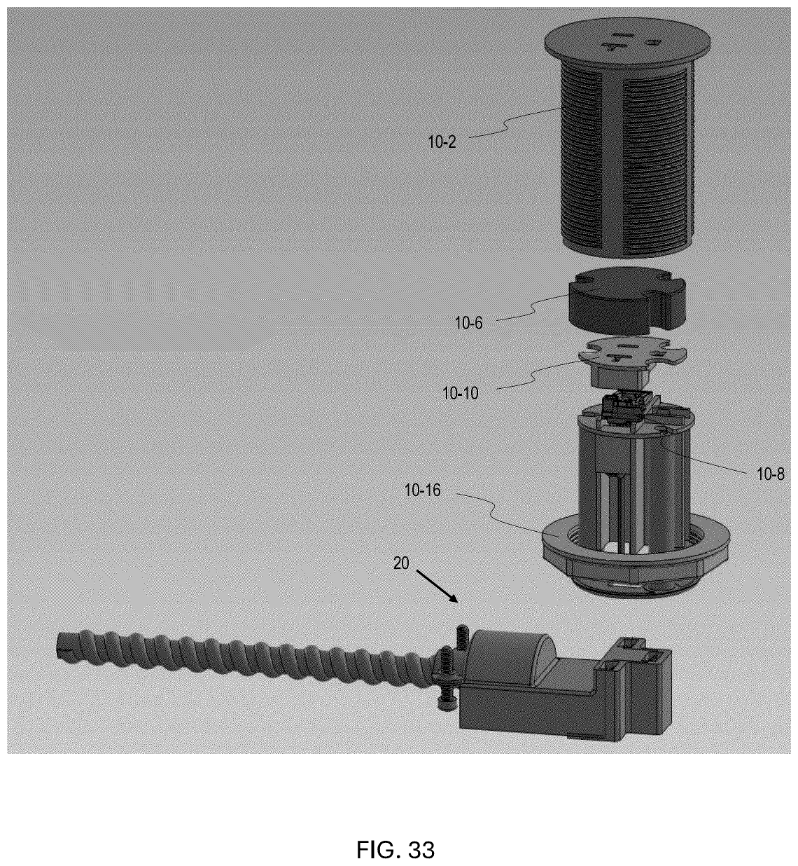

FIGS. 33-37 show exploded and other views of the assembly 500 with certain components removed. Gasket 10-6, outlet openings/receptacles 10-3, outlet receptacle contacts/terminals 10-12, tamper resistant mechanism 10-8, columns of the interior body 10-14 (through which screws can fit), and portions of the interior body 10-18 (on which the tamper resistant mechanism 10-8 can sit, and through which the outlet receptacle contacts/terminals can be positioned) are shown.

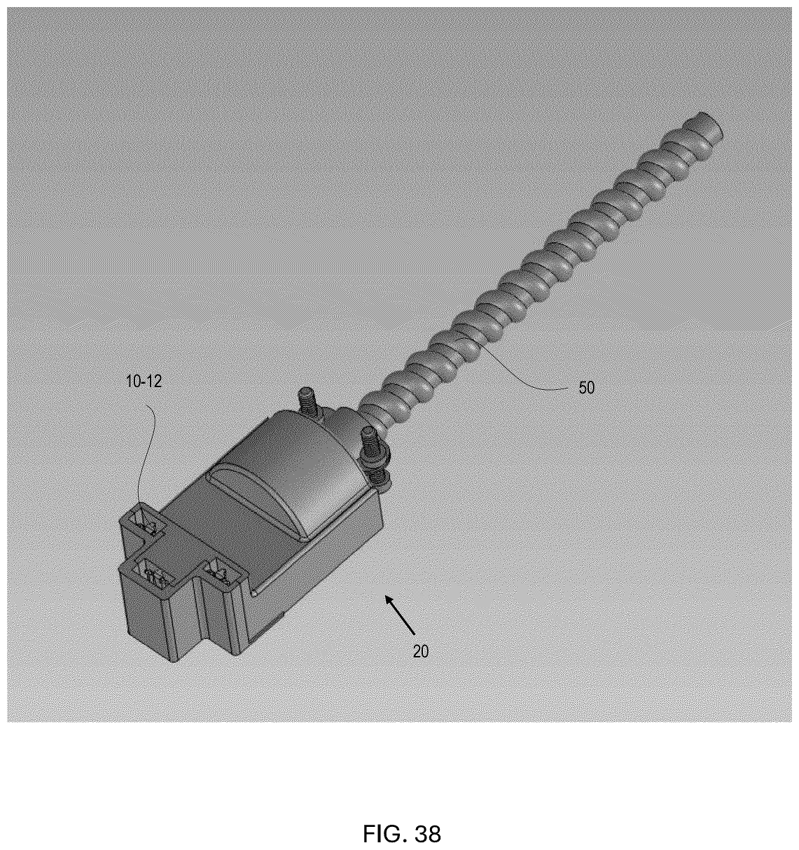

FIGS. 38-41B show various fully assembled and exploded views of the plug connector 20 of an embodiment. The plug connector body 20-2, contacts 10-12, connection mechanism between wire covering 50 and the plug connector 20, wires 50-1 extending from wire covering 50 and into the plug connector 20, and opening 10-17 through which the plug connector is configured to connect to the outlet receptacle (and then also connects with the contacts therein) are shown.

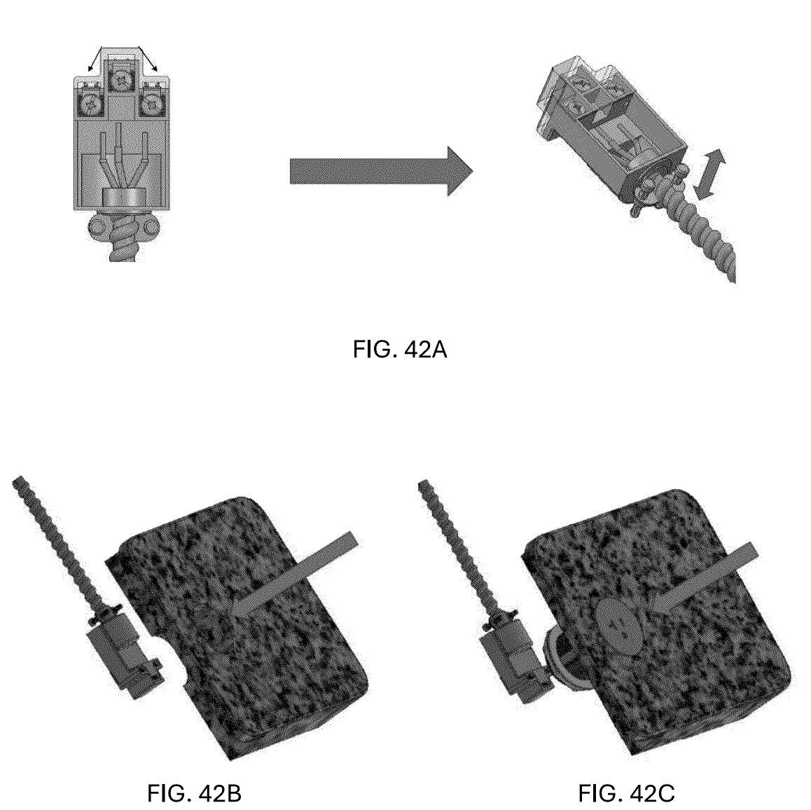

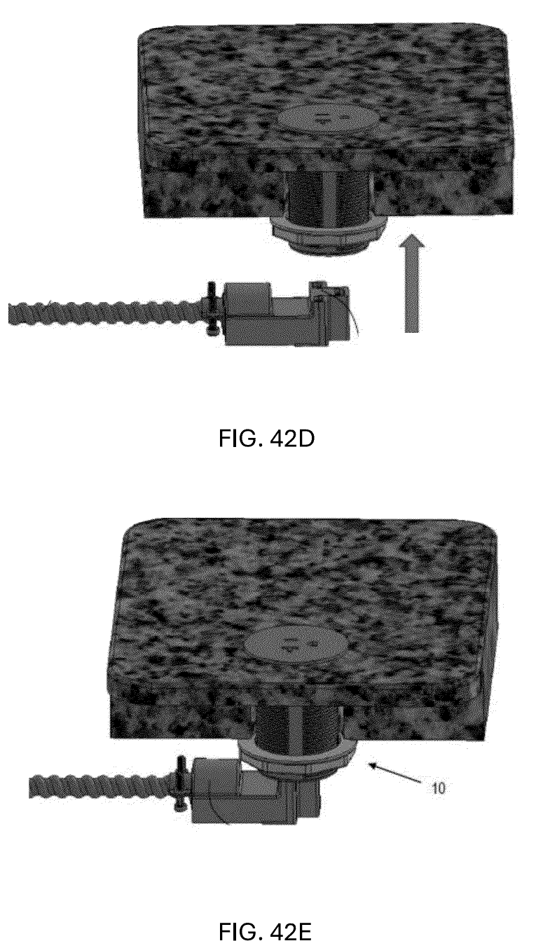

FIGS. 42A-42E show steps to install the assembly shown in FIGS. 38-41B according to an embodiment. The wire can be installed into the plug connector body above the counter or installation surface and the cord clamp can be tightened (FIG. 42A). Next, both parts of the device can be inserted into the installation surface hole and the nut can be screwed onto the assembly 500 (FIGS. 42B-42C). Lastly, the device assembly 500 can be snapped together (body and plug connector) underneath the installation surface (FIGS. 42D-42E).

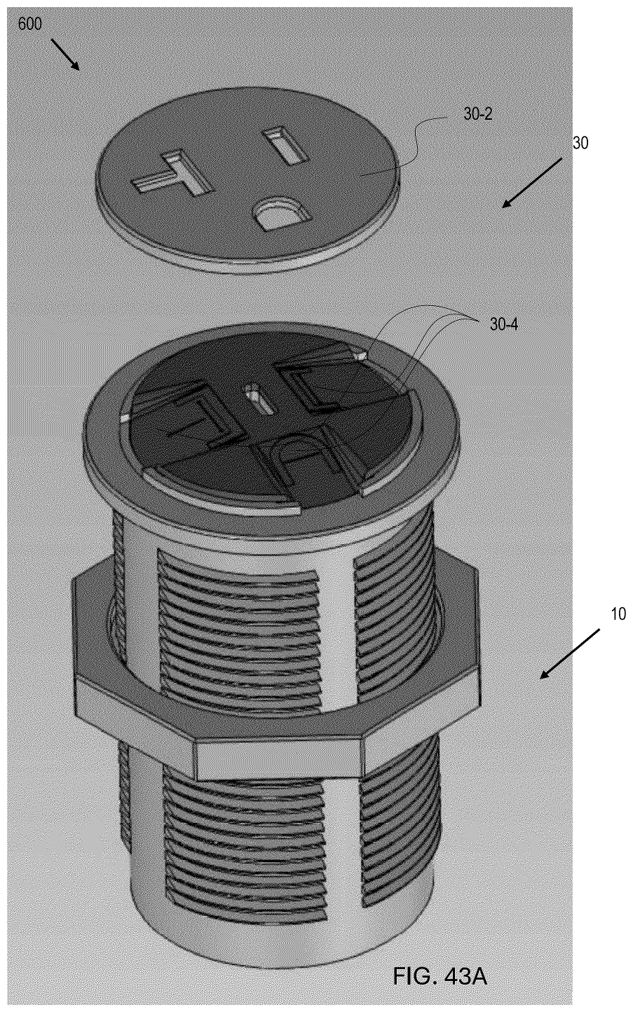

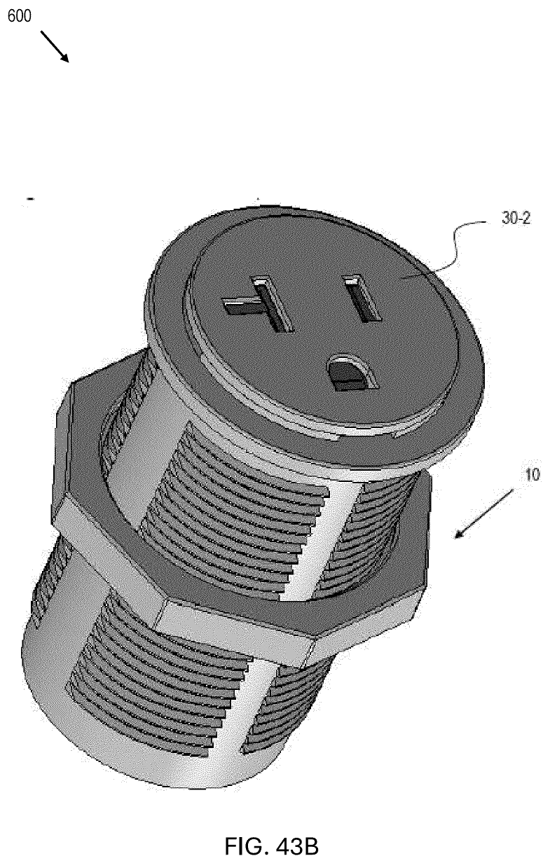

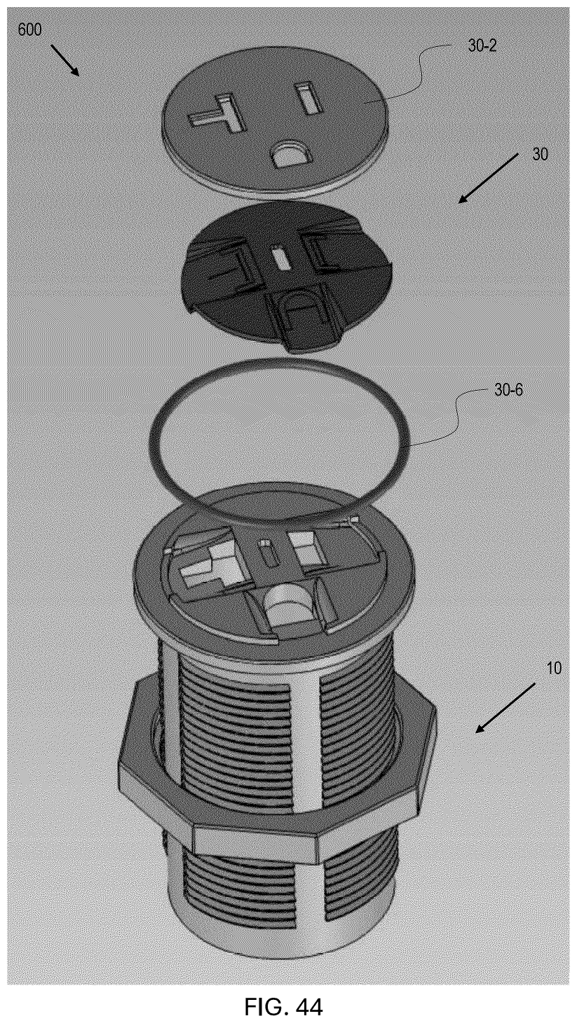

FIGS. 43A-44 show various views of an outlet receptacle assembly 600 with an alternative embodiment of the outlet receptacle 10 shown in FIGS. 31-42. The outlet receptacle 10 can include a cover and openings 30-2, with a gasket assembly 30 including a trim ring 30-6 and a gasket with angled surfaces 30-4 configured to lead spilled water away from the body of the outlet receptacle 10. The assembled view is shown in FIG. 43B.

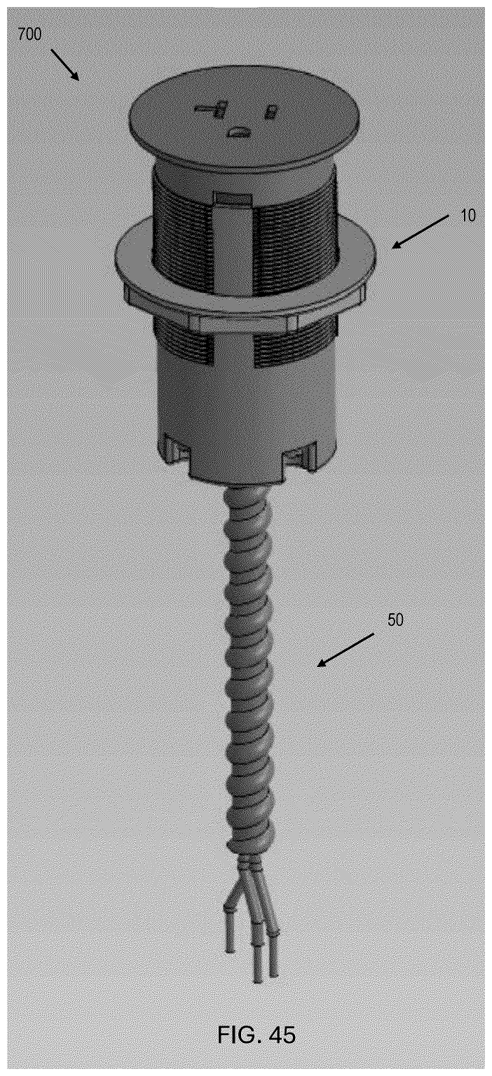

FIGS. 45-48B show various fully assembled and exploded views of an outlet receptacle assembly 700 of an alternative embodiment. This embodiment 700 is similar in many ways to the first alternative embodiment 200 discussed above. A main difference is that the body portion 10-2′ is configured and structured more like a plug/connector portion as opposed to the body shown in FIG. 31, for example (although, still similar in shape and it has a particular thread pattern on an outer surface). With body portion 10-2′ removed, the interior is similar to that which is shown with respect to the interior of body portion 10-2′ in FIGS. 33-37. Gasket 10-6, outlet openings/receptacles 10-3, outlet receptacle contacts/terminals 10-12, and portions of the interior body are shown.

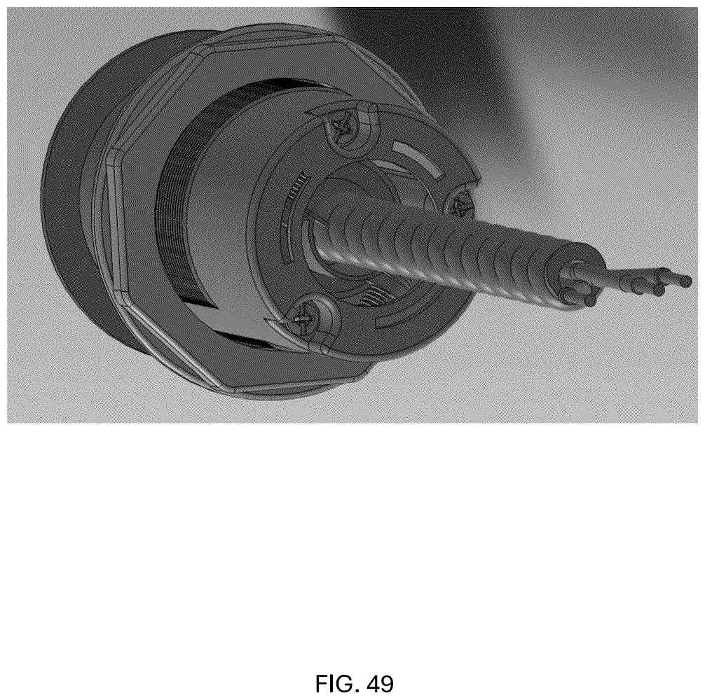

FIG. 49 shows the bottom portion of the body portion 10-2′.

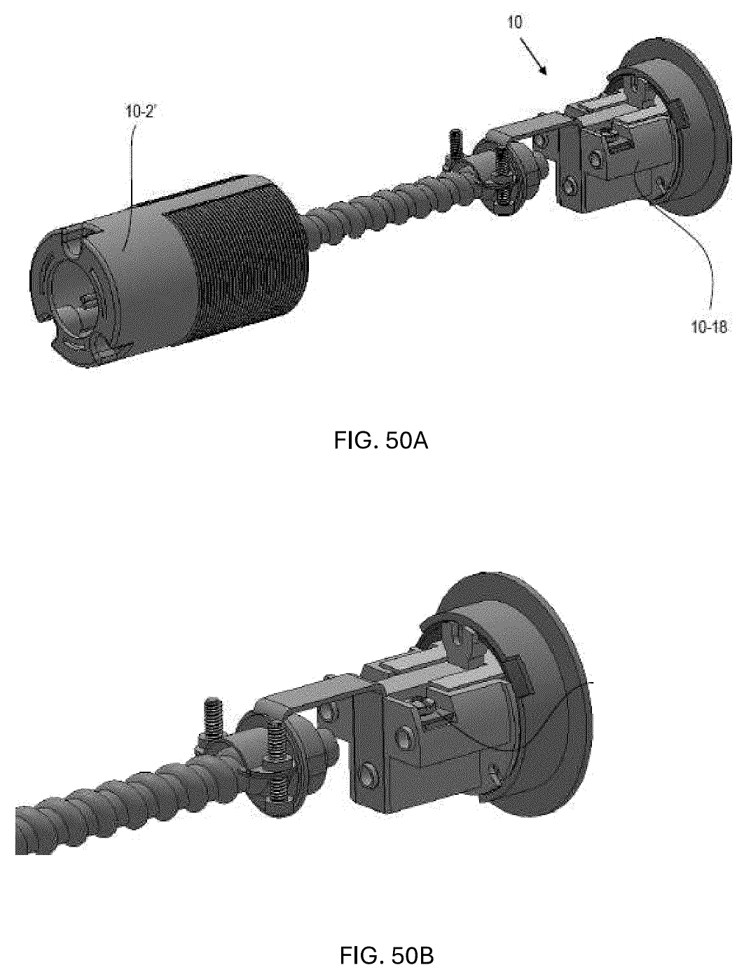

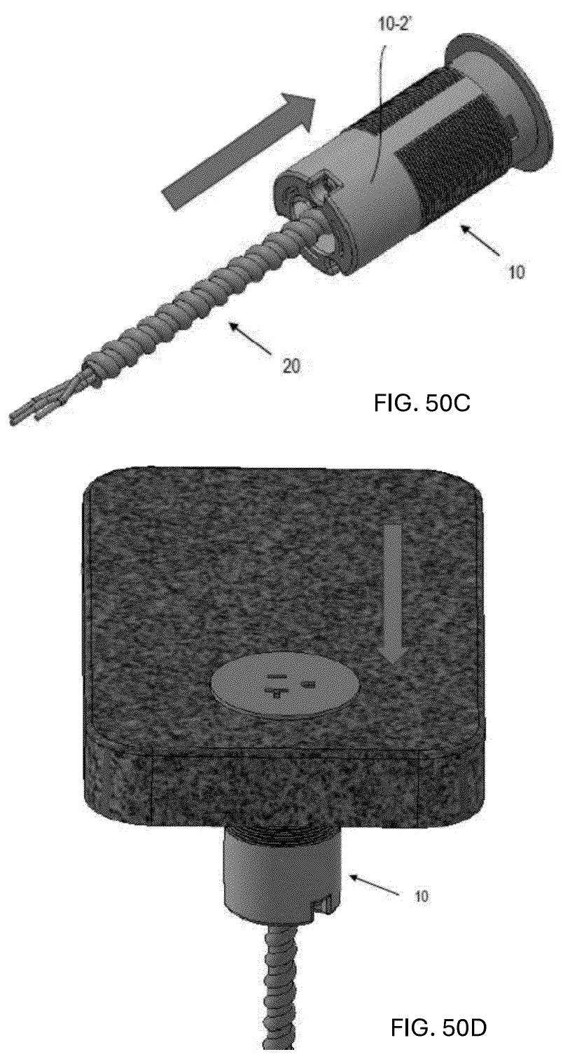

FIGS. 50A-50D show steps of installing the embodiment 700 shown in FIGS. 45-

49. First, a user can slide the back body onto the cable and terminate the wires (FIGS. 50A-50B). Then, a user can screw the back body onto the device in the direction indicated and insert it into a countertop or installation surface in the direction indicated, screwing the nut to tighten (FIGS. 50C-50D).

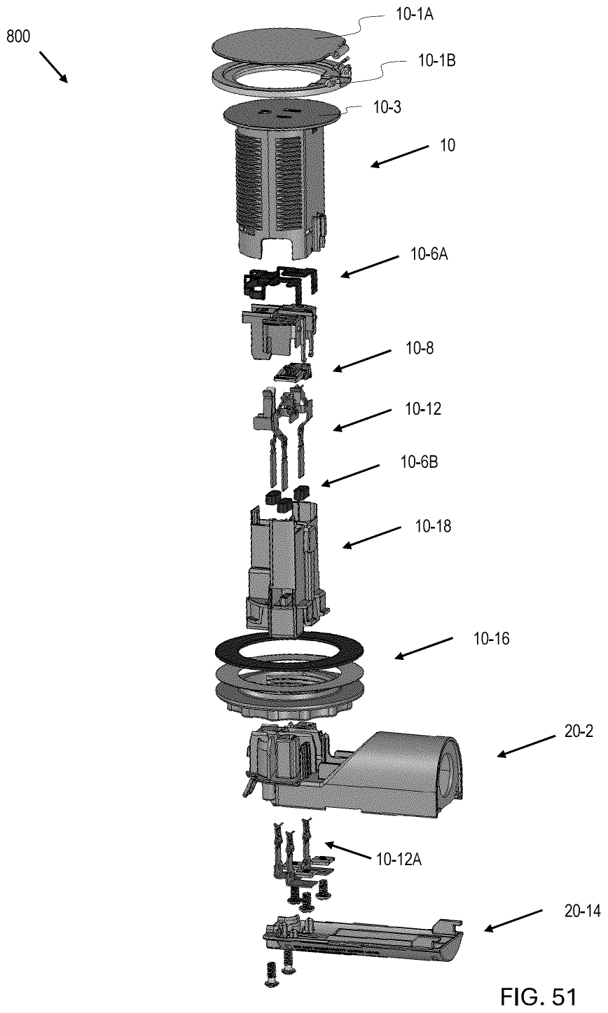

FIGS. 51-59 show various schematic representations and views of another alternative embodiment 800 of a non-pop-up countertop outlet (outlet covered openings/receptacles positioned flush or substantially flush with the countertop when installed). This embodiment is similar to those described above (see, e.g., FIGS. 31-42), but include some additional/different structures and mechanisms configured to keep water or other liquids away from the contacts. Where elements/components are the same structure and/or serve the same/similar function as those elements/components shown and described with respect to FIGS. 31-42, those elements are similarly named and numbered in FIGS. 51-58. Another advantage to these embodiments is the size and shape of the outlet receptacle assembly, allowing it to be installed into a countertop without taking up too much room below the top surface of the countertop (e.g., the plug connector connects to the outlet receptacle and extends at an angle (e.g., 90 degrees or about 90 degrees −+10 degrees) rather than extending straight down).

In brief, the embodiment 800 shown and described with respect to FIGS. 51-59 includes configurations with compartmentalization, which structurally addresses liquid that bypasses one of the primary or secondary gaskets. The compartmentalization can include elongated compartments (in one or both of the top body portion and the tail connector portion) configured to house and isolate terminals (hot, neutral, and ground) and liquid that flows into one or more of the respective compartments is isolated there-no conductive path is created via a liquid between/contacting two terminals (and is configured to flow out of device via specific drainage pathways and angled surfaces)). The structure and configuration of this embodiment 800 provides and allows for liquid drainage from the assembly. Angled surfaces (which can be measured from a horizontal plane when installed) at a predetermined angle (preferably between 0 degrees and 90 degrees, more preferably between 0 and 45 degrees, even more preferably between 0-10 degrees, and most preferably between 0 and 5 degrees or 5 degrees) and openings along the body provide a pathway from a top surface of a gasket or from a bottom portion of a channel and out of the assembly. Gaskets act to prevent water from entering assembly and can be positioned in top and bottom portions of the assembly. A primary gasket can include three channel covers connected by tails/arms (which can either be integrally formed from one piece or secured together by an adhesive)-e.g., one of three respective substantially planar pieces covers one of three divided and separate compartments/channels and being attached by tails/arms that extend around the outside of each respective channel. Each of the primary gasket cover portions can sit below the top surface of the channel walls that divide the channels from each other. Secondary gaskets can also be used, as discussed and described below. The plug connector tail can include a quick connect feature, is very low profile, and can be a field wirable separable connector and receptacle that does not need its own box-the connector itself can be the box.

Referring specifically to FIG. 51, an exploded view of the alternative assembly 800 is shown. This exploded view shows (from top to bottom) a hinged exterior cover or lid 10-1A and 10-1B selectively covering receptacle openings 10-3 including hot, neutral and ground-15 (here, only one plug can access this assembly; however, this disclosure contemplates an assembly that can accommodate multiple plugs connected to multiple respective loads where the assembly has an additional and same/similar layout to accommodate second and third etc. plugs, as should be understood by a person of ordinary skill in the art in conjunction with a review of this disclosure). Also shown are the body of the outlet receptacle 10, primary gasket 10-6A, shutter/tamper-resistant mechanism 10-8, contacts/terminals 10-12, secondary gaskets 10-6B, interior body 10-18 and surrounding nut assembly portion 10-16 (which can include a nut having interior threads that mate with the threads of the body of the outlet receptacle 10 and a rubber and friction washer), connector 20 formed of a plug connector base 20-14 and a plug connector body 20-2, and contacts 10-12A that mate with receptacle contacts 10-12 when attached.

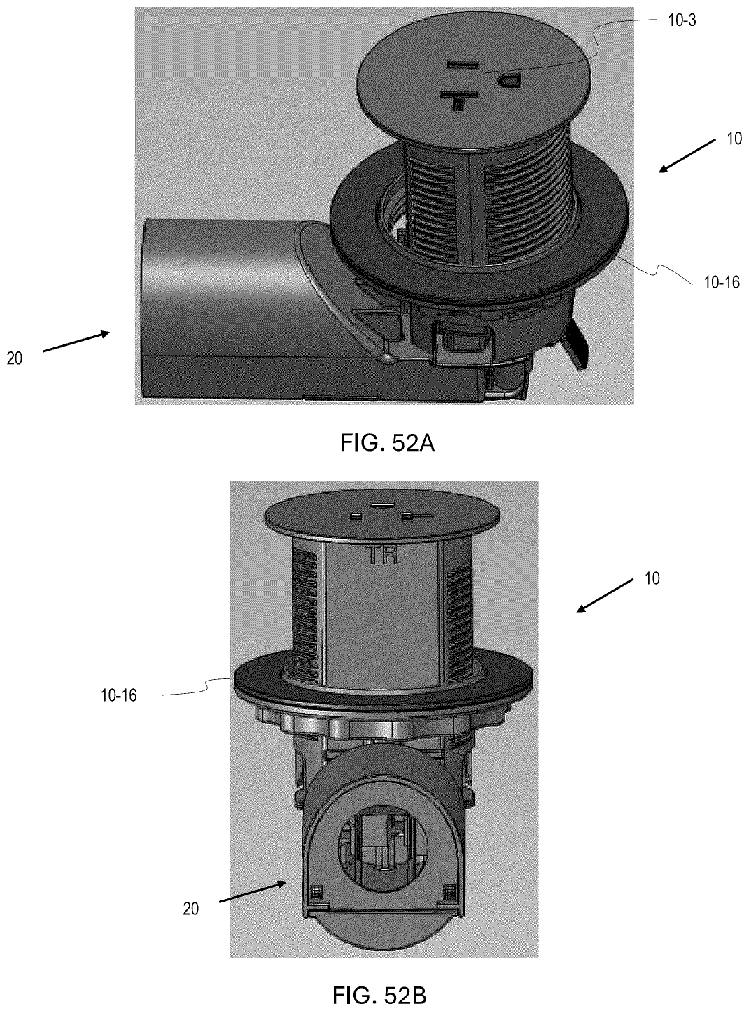

Referring to FIGS. 52A-52B, a perspective and rear assembled view is shown, respectively. Similar to above embodiments, a plug connector 20 is configured to mate with wires positioned through the wire cover (extending from the building/structure mains, not shown) and the mated connectors inside the plug connector 20 are configured to further mate with the connectors of the body of the outlet receptacle 10, as explained above. In this embodiment, the outlet receptacle 10 can include a cover and openings formed therethrough 10-3. In some embodiments, a hinged exterior cover 10-1A and 10-1B can be positioned over the cover and openings 10-3 (see, e.g., FIG. 51), and in further embodiments, the hinged exterior cover 10-1A and 10-1B have internal threads that mate with the threads of the body 10, similar to what is described below with respect to the nut portion 10-16. In some embodiments, the cover and openings 10-3 are integrally formed with the outlet receptacle body 10. The outside surface of the body 10 can be threaded and include a nut portion 10-16 which can have complementary threading on its inside surface configured to mate and move up and down the body of the outlet receptacle via the threads (and lock the assembly in place with the countertop positioned between the nut portion 10-16 and the cover 10-3). In some embodiments (see, e.g., FIG. 51), the nut portion 10-16 can further include one or more rings to assist with sealing and protecting the assembly from liquid.

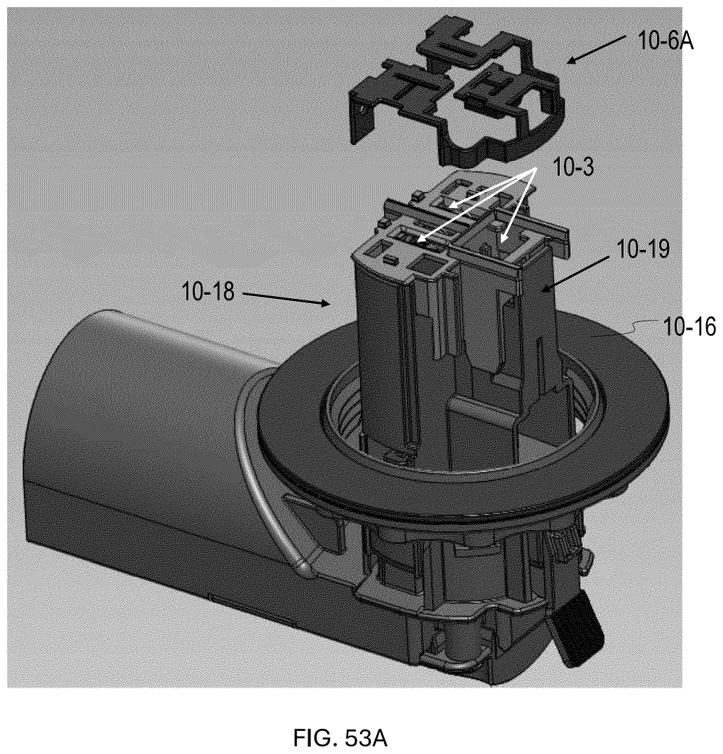

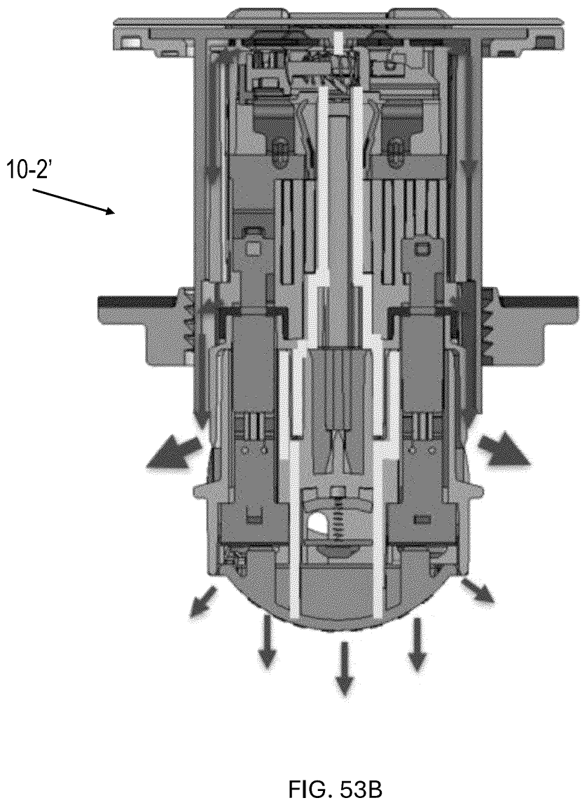

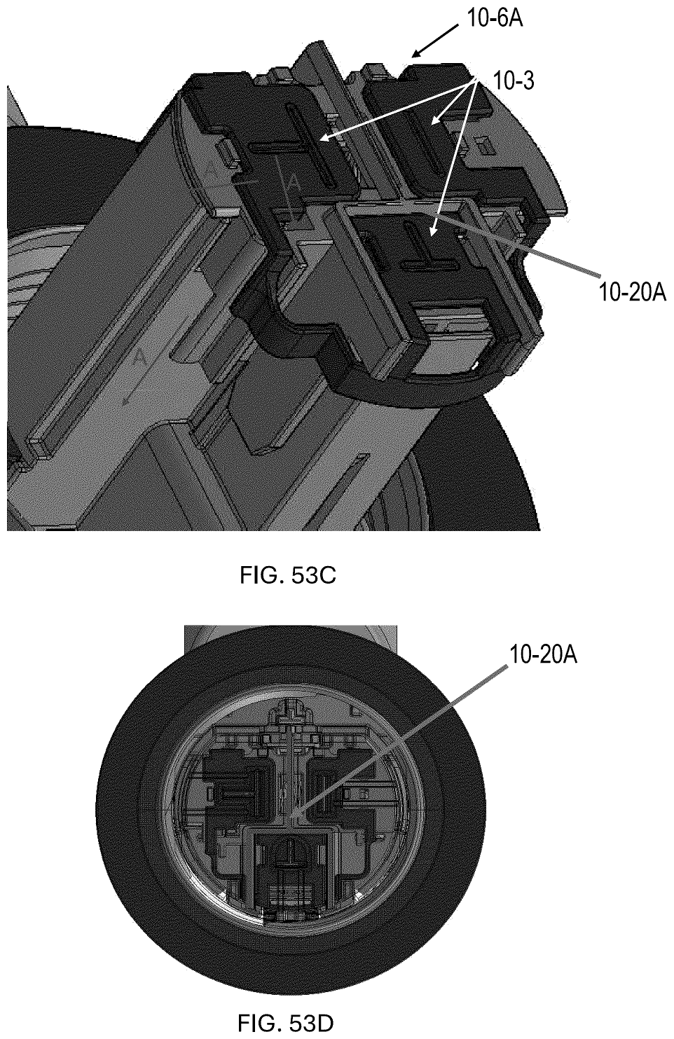

Referring to FIG. 53A, a perspective view of the assembly 800 is shown with the receptacle body 10 removed for illustrative purposes. As shown, outlet openings/receptacles 10-3 are positioned on the interior body 10-18 and can have a primary gasket 10-6A positioned on top of the outlet openings/receptacles 10-3. The primary gasket 10-6A can function to resist water entry into the interior body 10-18 (if water gets past cover 10-1A, or if cover is open and water gets through the receptacle openings 10-3 of the cover) and allow for drainage outside of the slot openings and around the channels 10-20 (discussed further below) without contacting the contacts/terminals 10-12. The flow of liquid can follow a path as shown by arrows A in FIG. 53C, for example, which is outside the channels 10-20 housing the receptacle contacts/terminals (e.g., ground, neutral, and hot). However, water entry into one or more channels 10-20 can occur because of wear and aging of the components of the device following an accidental spill, etc. The channels 10-20 formed within interior body 10-18 are structured and configured to provide a distinct flow path for liquid and a separate housing for each of the contacts/terminals in the event that liquid gets into the assembly.

FIG. 53B shows a cross-sectioned view of the assembly 800 and the various flow paths designed to divert water out and away from the assembly and especially the contacts (i.e., axial (generally along a path parallel to the central longitudinal axis of the body) and radial or angular drainage (drainage at an angle to the central longitudinal axis) while keeping the liquid flow paths separate from each other and from each separately housed terminals (FIG. 53D shows a top section view with interior body walls forming and separating each channel 10-20). A close-up view of the primary gasket 10-6A positioned on the outlet openings/receptacles 10-3 is shown in FIG. 53C. In this embodiment, the primary gasket 10-6A can be formed of a rubber material but can be also formed of any non-conductive material suitable for this use (as should be understood by a person of ordinary skill in the art in conjunction with this disclosure).

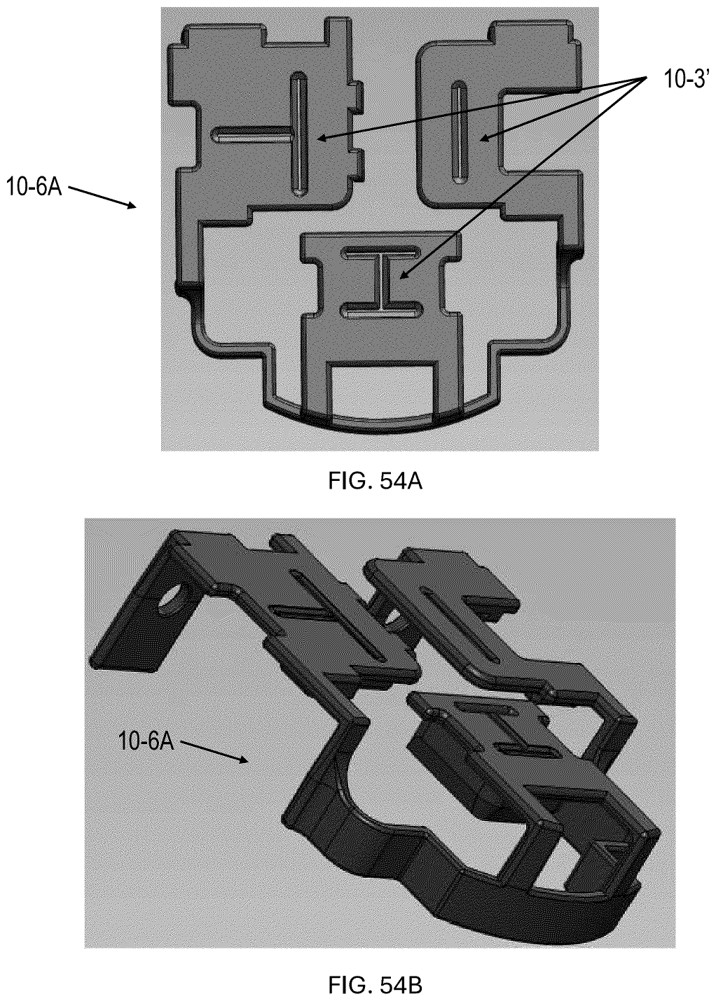

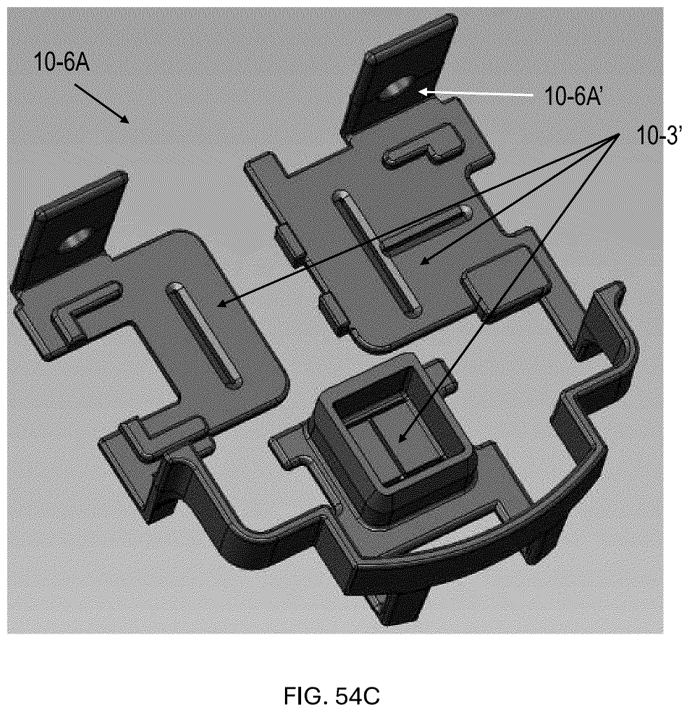

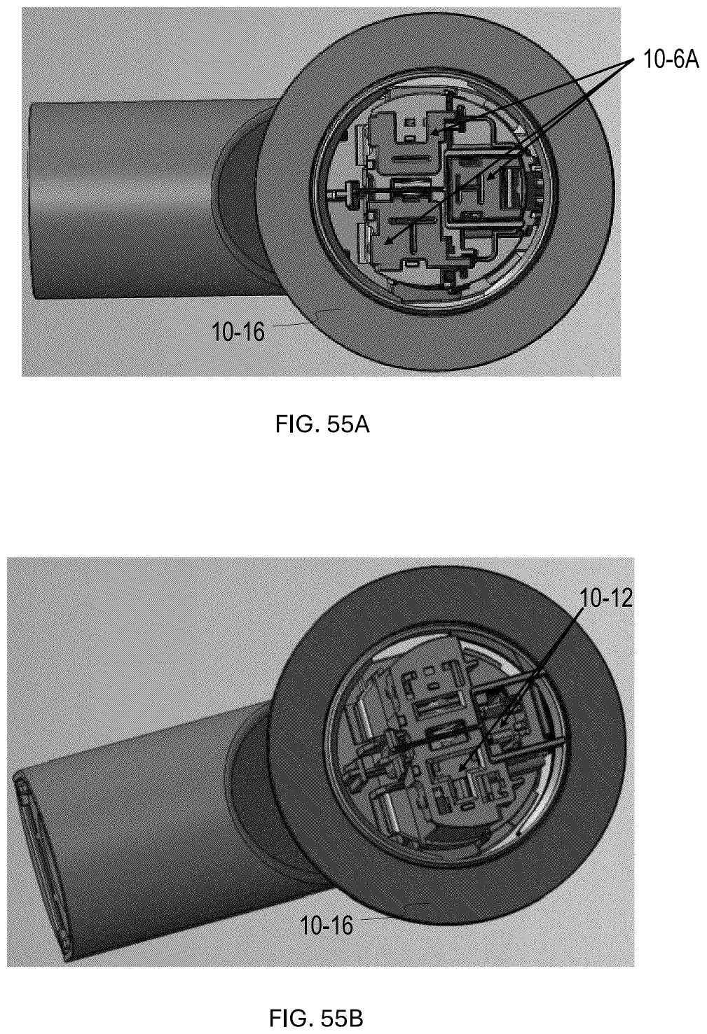

Referring to FIGS. 54A-54C, close-up front, perspective, and bottom views of the primary gasket 10-6A removed from the assembly for illustrative purposes are shown, respectively. In this embodiment, the primary gasket 10-6A is formed as a single piece yet still allows for the isolation of the three channels 10-20 (i.e., the isolation of the three channels 10-20 begins at the very top of the assembly 800 and follows all the way through, as described above, covering each entry point). The primary gasket 10-6A can fit within the contours of and have similar geometry to the top surface of the interior body 10-18 and can be designed to sit below the top surface of each wall separating and forming the channels of the interior body 10-18 (see, e.g., FIG. 53C, and 53D as highlighted—10-20A) and continue through the plug connector 20. This singular structure and configuration can allow for the gasket 10-6A to function as a water preventative measure while avoiding interference with the assembly 800. As shown, the primary gasket 10-6A has openings 10-3′ that align with the top outlet openings/receptacles 10-3 and remain closed until a force is applied (e.g., the pins of a plug). There can also be openings 10-6A′ in the back of the gasket 10-6A that are configured to correspond to and accept an attachment mechanism (not shown) that can be integrally formed with the interior body 10-18 to secure the gasket 10-6A thereto. A top perspective view of the assembly with the primary gasket 10-6A assembled and removed is shown in FIGS. 55A and 55B, respectively.

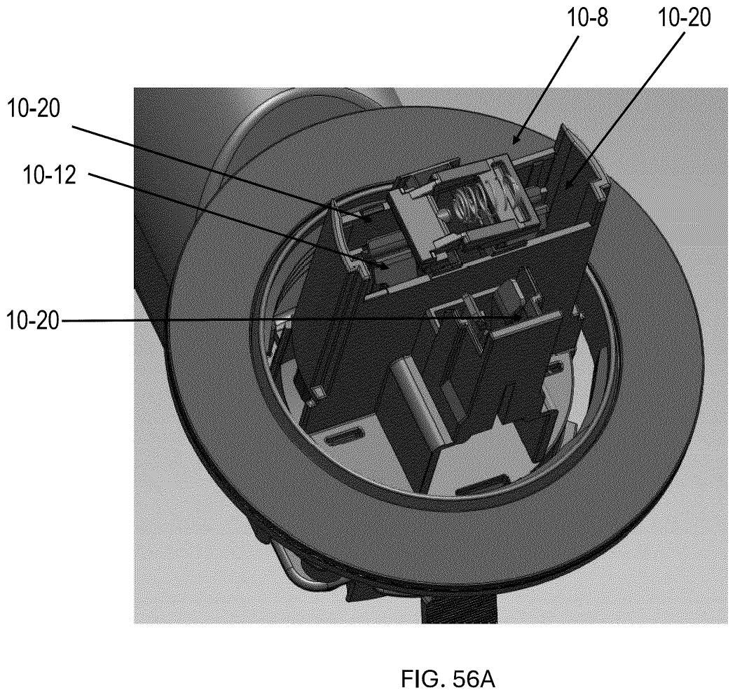

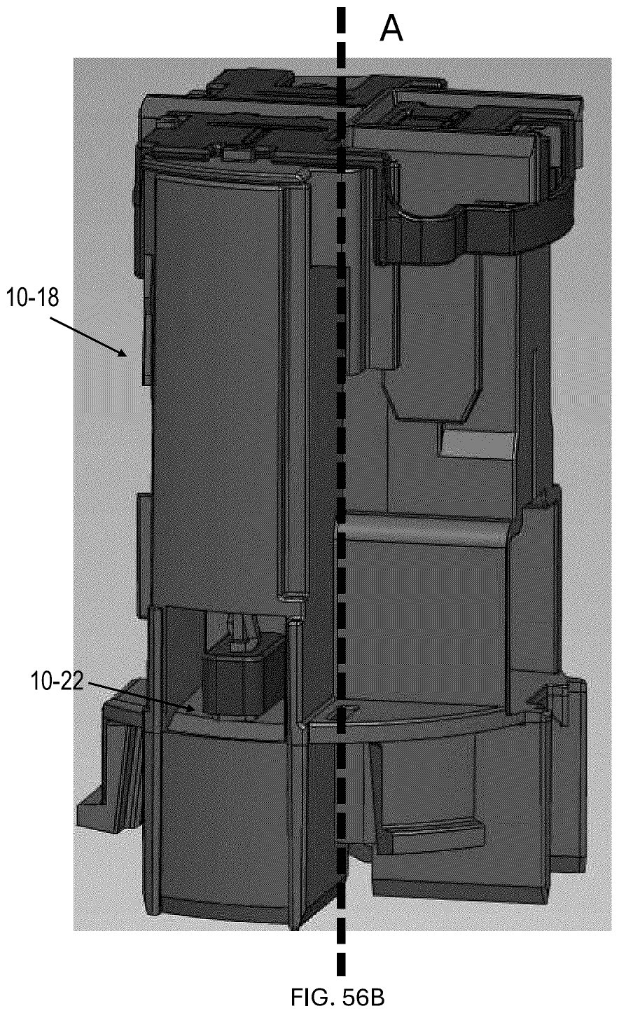

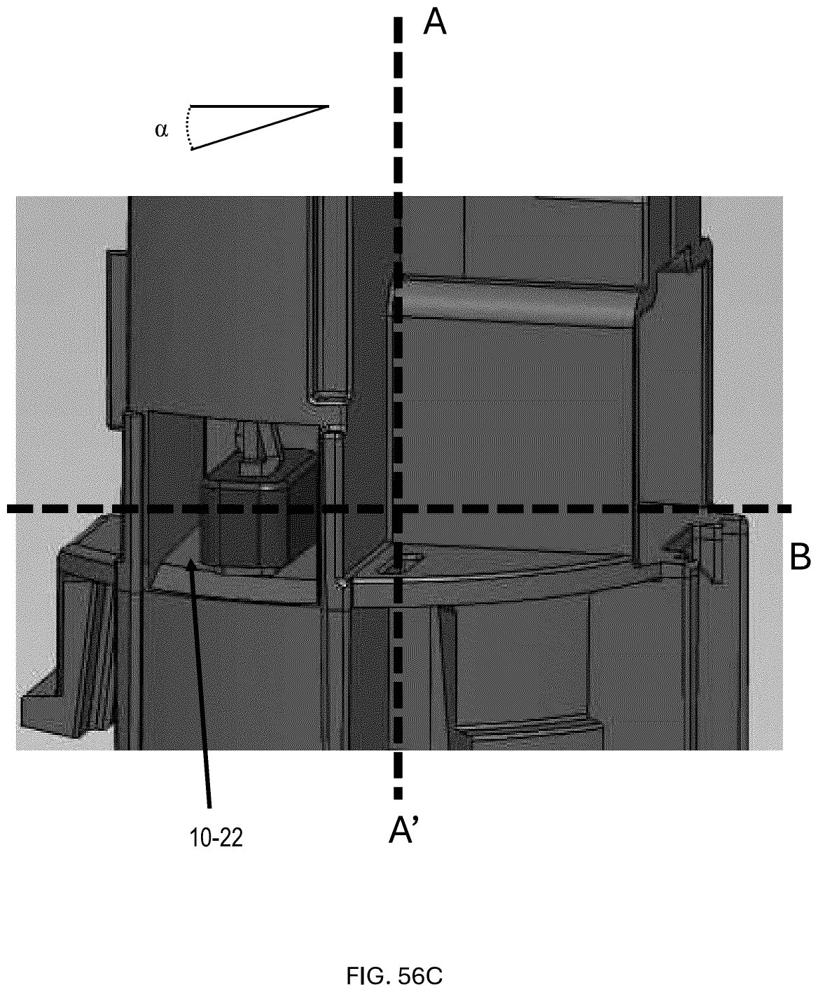

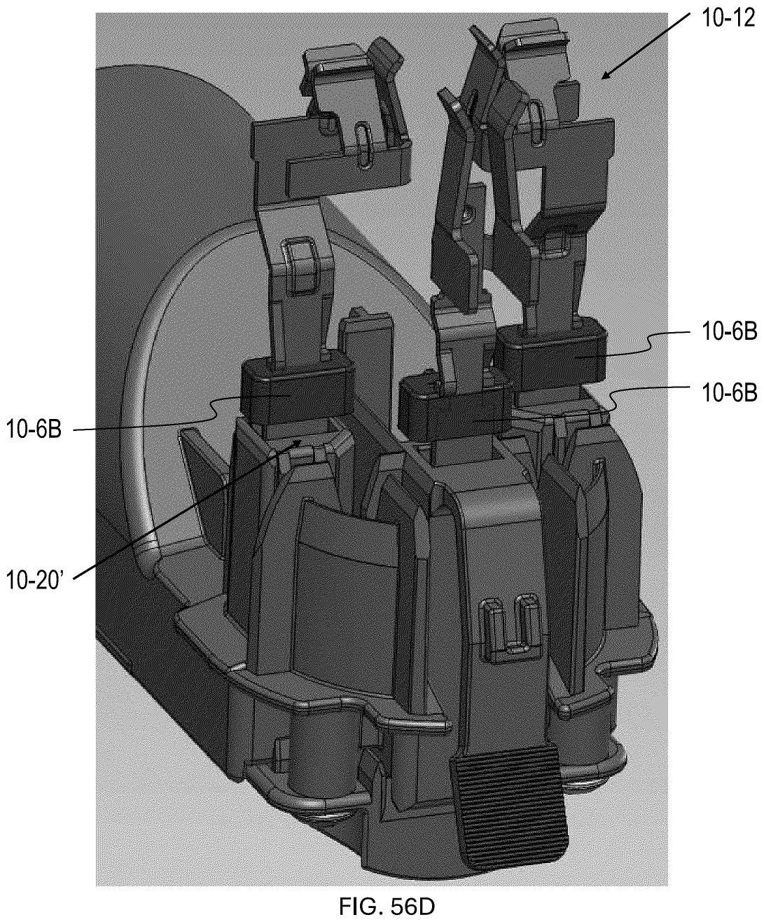

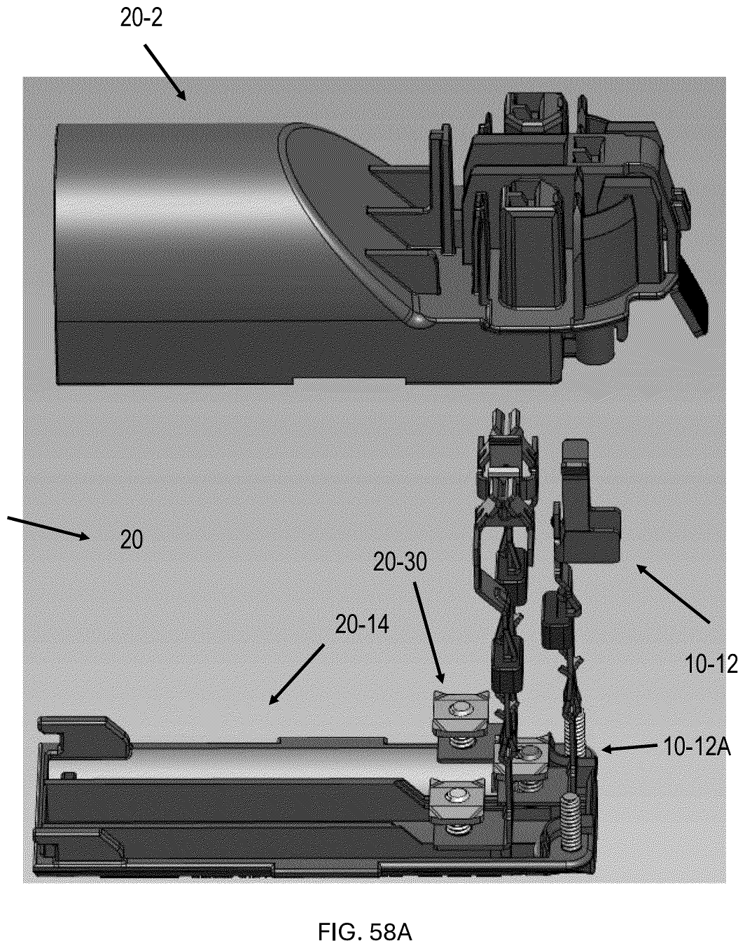

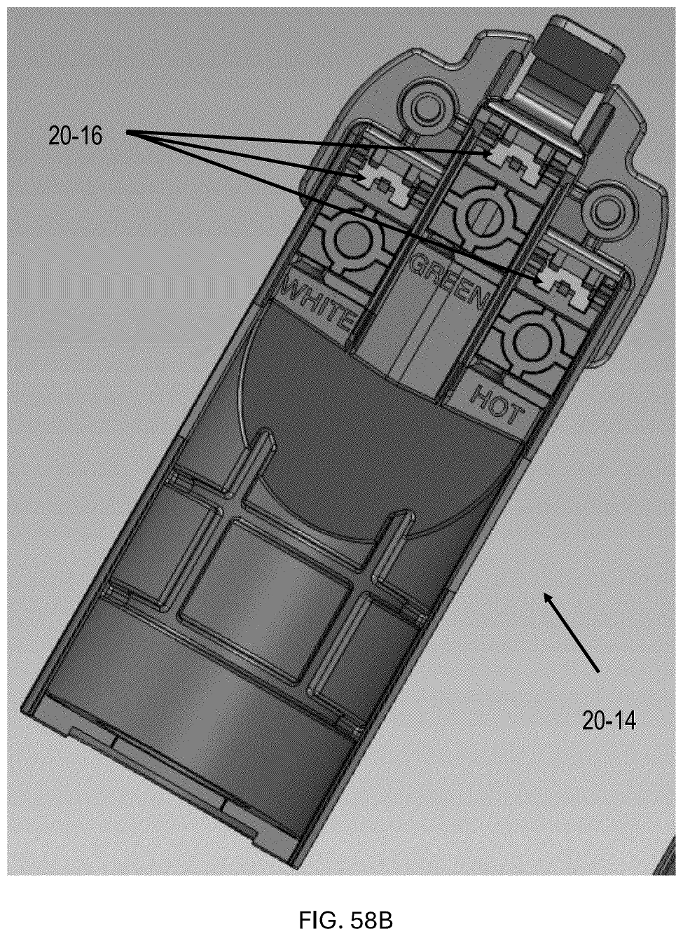

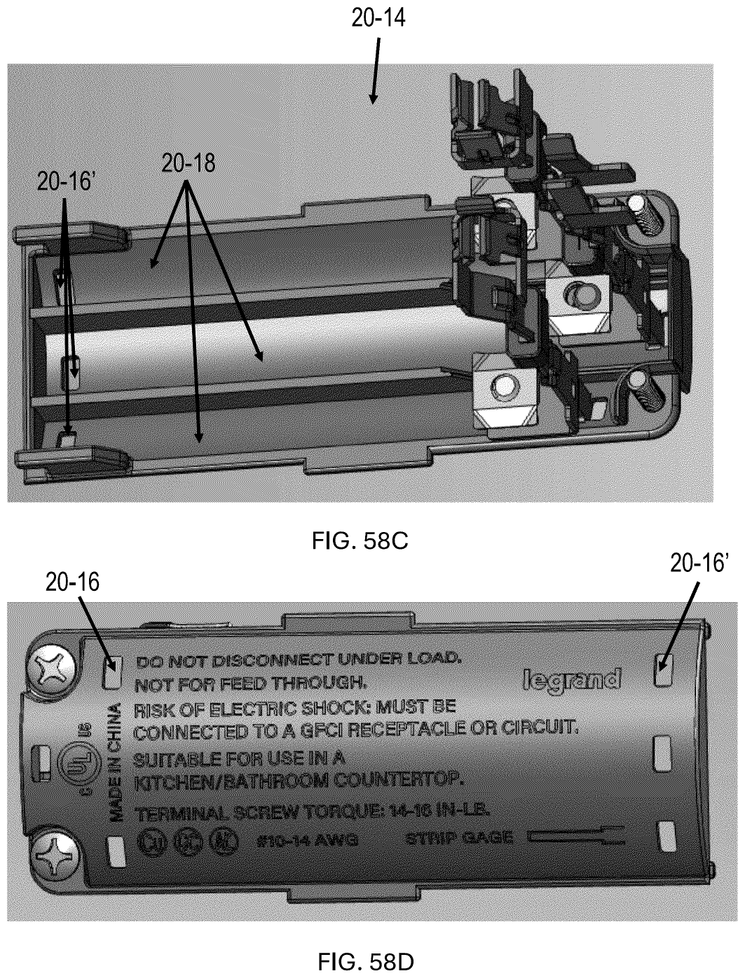

Referring to FIG. 56A, a close-up view of the interior body 10-18 is shown. The tamper-resistant mechanism 10-8 is shown, as described above, as well as the contacts/terminals 10-12 (hot, neutral and ground, each of which is positioned within a separate channel 10-20 providing for a separate pathway/channel for any potential liquid that may enter the device-keeping the water separate from the other contacts/terminals and providing a pathway for the liquid to leave the assembly-see also FIG. 53D). As shown, the pathways of the contacts/terminals 10-12 (hot, neutral, ground) are isolated from one another throughout this embodiment. As explained above, the primary gasket 10-6A serves to prevent water/liquid from getting into the channels 10-20 housing the contacts/terminals, but if water/liquid does get in, the assembly is designed such that there is no way for the liquid to bridge the channels (i.e., if water gets into one channel, the other two channels are separated and can be unaffected). A portion of each contact/terminal 10-12 sits adjacent to the top of and extends through its own channel which is walled off so that any liquid that enters gets diverted down and can exit at multiple drainage areas throughout the body 10-18 and are also part of the plug connector 20 (see FIGS. 53B and 58B-D).

As shown in FIGS. 56B-56C, the interior body 10-18 can have at the bottom of each channel a ledge 10-22 that is angled or sloped downward and away with respect to the interior body 10-18, providing radial drainage with respect to the assembly 800. From the base to the edge of the ledge 10-22, the base extends from a plane perpendicular to central longitudinal axis A which is parallel to a perpendicular axis B and extends at a predetermined angle α from that plane toward the A′ direction as shown in FIG. 56C. It is contemplated that angle α falls within a range that is greater than 0 degrees and less than or equal to 90 degrees with respect to perpendicular axis B of the interior body 10-18 to give it a downward sloping effect and divert liquid away from the assembly 800. In a preferred embodiment, a is between greater than 0 and 45 degrees. In a more preferred embodiment, α is between 1 and 10 degrees, and in an ideal embodiment, a is between 1 and 5 degrees. It should be understood that A, A′, and B are used for reference purposes, with A representing a central longitudinal axis of the interior body from top to bottom and B representing a perpendicular line upon which a parallel plane can be described, and from that plane an example surface can be angled.

While ledges 10-22 are described as being sloped, it should be understood that all assembly surfaces (interior and exterior) in the embodiments described herein can be sloped but are not required to be. In a preferred embodiment, any surface of the assembly that water would flow over is angled (as described above), particularly surfaces underneath each of the three channels described above. In some embodiments, the ledges and other potentially liquid-contacting surfaces are not sloped and are substantially parallel to axis B described above.

Referring to FIG. 56D, secondary gaskets 10-6B are shown surrounding each contact/terminal 10-12 at the top surfaces of respective channels 10-20′ (which function similarly to channels 10-20 with respect to separation) of the plug connector 20. The secondary gaskets 10-6B can function to prevent water from entering the plug connector 20, similar to the primary gasket 10-6A described above (although, the illustrated secondary gaskets are separate components compared to the singular primary gasket). In alternative embodiments, the gasket types can be switched in one or both embodiments (singular gasket used in place of the multiple gaskets and vice versa).

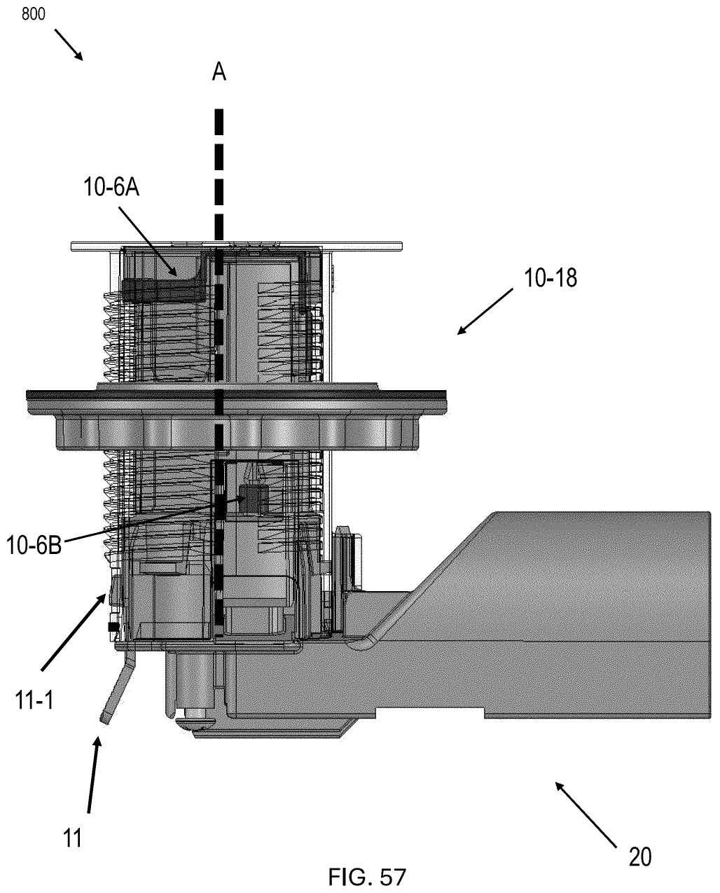

FIG. 57 shows a transparent side view of the assembly 800 with the locations of the primary and secondary gaskets 10-6A and 10-6B. This FIG. also shows an actuator 11, which when pushed toward the connector unlocks the connection between the connector 20 and the body 10. Actuator 11 is biased toward the position as shown, which locks the connector and the body 10 together. The actuator 11 is positioned on the connector (but can be on the body), and includes a flange 11-1 which is shown positioned through an opening in the body to selectively and releasably lock the body to the connector (i.e., quick connection). As shown, the plug connector 20 is positioned at a substantially right angle with respect to the longitudinal axis A of the internal body 10-18. This advantageously allows for the assembly 800 to take up less room (e.g., allowing for a cabinet drawer or tall appliances to be placed underneath a countertop where the assembly is installed-see also embodiments 100 and 300-500) and not require its own box (the connector serves as an electrical wiring device box, as should be understood by a person of ordinary skill in conjunction with a review of this disclosure). Furthermore, the plug connector 20 can be capable of swiveling (or rotating 360 degrees, including left/right and up and down (e.g., via the mechanism shown above)) with respect to the main body to avoid any existing structures.

Referring to FIGS. 58A-58D, various views of the plug connector 20 are shown. FIG. 58A shows the plug connector body 20-2 removed from the plug connector base 20-14 for illustrative purposes. As shown, the receptacle contacts 10-12 contact respective connector contacts 10-12A, which extend through the plug connector 20 to the plug connector base 20-14. FIG. 58B shows a top view of the interior of the plug connector base 20-14 with the contacts removed for illustrative purposes. The three openings 20-16 formed through the base 20-14 can correspond with the positioning of the three contacts 10-12A to provide an additional point of liquid drainage. As can be seen in FIGS. 58C and 58D, the compartmentalization of the assembly continues into the plug connector base 20-14 with three horizontal channels 20-18 extending along the length base 20-14. Each horizontal base channel 20-18 is configured to correspond to and segregate the contacts 10-12 (continuing the compartmentalization of the vertical channels described above). In addition to the openings 20-16 positioned under each contact described above, additional openings 20-16′ can be provided at the opposite end (i.e., end opposite the contacts) of the plug connector base 20-12 such that each horizontal channel 20-18 ends with an opening 20-16′ positioned underneath to divert the water out of the assembly 800 (and thereby providing complete compartmentalization and segregation of the contacts starting from the top of the assembly and continuing throughout the bottom-and having multiple segregated flow pathways and outlets for liquid throughout the device). In some embodiments, the horizontal base channels are positioned at an angle to allow for any liquid to flow down the base (i.e., away from the end with the contacts) and out of the device.

In one preferred embodiment, the total length of the assemblies described above can be 4.5 inches and the height can be 3.3 inches. The diameter of the outlet cover and openings can be 2.3 inches, while the body portion and nut portion can be 1.85 and 2.9 inches in diameter, respectively. The total height of the body portion can be 2.8 inches; the height at the tallest portion of the plug assembly can be 1.75 inches, and the total length of the plug assembly can be 4.3 inches (or 2.8 inches without portion that connects to the main body portion). In an ideal embodiment, to accommodate the assembly during installation, the hole in the surface need only be 2 inches wide if no lid is included, or 4 inches wide if a lid is included.

To use the embodiment 800 described in FIGS. 51-58 for example, a user can first drill a hole in a countertop or other chosen installation location (this assembly advantageously does not require a large hole to be drilled due to its size and angle of the connector, as explained above), and line up the wire covering 50 with the plug connector 20 to determine the length and strip length. Next, a user can pull the wire 50 into the plug connector 20 and tighten it (using attachment screws 20-12, for example). Once the wires 50-1 inside the wire covering 50 are terminated at 20-30 (see FIG. 58A), the cover (or plug connector base 20-16) can be installed (via screws, for example). Next, a user can position the top half of the assembly (i.e., the body portion 10-2′ removed from the plug connector 20) through the hole for installation with the outlet cover 10-3 ideally being flush with the top of the surface (e.g., countertop) and hand tighten the nut 10-4 underneath the surface (e.g., screwing the nut around the body portion until it secures the body portion in place contacting the bottom surface of the countertop). Lastly, a user can snap or fit the plug connector 20 into the body portion, causing the actuator 11 to push toward the plug connector 20 and secure the two together, and then wire the other end of the wire covering to a junction box to complete the assembly.

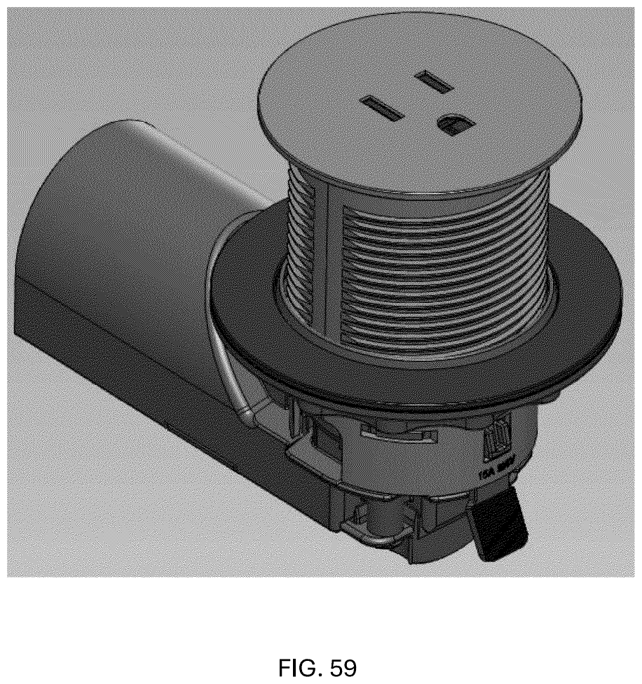

While the above-described embodiments depict 15A and/or 20A assemblies, the respective other assembly is contemplated and can be used—such as a 15A assembly in the immediately above described embodiment, as shown in FIG. 59, which includes the same components as the 20A version—(as should be understood by a person of ordinary skill in the art in conjunction with a review of this disclosure). In addition, all embodiments 100-800 and features thereof that are described herein are intended to be able to be combined in any way mechanically possible.

It should be understood that any of the specific dimensions recited in this application can apply to any embodiment described above, as appropriate, but are not required to. All embodiments can be combined in any way mechanically possible.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprise” (and any form of comprise, such as “comprises” and “comprising”), “have” (and any form of have, such as, “has” and “having”), “include” (and any form of include, such as “includes” and “including”), and “contain” (any form of contain, such as “contains” and “containing”) are open-ended linking verbs. As a result, a method or device that “comprises”, “has”, “includes” or “contains” one or more steps or elements. Likewise, a step of method or an element of a device that “comprises”, “has”, “includes” or “contains” one or more features possesses those one or more features but is not limited to possessing only those one or more features. Furthermore, a device or structure that is configured in a certain way is configured in at least that way but may also be configured in ways that are not listed.

The corresponding structures, materials, acts and equivalents of all means or step plus function elements in the claims below, if any, are intended to include any structure, material or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. Each embodiment was chosen and described in order to best explain the principles of one or more aspects of the invention and the practical application, and to enable others of ordinary skill in the art to understand one or more aspects of the present invention for various embodiments with various modifications as are suited to the particular use contemplated.

What is claimed is:

1. (canceled)

2. An electrical wiring device, comprising:
an elongated body housing extending along a first central longitudinal axis between a first end and a second end and having an interior space;
an interior body portion forming one or more first channels positioned within the interior space and extending substantially between the first end and the second end of the interior body, wherein the one or more first channels are formed by and separated from each other by at least one wall;
a plug connector having a head portion and a tail portion, the head portion being releasably connectable to the second end of the interior body, comprising one or more elongated second channels and extending substantially along the first central longitudinal axis when connected to the second end of the interior body; and
the tail portion having a cavity therein, connected to the head portion and extending substantially along a second central longitudinal axis.

3. The electrical wiring device of claim 2, wherein the first central longitudinal axis and the second central longitudinal axis are different axes.

4. The electrical wiring device of claim 3, wherein the first central longitudinal axis and the second central longitudinal axis are substantially perpendicular to each other when the interior body portion is connected to the plug connector.

5. The electrical wiring device of claim 2, wherein the one or more elongated second channels are substantially aligned with the first channels of the interior body portion when the interior body portion is coupled to the plug connector.

6. The electrical wiring device of claim 5, further comprising one or more elongated contacts each housed within a separate one of the one or more elongated first channels.

7. The electrical wiring device of claim 6, further comprising one or more connector contacts each housed within a separate one of the one or more second channels and electrically connectable with one of the receptacle contacts when the head portion is connected to the interior body.

8. The electrical wiring device of claim 2, wherein the tail portion is integrally formed with the head portion of the plug connector.

9. The electrical wiring device of claim 2, wherein the head portion of the plug connector is positioned within the interior body when the plug connector is connected to the interior body.

10. The electrical wiring device of claim 2, wherein the interior body portion is integrally formed within the interior space of the elongated body housing.

11. The electrical wiring device of claim 2, wherein the interior body portion is releasably positionable within the interior space of the elongated body housing.

12. The electrical wiring device of claim 2, further comprising a primary gasket positioned below a top surface of the at least one wall forming the one or more channels.

13. The electrical wiring device of claim 12, wherein the primary gasket is formed of one piece.

14. The electrical wiring device of claim 6, further comprising one or more secondary gaskets surrounding each of the one or more elongated contacts.

15. An electrical wiring device, comprising:
a body extending along a central axis and having a first end, a second end, and an interior space therein;
one or more channels each having a first end and a second end and being integrally formed within the interior space of the body and extending substantially between the first end and the second end of the body, wherein the one or more channels are formed by and separated from each other by at least one wall; and
one or more ledges formed within the body and angled downward and away when in use with respect to the central axis of the body.

16. The electrical wiring device of claim 15, wherein the one or more ledges each further comprise an opening formed therethrough configured to drain water away from the interior body.

17. The electrical wiring device of claim 16, wherein the one or more ledges substantially align with the second end of the one or more channels.

18. An electrical wiring device, comprising:
a body portion having a first end and a second end extending along a central longitudinal axis;
a plug connector, comprising:
a head portion being releasably connectable to the second end of the body portion; and
a tail portion having a cavity therein, connected to the head portion and extending substantially along a second central longitudinal axis;
a plurality of receptacle contacts housed within the body portion;
a plurality of connector contacts housed within the plug connector and in contacting relation with the plurality of receptacle contacts when the plug connector is connected to the body; and
wherein the first longitudinal axis and the second central longitudinal axis are substantially 90 degrees with respect to each other.

19. The electrical wiring device of claim 18, wherein the head portion of the plug connector is positioned within the body when the plug connector is connected to the body.

20. The electrical wiring device of claim 18, wherein the tail portion is integrally formed with the head portion of the plug connector.

21. The electrical wiring device of claim 20, wherein the tail portion is configured to house an AC power wire.
